(19) United States
(12) Patent Application Publication
(10) Pub. No.: US 2023/0219104 A1
(43) Pub. Date: Jul. 13, 2023

(54) SHOWER DEVICE

(71) Applicant: Dornbracht AG & Co. KG, Iserlohn (DE)

(72) Inventor: Michael Neumayr, Muenchen (DE)

(21) Appl. No.: 18/089,184

(22) Filed: Dec. 27, 2022

Related U.S. Application Data
(63) Continuation-in-part of application No. 15/751,695, filed on Feb. 9, 2018, now Pat. No. 11,534,775.

(30) Foreign Application Priority Data
May 31, 2016 (DE) 10 2016 110 069.2

(51) Int. Cl. B05B 1/06; B05B 1/10

(52) U.S. Cl. CPC B05B 1/06; B05B 1/10

(57) ABSTRACT

A shower device for creating at least one water jet pattern with a structural assembly, with a nozzle assembly and with a lighting assembly. It is proposed that the structural assembly provides an exit opening for the emergence of the water discharged by the nozzle assembly and comprises an outer edge region running about the edge of the exit opening, that the exit opening during shower operation is only partially occupied with emerging water at any given time, that the nozzle assembly is arranged distributed along at least a portion of the edge of the exit opening at the edge region and that the path of the water discharged by the nozzle assembly during the shower operation runs each time from the edge region in the direction of the exit opening and then through the exit opening.

This application is a Continuation in Part of U.S. Application Ser. No. 15/751,695 filed Feb. 9, 2018, which claims priority from International Patent Application Serial No. PCT/EP2017/063021, entitled “Shower Device,” filed May 30, 2017, which claims priority from German Patent Application No. DE 10 2016 110 069.2, filed May 31, 2016, the disclosures of which is incorporated herein by reference in their entirety.

### FIELD OF THE TECHNOLOGY

The disclosure relates to a shower devices for creating at least one or at least two water jet patterns.

### BACKGROUND

At present, the creation of at least one water jet pattern with simultaneous creation of lighting effects is a subject of interest. This involves not simply providing a water exit for physical hygiene, but also a choreography involving water and lighting, which should produce a particular shower experience. This requires a shower device which serves both mentioned aspects in an especially flexible manner.

The known shower device (DE 10 2004 001 256 A1), from which the some embodiments start, comprises a structural assembly, which accommodates both a nozzle assembly and a lighting assembly, but the resulting water jet pattern in view of the nozzle assembly there is confined to the water jet pattern of an ordinary shower, and the lighting on account of the light sources arranged in the visible surface is confined to the lighting effect of an ordinary light source.

### SUMMARY

Various embodiments solve the problem of designing and modifying the known shower device so that the flexibility is enhanced in the combined creation of water jet patterns and lighting effects.

First of all, the fundamental consideration is important that a large exit opening, at whose outer edge region a nozzle assembly is arranged, already allows a good flexibility in the creation of the water jet pattern. This edge region is namely suitable for accommodating very different kinds of nozzles of the nozzle assembly, whose water runs each time from the edge region at first in the direction of the exit opening. At the same time, this edge region, inter alia, offers a possible structural space for the positioning of a lighting assembly.

Specifically, it is proposed that the structural assembly provides an exit opening for the emergence of the water discharged by the nozzle assembly and accordingly has an outer edge region running about the edge of the exit opening. It is an interesting fact here that the exit opening is not necessarily fully occupied by emerging water during the shower operation, such as is the case for example with a nozzle opening. Instead, it can be that during the shower operation the exit opening is only partly occupied with emerging water at any given time. Depending on the water jet pattern, this allows a differing occupation of the exit opening with emerging water, which further enhances the flexibility in the creation of the water jet pattern.

Moreover, it is provided in accordance with the proposal that the nozzle assembly is arranged distributed along at least a portion of the edge of the exit opening at the edge region. Thus, the nozzle assembly follows the course of the edge of the exit opening. During the shower operation, the path of the water discharged by the nozzle assembly runs each time from the edge region toward the exit opening and then through the exit opening. Thus, according to the proposal, the water discharged by the nozzle assembly must at first arrive at the exit opening in order to then be able to pass through the exit opening. With this “detour”, the good flexibility in the design of the shower device is consciously achieved. At the same time, it has been found that just such a detour results in new water jet patterns which make the proposed shower device one of a kind.

As mentioned above, a corresponding flexibility results for the design of the lighting assembly. In various embodiments, the above exit opening serves not only for the emergence of water, but also for the emergence of at least part of the light which has been generated by the lighting assembly.

Basically, the nozzle assembly may be arranged distributed only along a portion of the edge of the exit opening, as indicated above. In various embodiments, however, the nozzle assembly is arranged distributed along the entire edge of the exit opening, wherein the distribution need not necessarily be uniform, but instead may also be nonuniform. Basically, a distribution of individual groups of nozzles of the nozzle assembly is also conceivable.

From the arrangement of the nozzle assembly along the edge of the exit opening it results according to various embodiments that the path of the water discharged by the nozzle assembly runs from several different directions from the edge region to the exit opening, such as each time to the center region of the exit opening, and, in some embodiments, in a star pattern. This grants the possibility of creating a water jet pattern which is symmetrical about a center region of the exit opening.

Various embodiments involve the possibility of creating different water jet patterns by the nozzle assembly having different kinds of nozzles, which are actuatable by means of a valve assembly for creating different water jet patterns.

Various embodiments concern possibilities for the realization of the lighting assembly. In various embodiments, the reflector assembly, which has a hood-like reflector, with a suitable arrangement of the at least one light source of the lighting assembly it is possible to create an optical depth effect which is further intensified by a corresponding water jet pattern.

Various embodiments concern configurations for the exit opening. With the round exit openings according to various embodiments around the edge of the exit opening it is possible to create steady water jet patterns, while with the polygonal exit openings according some embodiments entirely new water jet patterns can be created which owe their existence to the corners. It should be considered that at least one corner of the exit opening can be sharp-edged and/or at least one corner of the exit opening can be rounded.

In various embodiments, the nozzle assembly and/or the lighting assembly is/are covered by the edge region and thus not visible thanks to suitable design of the edge region of the exit opening when the shower device is used appropriately. This produces a creative overall impression which cannot be produced with existing shower devices.

According to various embodiments, a shower device for creating at least one water jet pattern is provided, said shower device comprising a nozzle assembly for discharging water, a structural assembly comprising a damming section for damming the water discharged by the nozzle assembly, and an exit opening for the discharge of the water, discharged by the nozzle assembly and dammed in the damming section, from the shower device, wherein the damming section comprises a boundary arrangement, which the water passes at least partially towards the exit opening during the shower operation, and wherein a surge rim is assigned to the exit opening, which is at least partially occupied by discharging water during the shower operation.

It can be that the boundary arrangement is designed as a flow-through damming structure with several flow paths. Reference may be made to all embodiments of the shower device according to the first teaching.

The fundamental consideration is that stagnant water in the shower device can be avoided outside the shower operation by designing the boundary arrangement as a damming structure through which water can flow. The water accumulated in the damming section, which is discharged by the nozzle assembly during the shower operation, can flow through the damming structure accordingly during and also after the shower operation. By this, after the end of the shower operation, the water, which has been dammed in the damming section, can run off at least partially, in some embodiments completely, from the latter whereby dammed water in the shower device is avoided.

Thus, in the shower device according to the proposal, the boundary arrangement is not exclusively overflowed, as is the case in the prior art, but at least flowed-through. By allowing the water to flow off after the end of the shower operation and thus avoiding stagnant water, the shower device is improved in terms of hygiene.

The damming structure has several flow paths for the water, which allows the water to flow through the damming structure. The design of the damming structure with several, in particular uniformly arranged and configured, flow paths ensures sufficient damming and thus a uniform delivery of water, which is required, for example, to produce a water jet pattern in the form of a water surge. In particular, this design can ensure that sufficient damming can be achieved in the damming section even in the case of varying quantities of water, which is discharged through the nozzle assembly during shower operation, so that a circumferentially uniform water surge flows over the edge of the exit opening. On the one hand, a circumferentially uniform water surge is particularly visually appealing, but is also beneficial to hygiene, since a uniform flow velocity over the entire circumference of the exit opening reduces the risk of limescale.

According to various embodiments of the shower device, it is provided that the damming structure comprises a plurality of damming elements for damming water, in some embodiments, that the damming elements are arranged in and/or transversely to the main flow direction of the water flowing from the damming section to the exit opening at least in sections uniformly spaced apart from one another, in some embodiments, that the damming elements are arranged in a plurality of rows in and/or transversely to the main flow direction of the water flowing from the damming section to the exit opening. Some embodiments of the damming structure with several damming elements are defined here. In particular, several damming elements can enable a particularly uniform damming and a particularly uniform flow through the damming structure. In particular, the uniform spacing of the damming elements can enable uniform damming of the water across the entire damming structure. The arrangement in several rows can also or additionally increase the uniformity of the water damming and the resulting water surge.

According to various embodiments of the shower device, it is provided that the damming structure is designed as a damming module or several damming modules, in some embodiments, that the damming module or the damming modules each comprise several damming elements and at least one base element, on which the damming elements are arranged, in some embodiments, that in each case the base element is of curved and/or plate-like design and/or the damming elements are arranged on the base element on several sections of circular paths, in some embodiments, that the circular paths each comprise a different curvature and a common center point or the circular paths each comprise the same curvature and a different center point. Here, the damming structure is modularly designed as one damming module or several damming modules. In this way, advantages can be achieved in particular with regard to the usability of the damming structure, for example in the manufacture, assembly and maintenance of the shower device.

According to some embodiments of the shower device, it is provided that the flow paths are formed by the damming elements, and/or that the flow paths are formed in such a way that the water flowing through the damming structure is deflected several times, such as at least twice or at least four times, in particular by the damming elements, in some embodiments, that the flow paths form a channel structure, which is connected at least in sections. Here, the flow paths are further improved in a way that they are formed by the damming elements themselves, meaning, that the damming elements form the lateral boundaries of the flow paths. In particular, the multiple deflections of the water as it flows through the damming structure can lead in each case to a prolonged flow path or a prolonged residence time of the water within the damming structure, whereby the damming effect of the damming structure can also be advantageously increased. A design of the flow paths as a channel structure can make the outflow of water from the damming structure more uniform, for example by distributing it within the damming structure, if water flows into the damming structure unevenly.

According to some embodiments of the shower device, it is provided that the damming structure comprises several openings, which are formed in particular by the damming elements, in some embodiments, that a part of the openings is designed as inlet openings for the inflow of water into the flow paths of the damming structure and a part of the openings is designed as exit openings for the outflow of water from the flow paths of the damming structure. Here, the damming structure comprises several openings through which the water can flow into the damming structure, in particular into the flow paths, or flow out of the damming structure. The formation of the openings by the damming elements enables a structurally simple design option without further components.

According to various embodiments of the shower device, it is provided that the damming structure is designed in such a way that the water in the damming section can completely run off towards the exit opening after the shower operation, and/or that the damming structure is designed in such a way that the cross-section of the flow paths through which water flows, is dependent on the damming height of the water dammed by the damming structure in the damming section, and/or that the damming structure is designed in such a way that the damming height of the water dammed in the damming section is dependent on the volumetric flow rate of the water discharged by the nozzle assembly, and/or that the damming structure is designed in such a way that the volumetric flow rate of the water flowing through the damming structure is dependent on the damming height of the water dammed by the damming structure in the damming section. Some embodiments are defined herein, which improve the shower operation of the shower device. In case the cross-sections of the flow channels through which the water flows vary with the damming height of the dammed water, fluctuations in the water supply to the damming section can be compensated, thereby homogenizing the volumetric flow rate of the water exiting the shower device. Likewise, the damming height, which depends on the volumetric flow rate of the nozzle assembly, can lead to a homogenization of the volumetric flow rate of the water exiting the shower device.

According to various embodiments of the shower device, it is provided that the nozzle assembly comprises a first nozzle group, via which a first water jet pattern, in particular in the form of a circulating or partially circulating water surge, can be created, and/or, that the nozzle assembly comprises a second nozzle group, via which a second water jet pattern, in particular different from the first water jet pattern, can be created, in particular in the form of several water jets, in some embodiments, that the first nozzle group comprises one or more nozzles of a first type, which is or are designed as a jet nozzle or jet nozzles and/or as a surge nozzle or surge nozzles, in some embodiments, that the second nozzle group comprises one or more nozzles of a second type, which is or are designed as a jet nozzle or jet nozzles or as a surge nozzle or surge nozzles. Here, several, in particular different, water jet patterns can be created with the shower device during shower operation.

According to various embodiments of the shower device, it is provided that the first nozzle group comprises one or more nozzle modules of a first type, which is or are each formed by one or more nozzles of a first type and a first nozzle holder for holding the one or more nozzles of a first type, and/or that the second nozzle group comprises one or more nozzle modules of a second type, which is or are each formed by one or more nozzles of the second type and a second nozzle holder for holding the one or more nozzles of the second type, in some embodiments, that the first nozzle holder comprises a water supply and a water distribution system for supplying and distributing water to the one or more nozzles of the first type, and/or, that the second nozzle holder comprises a water supply and a water distribution system for supplying and distributing water to the one or more nozzles of the second type. Here, a further embodiment of the first nozzle group and the second nozzle group is defined as each comprising one nozzle module or several nozzle modules. The modular design, in each case with at least one nozzle and one nozzle holder can lead to improved usability of the respective nozzle group, for example during manufacture and assembly or also during maintenance of the shower device. In various embodiments, it can be provided that the respective nozzle holder fulfills a dual function, both for holding the respective nozzle or nozzles and for supplying the respective nozzle or nozzles with water via a water supply and a water distribution system. In this way, in particular the water supply is implemented in a structurally simple and space-saving manner.

According to various embodiments of the shower device, it is provided that the damming section is designed as a circumferential channel, in some embodiments, that the damming section is confined on one side by the damming structure. Here, a structurally simple and inexpensive design of the damming section is proposed, which nevertheless enables an effective damming of water. In particular, the one-sided confinement of the damming section by the passable damming structure can be advantageous in terms of production technology, with regard to assembly, for example.

According to various embodiments of the shower device, it is provided that the, in particular annular, exit opening is confined by a first opening edge and, in some embodiments, by a second opening edge, in some embodiments, that the first opening edge and/or the second opening edge is free of water, in particular water discharged by the first nozzle group, at all times during shower operation, and/or, that the first opening edge and/or the second opening edge is at least partially occupied by water, in particular water discharged by the second nozzle group, during shower operation. Here, the exit opening is advantageously improved. A first opening edge and/or a second opening edge allow a defined outflow of water from the shower device that is moreover aesthetically pleasing.

According to various embodiments of the shower device, it is provided that the structural assembly comprises a holder by means of which the damming structure and/or one of the nozzle groups can be arranged on a base body of the structural assembly, and/or, that the structural assembly comprises several holders by means of which in each case one of the damming modules and/or one of the nozzle modules of the first type or one of the nozzle modules of the second type can be arranged on the base body of the structural assembly, in some embodiments, that the holder or the holders each comprise a lever, and/or, that the holder or the holders are each prestressed with respect to the base body, and/or, that the holder or the holders each comprise at least one latching means for latching to the base body, in some embodiments, that the respective latching means can be unlatched via the respective lever. These embodiments relate to the arrangement of the damming structure and/or the nozzle group on a base body of the shower device. By providing one or more holders, the damming structure, in particular damming modules and/or the nozzle group, in particular the nozzle modules of the first or second type, can be arranged on the base body in a particularly assembly-friendly manner. This can, in particular, simplify manufacturing as well as maintenance. A latching means, which can be unlatched via a lever can enable repeated assembly and disassembly, in particular without tools.

According to a further aspect, a damming module for forming a passable damming structure of a shower device, in particular a shower device according to the proposal, is provided, wherein the damming module comprises a base element, in particular of plate-like design, and several, in particular at least 50, damming elements, wherein the damming elements are arranged on the base element in several rows in at least two directions. Reference may be made to all explanations concerning the shower device according to the proposal.

According to a various embodiments, a shower system comprising a shower device and a wall, such as a ceiling, to which the shower device is attached, is provided. It is possible, that the shower device is designed according to the proposal. Reference may be made to all explanations concerning the shower device according to the proposal and the damming module according to the proposal.

According to various embodiments, a method for creating at least one water jet pattern with a shower device, in particular a shower device according to the proposal, is provided. In this respect, it is possible that the boundary arrangement is designed as a damming structure with several flow paths and that the water flows through the damming structure. Reference may be made to all embodiments relating to the shower device according to the proposal, the damming module according to the proposal and the shower system according to the proposal. In some embodiments, the water dammed up in the damming section during the shower operation completely drains out of the damming section after the shower operation. This embodiment makes it possible to avoid dammed water in the damming section of the shower device after the shower operation. In this way, in particular hygiene can be ensured.

According to various embodiments, a shower device for creating at least one water jet pattern is provided, the shower device comprising a nozzle assembly for discharging water, a structural assembly comprising a damming section for damming the water discharged from the nozzle assembly, an exit opening for discharging the water from the shower device, which has been discharged from the nozzle assembly and dammed in the damming section, and a lighting assembly for illuminating the water emerging from the exit opening, the structural assembly comprising a base body in which the nozzle assembly, the damming section and the lighting assembly are at least partially accommodated and from which water can emerge via the exit opening, wherein the exit opening is assigned a surge rim which is at least partially occupied by emerging water during shower operation, and wherein the exit opening is confined by a circumferential first opening edge.

It can be that the shower device comprises a functional arrangement, which comprises at least part of the lighting assembly and/or at least part of the nozzle assembly, and, that the functional arrangement is designed as an assembly unit which, in the course of assembly, can be connected to the structural assembly, in particular detachably, in such a way that, in the assembled state, the functional arrangement is at least partially accommodated by the base body, wherein the functional arrangement in the course of assembly is, at least partially, to be moved through an assembly opening of the structural assembly, which is surrounded by the first opening edge. Reference may be made to all explanations regarding the shower device according to the proposal of the first teaching and regarding the shower device according to the proposal of the second teaching.

The fundamental consideration is to provide an opening in the shower device through which cleaning and maintenance of areas located inside the shower device is possible in a simple manner. In this respect, the opening serves as an inspection opening, but according to the proposal, it is also designed and arranged in such a way that it fulfills the function of an assembly opening into which a pre-assembled functional part, hereinafter referred to as a functional arrangement, of the shower device can be inserted. “Functional” means, here and further, crucial for the shower function. Functional components of the shower device, such as the lighting assembly, can be maintained in this way and replaced if necessary without having to dismantle the entire shower device. Moreover, according to the proposal, the opening is designed and arranged in such a way that it is confined by the same edge of the opening, which also forms the exit opening for the water. As a result, a shower device is formed that is easy to clean and maintain , which at the same time has a functional, visually appealing structure due to the multiple functions of the access opening. At the same time, in the state of the pre-assembled functional arrangement inserted into said opening, an aesthetic, in particular circumferential and/or slit-shaped, water exit is created, which is particularly conducive to an attractive appearance.

According to various embodiments of the shower device, it is provided that the exit opening is confined by a second opening edge in such a way that the exit opening between the first opening edge and the second opening edge is annular, in some embodiments, that the first opening edge is formed as part of the structural assembly, in particular of the base body, and the second opening edge is formed as part of the functional arrangement, in some embodiments, that during the shower operation, in particular at any time, the exit opening is only proportionally flowed-through by water, which reaches the exit opening from the surge rim, and/or, that the first opening edge and/or the second opening edge is free of water during the shower operation, in particular at any time. This embodiment opens up the possibility of creating a shower device with a slit-shaped exit opening, which is relatively easy to install. In order to produce a uniform water surge, a further embodiment provides for water to flow through the exit opening from the surge rim, the latter being only proportionally occupied by water. The uniformity of the water surge can alternatively or additionally be achieved by the water passing the first and/or the second opening edge without contact.

According to various embodiments of the shower device, it is provided that the lighting assembly comprises at least one light source and a light deflection assigned to the light source, the light from the light source being deflectable via the light deflection in such a way that the water emerging from the exit opening is indirectly illuminated, in some embodiments, that the at least one light source and/or the light deflection is formed as part of the functional arrangement, in some embodiments, that the functional arrangement comprises a light cover, which covers in the mounted state the at least one light source in such a way that it is not visible to a user during shower operation. These can be advantageous embodiments of the shower device with respect to the lighting assembly. Due to the indirect illumination of the water jet patterns, a particularly uniform illumination of the water emerging from the shower device can be achieved. In the event that the light source and the light deflector are formed as part of the functional arrangement, a particularly maintenance-friendly lighting assembly can be created. The light cover can avoid blinding a user by light, thus improving the showering experience.

According to various embodiments of the shower device, it is provided that the shower device comprises a fastening arrangement, wherein the functional arrangement can be fastened to the structural assembly via the fastening arrangement in a manual assembly movement, in some embodiments, that the fastening arrangement is designed as a latching fastening arrangement, in which at least one fastening element and at least one fastening point assigned to the fastening element can be latched to one another, in particular in a self-locking manner, wherein the at least one fastening element is arranged at the functional arrangement and the at least one fastening point is arranged at the structural assembly, or, the at least one fastening point being arranged at the functional arrangement and the at least one fastening element being arranged at the structural assembly, in some embodiments, that the fastening arrangement comprises several fastening elements and several fastening points, each assigned to one of the fastening elements, which are arranged at the structural assembly and the functional arrangement at a uniform angular distance from one another around a, in particular vertical, geometric main axis of the functional arrangement fastened to the structural assembly. Some embodiments are defined here with regard to the fastening of the functional arrangement to the structural assembly, which are characterized by a particularly simple, in particular tool-free, assembly. A uniform angular spacing of the fastening elements and assigned fastening points enables simplified alignment of the functional arrangement with respect to the structural assembly during assembly.

According to various embodiments of the shower device, it is provided that the at least one fastening element comprises a latching element of the first type and the at least one fastening point comprises a latching element of the second type, which latch behind one another in the assembled state, resulting in a self-locking latching connection, in some embodiments, that the latching element of the first type or the latching element of the second type is mounted movably, in particular rotatably, and is transferred from an unlatching position into a latching position in the course of the assembly, so that the latching element of the first type and the latching element of the second type engage behind one another, in some embodiments, that the at least one fastening point comprises a fastening receptacle in which the latching element of the second type is arranged and into which the latching element of the first type can be moved, in particular guided by the fastening receptacle, in the course of the assembly. Here, the fastening arrangement is further formed, wherein the self-locking latching connection enables a particularly simple assembly of the functional arrangement to or disassembly from the structural assembly. A movement guided through the fastening receptacle or receptacles can simplify the latching, in particular with regard to the alignment of the functional arrangement relative to the structural assembly during assembly.

According to various embodiments of the shower device, it is provided that the fastening arrangement is configured such that the functional arrangement is detachable from the structural assembly in a manual disassembly movement, in some embodiments, that in the manual disassembly movement the functional arrangement is movable along the main geometric axis of the functional arrangement by a manual pulling force, whereby the at least one fastening element and the at least one fastening location are disengaged from each other. Here, a simple disassembly possibility of the functional arrangement from the structural assembly is proposed, which may improve and simplify the maintainability of the shower device. An embodiment proposes a particularly simple way of disengaging the, in particular self-locking, latching. The dismountable functional arrangement can be maintained particularly easily.

According to various embodiments of the shower device, it is provided that the structural assembly, in particular the base body, comprises an inspection opening for maintenance of the nozzle assembly accommodated in the base body and/or of the damming section accommodated in the base body and/or of the lighting assembly accommodated in the base body, the functional arrangement in the assembled state being arranged at least partially in the inspection opening, in some embodiments, that the functional arrangement comprises a cover surface, which at least partially covers the inspection opening in the assembled state and exposes the inspection opening in the disassembled state of the functional arrangement. It is provided that the structural assembly comprises an inspection opening which simplifies maintenance of the structural assembly, in particular of the components accommodated in the base body. In some embodiments, the functional cover can comprise a cover surface, which covers the inspection opening when the functional cover is mounted on the structural assembly, without additional components or additional assembly steps being required.

According to various embodiments of the shower device, it is provided that the shower device comprises a functional connection, wherein a functional connection between the structural assembly and the functional arrangement can be established via the functional connection in the course of assembly, in particular without tools, in some embodiments, that the functional connection is automatically established in the course of assembly when the functional arrangement is fastened to the structural assembly by the fastening arrangement. This embodiment relates to establishing the functionality of the functional arrangement by the shower device comprising a functional connection. A connection may be established via the functional connection during assembly, such that the lighting assembly and/or the nozzle assembly of the functional arrangement are usable according to their respective functions. The functional connection can be established in an additional assembly step or automatically when the functional arrangement is attached to the structural assembly, without an additional assembly step.

According to various embodiments of the shower device, it is provided that the nozzle assembly comprises a first nozzle group via which a first water jet pattern, in particular comprising a circulating or partially circulating water surge, can be created, and, that the nozzle assembly comprises a second nozzle group via which a second water jet pattern, in particular comprising several individual water jets, can be created, in some embodiments, that the first nozzle group comprises one or more nozzles of a first type, via which water can be discharged into the damming section, and/or, that the second nozzle group comprises one or more nozzles of a second type, via which water can be discharged through the exit opening. This embodiment enables the creation of different water jet patterns, which extends the functionality of the shower device, in particular with regard to the water delivery options.

According to various embodiments, a shower system with a shower device and a wall, such as a ceiling, to which the shower device is attached, is provided. It is possible that the shower device is designed according to the proposal. Reference may be made to all explanations concerning the shower device according to the proposal. In some embodiments, it is thereby the case that the shower device, in particular the structural assembly, such as the base body, is integrated in the wall in such a way that the exit opening is arranged in a plane with the wall, or, that the exit opening spans an exit plane, which is spaced from the wall by at most 10 cm, at most 1 cm, or at most 0.5 cm, and/or, that the shower device, in particular the structural assembly, such as the base body, is integrated into the wall in such a way that a cover surface of the functional arrangement is arranged in a plane with the wall, or in that the cover surface spans a cover plane which is spaced from the wall by at most 10 cm, at most 1 cm, or at most 0.5 cm. Here, the shower system is further embodied in that the shower device is configured as a partially integrated or fully integrated shower device in a wall. This makes it possible to create a shower system in which the shower device is arranged only in the immediate vicinity of the wall, whereby, for example, an area lying below or next to it can remain free.

According to various embodiments, a method for assembling a shower device according to the proposal is provided. In this context, it is possible that, in the course of assembly, the functional arrangement of the shower device is connected to the structural assembly, in particular detachably, in such a way that, in the assembled state, the functional arrangement is at least partially accommodated by the base body, wherein the functional arrangement in the course of assembly is, at least partially, being moved through the assembly opening of the structural assembly surrounded by the first opening edge. Reference may be made to all explanations regarding the shower device according to the proposal and the shower system according to the proposal.

According to various embodiments, a shower device for creating at least two water jet patterns is provided, wherein the shower device comprises a nozzle assembly for discharging water with a first nozzle group for creating a first water jet pattern and with a second nozzle group for creating a second water jet pattern, with a first shower head comprising the first nozzle group and the second nozzle group, and with a plurality of water supply lines via which water can be supplied to the first shower head.

It can be that the water supply lines are designed as supply and spacing units for supplying water to the first shower device and for spacing and fastening the first shower device to a wall, in particular a ceiling. Reference may be made to all explanations concerning the shower device according to the first teaching, concerning the shower device according to the second teaching and concerning the shower device according to the third teaching.

The fundamental consideration is to arrange a nozzle assembly for discharging water with a first nozzle group and a second nozzle group in such a way that water can emerge from the wall, in particular the ceiling, at locations and/or in directions that are unusual for the user, thereby enabling novel and particularly appealing water jet patterns. For this purpose, a shower head which accommodates the first and second nozzle groups is arranged at a distance from the wall or ceiling by means of elongated spacers.

The spacers, which are referred to as supply and spacing units, have a dual function and are designed both, to supply water to the shower head and to fix the shower head in the room. By this dual function of the water supply lines additional suspension or fastening components for the shower head can be omitted and, by spacing it from the wall or ceiling, there is now the possibility of discharging water not only in one direction, for example vertically downwards parallel to the direction of gravity, but also upwards, so that the water of a corresponding water jet pattern describes an arc due to gravity, which is perceived as particularly aesthetic. In addition, the supply and spacing units allow for unobtrusive mounting of the shower head and the creation of an apparently floating design element.

According to various embodiments of the shower device, it is provided that the water supply lines are designed as spatially separated water supply lines, which are fastened to the first shower head at a distance from one another or can be fastened to the wall, in particular the ceiling, at a distance from one another, in some embodiments, that the water supply lines are arranged essentially parallel to one another and/or on a common first circular path or elliptical path. In this case, several spatially separated water supply lines are provided, which enables a particularly attractive and filigree attachment of the shower head and thus further enhances the impression of an apparently floating design element.

According to various embodiments of the shower device, it is provided that the water supply lines are divided into water supply line groups, that water can be supplied to the first nozzle group via a first water supply line group with at least two water supply lines and water can be supplied to the second nozzle group via a second water supply line group with at least two water supply lines, and that the first water supply line group and the second water supply line group are designed to be fluidically separate from one another, in some embodiments, that the water supply lines of the first water supply line group and the water supply lines of the second water supply line group are arranged essentially parallel to one another and/or on a common first circular path or elliptical path. Here, the water supply lines are specified to be divided into water supply line groups that can easily supply water to the different nozzle groups. Here, each of the water supply line groups comprises at least two water supply lines, so that each nozzle group is supplied with water via several water supply lines and thus at different locations. This results in a particularly uniform delivery of water over the entire extension of the nozzle group, as will be specified in more detail below.

According to various embodiments of the shower device, it is provided that the first nozzle group comprises a plurality of first nozzles for discharging water for the first water jet pattern and the second nozzle group comprises a plurality of second nozzles for discharging water for the second water jet pattern, in some embodiments, that water can be discharged in a first direction via the first nozzles and can be discharged in a second direction via the second nozzles, wherein the first direction differs from the second direction, in particular by at least 30°, by at least 60°, or by at least 90°, from the second direction, in some embodiments, that the first direction is oriented downwardly with respect to a horizontal plane and the second direction is oriented upwardly with respect to the horizontal plane. Here, different water jet patterns can be created, each comprising a different course and/or a different orientation. In addition to different visual impressions that improve the showering experience, the different water jet patterns can also lead to different raining or falling of the water, especially in case of different directions, in which the water is discharged.

According to various embodiments of the shower device, it is provided that the first shower head comprises a distribution system for distributing water from the water supply lines to the first nozzle group and second nozzle group, which comprises a first distribution line for distributing water to the first nozzles and a second distribution line for distributing water to the second nozzles, in some embodiments, that the first distribution line comprises a first ring line on which the first nozzles, in particular at least partially equally spaced, are arranged, and, that the second distribution line comprises a second ring line on which the second nozzles, in particular at least partially equally spaced, are arranged, in some embodiments in that the first distribution line, in particular the first ring line, is formed from several first line elements, in particular detachably connected to one another, and/or, that the second distribution line is formed from several second line elements, in particular detachably connected to one another. Here, a distribution system is specified, which enables the distribution of water within the shower head. In this context, an embodiment with fluidically separated ring lines enables a structurally simple distribution and low pressure loss. A modular design of the distribution lines enables a cost-effective and, in particular, individually adaptable construction of a distribution system.

According to various embodiments of the shower device, it is provided that the first nozzle group comprises a plurality of first nozzle connections via which the first nozzles are connected to the first manifold line in groups, and/or, that the second nozzle group comprises several second nozzle connections via which the second nozzles are connected to the second manifold line in groups, in some embodiments, that the first nozzle connections each connect two first line elements to one another and/or the second nozzle connections each connect two second line elements to one another, in some embodiments, that the first ring line is formed from the first line elements and the first nozzle connections and/or the second ring line is formed from the second line elements and the second nozzle connections. Here, the nozzle groups are connected to the manifold lines in groups via nozzle connections. This enables to reduce the number of components of the manifold system and thus also the assembly work. In some embodiments, the nozzle connections can act as a connector and as a port, which can simplify the assembly of the manifold system.

According to a various embodiments of the shower device, it is provided that the first shower head comprises a modular, in particular annular, base body which is formed from several base body modules, in particular detachably connected to one another, in some embodiments, that the first distribution line, in particular the first line elements and/or the first nozzles are arranged on the base body via the first nozzle connections and/or the second distribution line, in particular the second line elements and/or the second nozzles are arranged on the base body via the second nozzle connections. This embodiment relates to the modular design of the base body, which is formed from several base body modules. The modularity may, for example, simplify the manufacturing of the base body. Various embodiments provide for the manifold to be arranged on the base body via the nozzle connections, whereby the nozzle connections can also function as a type of arrangement element, thereby reducing the number of components for the shower device and simplifying the construction of the shower head.

According to various embodiments of the shower device, it is provided that the distribution system comprises at least two first supply line connections, through which in each case water of a water supply line of the first water supply line group can be supplied to the first distribution line, and, that the distribution system comprises at least two second supply line connections, through which in each case water of a water supply line of the second water supply line group can be supplied to the second distribution line, wherein in particular the first supply line connections and/or the second supply line connections are formed as part of the base body, in particular in each case as part of a base body module, in some embodiments, that the first supply line connections divide the first distribution line, in particular the first ring line, into several first line sections, the lengths of the various first line sections differing from one another by at most 25%, at most 10%, at most 5%, or not at all, and/or, in that the second supply line connections divide the second distribution line, in particular the second ring line, into several second line sections, the lengths of the various second line sections differing from one another by at most 25%, at most 10%, at most 5%, or not at all. Here, the water supply line to the distribution lines is specified. Via the supply line connections, water can be supplied more uniformly from the water supply lines to the distribution lines at different locations. The design of the first and/or second supply line connections as part of the base body results in a structurally simple and easy-to-install structure of the shower device. In addition, the supply line connections can here simultaneously enable the connection of the water supply lines to the shower head. A particularly uniform pressure distribution within the manifold lines and an associated particularly uniform water delivery via the nozzles can be achieved in particular by the lengths of the line sections deviating from one another only to a small extent or not at all.

According to various embodiments of the shower device, it is provided that the first shower head comprises a housing, in particular an annular housing, in which the base body and/or the distribution system and/or the first nozzle group and/or the second nozzle group are accommodated, in some embodiments, that the housing comprises an exit opening through which water of the first nozzle group, in particular of the first nozzles, can be discharged from the inside of the housing to the outside, and/or an exit opening through which water of the second nozzle group, in particular of the second nozzles, can be discharged from the inside of the housing to the outside, in some embodiments, that the exit opening is designed as a slit-shaped and/or curved and/or coherent exit opening and/or an exit opening formed from a row of holes. Additionally or alternatively, it can also be provided that the first shower head comprises a jet passage opening, in particular circular or elliptical, which is surrounded by the, in particular annular, housing, wherein water from the second nozzle group, in particular from the second nozzles, passes through the jet passage opening during shower operation. These embodiments relate to a housing for protecting the components of the shower head accommodated in the housing from external influences, as well as for creating an external aesthetic appearance of the shower head. A first exit opening, in particular in the form of a slit, can allow water to be discharged from the first group of nozzles, and a second exit opening, in particular formed by a row of holes, can allow water to be discharged from the second group of nozzles.

According to various embodiments of the shower device, it is provided that the shower device comprises a second shower head with a third nozzle group for creating a third water jet pattern, which comprises at least one third nozzle, and a third water supply line group with at least one water supply line, in some embodiments, that the first shower head and the second shower head are spaced apart from one another at a shower head spacing, wherein the water supply lines of the first water supply line group and the second water supply line group space the first shower head and the second shower head apart from one another. To create another possible water jet pattern, this further embodiment proposes to provide a second shower head in addition to the first showerhead. This extends the water delivery possibilities through the shower device. By arranging the shower heads in different, in particular horizontal, planes, the use of space can be optimized.

According to various embodiments of the shower device, it is provided that the shower device comprises a mounting arrangement with a, in particular plate-shaped, mounting body for mounting on the wall, in particular the ceiling, on which the first shower head is arranged via the water supply lines of the first water supply line group and the second water supply line group and on which the second shower head is arranged, in some embodiments, that the mounting body at least partially surrounds the second shower head. This embodiment relates to a mounting arrangement comprising a mounting body, which allows mounting on or in a wall. Via the mounting arrangement, the shower device, in particular with the two shower heads, can be easily mounted on a wall or ceiling.

According to various embodiments of the shower device, it is provided that the shower device comprises a lighting assembly for illuminating at least one of the water jet patterns by light with at least one light source, in some embodiments, that all water jet patterns of the different nozzle groups can be directly illuminated via the lighting assembly during shower operation, in some embodiments, that the lighting assembly is at least partially integrated in the second shower head in such a way that the light source of the lighting assembly can be flowed around by the water of the third nozzle group. This embodiment relates to a lighting assembly for illuminating at least one of the water jet patterns, whereby the shower experience can be intensified in a special way, in particular if, according to various embodiments, all water jet patterns of the different nozzle groups can be directly illuminated during shower operation.

According to various embodiments, a method for creating a water jet pattern with a shower device is provided. It is possible that the shower device is designed according to the proposal. Reference may be made to all explanations concerning the shower device according to the proposal. Thereby, it can be that a first water jet pattern created with the shower device is cone-shaped, and/or, that a second water jet pattern created with the shower device is sink-shaped, and/or, that a third water jet pattern created with the shower device is cylindrical. This embodiment relates to the creation of different, particularly aesthetically pleasing, water jet patterns.

According to various embodiments, , a shower system with a shower device and a wall, in particular a ceiling, to which the shower device is attached, is provided. It is possible that the shower device is designed according to the proposal. Reference may be made to all explanations concerning the shower device according to the proposal and the method according to the proposal.

According to various embodiments, a shower device for creating at least two water jet patterns is provided, the shower device comprising a nozzle assembly for distributing water with a first nozzle group for creating a first water jet pattern and/or a second nozzle group for creating a second water jet pattern, a first shower head which comprises the first and/or second nozzle group, and several water supply lines via which water can be supplied to the first shower head.

It can be that the nozzle assembly comprises a third nozzle group for creating a third water jet pattern, that the shower device comprises a second shower head, which comprises the third nozzle group and in relation to which the first shower head in the assembled state is arranged, in particular rigidly, and which comprises at least one further water supply line, via which water can be supplied to the second shower head, and that the first shower head and the second shower head are spaced apart from one another at a shower head spacing along a, in particular vertical, geometrical main axis of the shower device. Reference may be made to all explanations concerning the shower device according to the proposal of the first teaching, concerning the shower device according to the proposal of the second teaching, concerning the shower device according to the proposal of the third teaching and concerning the shower device according to the proposal of the fourth teaching.

The basic consideration is to provide a second shower head in addition to the first shower head, which, as part of a nozzle assembly, comprises a further nozzle group, hereinafter referred to as “third” nozzle group, for creating a further water jet pattern, hereinafter referred to as “third” water jet pattern, and to arrange this second shower head at a shower head spacing spaced apart from the first showerhead. If the second shower head, which is the preferred use case, is arranged, for example, on a ceiling of the shower area, the first shower head is arranged lower than the second shower head due to the shower head spacing, so that water of a water jet pattern created by the first shower head exits the shower device at a different height than water of a water jet pattern created by the second shower head. If at least two water jet patterns are created simultaneously by the first and second shower heads, a unique sculptural overall pattern is created.

A further aspect here is that, due to the spacing of the first shower head from the second shower head, part of the nozzle assembly is arranged in such a way that water can emerge from the wall, in particular ceiling, at points and/or in directions that are unusual for the user, thereby enabling to produce novel and particularly appealing water jet patterns. In particular, it is possible to emit water not only in one direction, for example vertically downwards parallel to the direction of gravity, but also upwards, so that the water of a corresponding water jet pattern describes an arc due to gravity, which is perceived as particularly aesthetic.

According to various embodiments, certain arrangements and orientations of the shower heads, the nozzles and the exit openings of the housing of the respective shower head make it possible to create particularly aesthetic water jet patterns and combinations of water jet patterns and to intensify the showering experience. This relates in particular to the arrangement and orientation of the first and second shower head, the nozzles of the first, second and third nozzle groups, the first and second exit openings of the housing of the first shower head and the at least one third nozzle and any third exit opening associated therewith, which may be provided in a housing of the second shower head.

In detail, according to various embodiments, it is provided that the first shower head extends along a first plane extending transversely to the main geometric axis, in particular orthogonally, and that the second shower head extends along a second plane extending transversely to the main geometric axis, in particular orthogonally, and that the first plane and the second plane are different from each other, in some embodiments, that the first plane and the second plane are spaced apart and/or parallel to each other along the main geometric axis of the shower device.

According to various embodiments, it is provided that the first nozzle group comprises several first nozzles for delivering water for the first water jet pattern and/or the second nozzle group comprises several second nozzles for delivering water for the second water jet pattern, and that the third nozzle group comprises at least one third nozzle for delivering water for the third water jet pattern.

According to various embodiments, it is provided that the first nozzles, in particular the first group of nozzles, are arranged on a common first circular path or a common first elliptical path and/or the second nozzles, in particular the second group of nozzles, are arranged on a common second circular path or a common second elliptical path, which in each case run parallel to the first plane, and that the at least one third nozzle is located in the second plane and/or delivers the water for the third water jet pattern orthogonally to the second plane.

According to various embodiments, it is provided that the first shower head comprises a housing, in particular an annular housing, in which the first nozzle group and/or the second nozzle group is accommodated, and that the housing comprises a first exit opening, in particular a slit-shaped and/or curved and/or continuous opening, through which water of the first nozzle group, in particular the first nozzles, can be discharged to the outside from the interior of the housing, and/or a second exit opening, in particular slit-shaped and/or curved and/or connected, via which water of the second nozzle group, in particular the second nozzles, can be discharged to the outside from the interior of the housing.

According to various embodiments, it is provided that the first exit opening and/or second exit opening each runs parallel to the first plane, and that the at least one third nozzle and/or a third exit opening assigned thereto in a housing part of the second shower head is located in the second plane and/or the at least one third nozzle emits water for the third water jet pattern orthogonally to the second plane.

According to various embodiments of the shower device, it is provided that the annular housing of the first shower head is formed circumferentially around the geometric main axis and extends circumferentially around a flat jet passage opening, the cross-sectional shape of which is defined by the annular shape of the housing, in some embodiments, that the second nozzle group or its second nozzles is or are arranged and aligned in such a way that during shower operation the water of the second water jet pattern passes at least partially, in some embodiments completely, through the jet passage opening of the first shower head, and/or, that the second shower head is arranged opposite the first shower head in such a way that during shower operation the water of the third water jet pattern passes at least partially, in some embodiments completely, through the jet passage opening of the first shower head. Here, an annular shape of the housing of the first shower head and a planar jet passage opening defined thereby, is defined. A housing that extends as a ring around a jet passage opening creates an aesthetically high-quality design element and also enables the creation of particularly appealing water jet patterns that further intensify the showering experience.

According to various embodiments of the shower device, it is provided that the first nozzle group and/or the second nozzle group and/or the third nozzle group is designed rotationally symmetrically, and/or, that the first water jet pattern and/or the second water jet pattern and/or the third water jet pattern is designed rotationally symmetrically, in some embodiments, that the axes of the rotational symmetries are identical. Here, each of the nozzle groups and/or the respective waterjet pattern can be designed rotationally symmetrical. In addition to an attractive appearance, rotational symmetry also offers the advantage that the water emerges and falls particularly uniformly.

According to various embodiments of the shower device, it is provided that the shower device comprises a mounting arrangement with a, in particular plate-shaped, mounting body for mounting on the wall, in particular the ceiling, on which the second shower head is arranged and which at least partially surrounds the second shower head, in some embodiments, that the mounting body and the first shower head are spaced apart from one another along the geometric main axis of the shower device and/or that the mounting body runs parallel to the first plane. Additionally or alternatively, it may be provided that the first shower head and/or the second shower had is rigidly attached to the mounting body in the mounted state and/or is attached to the wall exclusively via the mounting body. These embodiments relate to a mounting arrangement with a mounting body, which enables mounting on or in a wall. Via the mounting arrangement, the shower device, in particular with the two shower heads, can be easily mounted on a wall or ceiling.

According to various embodiments of the shower device, it is provided that the water supply lines via which water can be supplied to the first shower head are designed as supply and spacing units for supplying water to the first shower head and for spacing and fastening the first shower head relative to the wall, in particular the ceiling, in some embodiments, that the water supply lines, via which water can be supplied to the first showerhead, space the first shower head and the second shower head from one another and/or the first shower head is arranged on the mounting body via the water supply lines, via which water can be supplied to the first shower head. Here, these water supply lines, which are provided for supplying water to the first shower head are designed as supply and spacing units. By means of such elongated spacers, the first shower head is spaced from the wall or ceiling. The spacers have a dual function and are designed both, to supply water to the shower head and to fix the shower head in the room. This dual function of the water supply lines means that additional suspension or fastening components for the shower head can be omitted, and, as mentioned, due to the spacing to the wall or ceiling water can be discharged not only in one direction vertically downwards but also upwards. In addition, the supply and spacing units allow for unobtrusive mounting of the shower head and the creation of a seemingly floating design element.

According to various embodiments of the shower device, it is provided that the mounting body comprises at least one water supply for a connecting supply line, in particular laid in the wall, and a water distribution structure, and that the water distribution structure in the mounting body distributes the supply line of water to the first shower head and the second shower head, in some embodiments, that the water distribution structure is switchable in such a way that the supply of water takes place either exclusively to the first shower head or exclusively to the second shower head or simultaneously, in particular in adjustable volume flows, to the first shower head and the second shower head. This embodiment relates to options of distributing the water supplied to the shower device within the shower device and, in particular, of directing it to the first shower head and to the second shower head.

According to various embodiments of the shower device, it is provided that the first nozzle group creates a radially outer water jet pattern as the first water jet pattern during shower operation and/or the second nozzle group creates a radially outer water jet pattern as the second water jet pattern during shower operation, and that the third nozzle group creates a radially inner water jet pattern as the third water jet pattern during shower operation, in some embodiments, that the first water jet pattern and/or the second water jet pattern falls radially, in particular in an arc, in the direction of the third water jet pattern and/or the third water jet pattern falls along the geometrical main axis, in particular vertically and/or straight, in the direction of the first water jet pattern and/or the second water jet pattern, in some embodiments, that the first water jet pattern and/or the second water jet pattern intersects the third water jet pattern. Special water jet patterns are specified here, which can also influence each other and further intensify the shower experience.

According to various embodiments of the shower device, it is provided that the shower device comprises a lighting assembly for illuminating at least one of the water jet patterns by light with at least one light source, in some embodiments, that all water jet patterns of the different nozzle groups can be directly illuminated via the lighting assembly during shower operation, in some embodiments, that the lighting assembly is at least partially integrated in the second shower head in such a way that the light source of the lighting assembly can be flowed around by the water of the third nozzle group. This embodiment relates to a lighting assembly for illuminating at least one of the water jet patterns, whereby the shower experience can be intensified in a special way, in particular if, according to various embodiments, all water jet patterns of the different nozzle groups can be directly illuminated during shower operation.

According to various embodiments, a method for creating a water jet pattern with a shower device is provided. It is possible that the shower device is designed according to the proposal. Reference may be made to all explanations concerning the shower device according to the proposal. In various embodiments, a first water jet pattern created with the shower device is cone-shaped, and/or a second water jet pattern created with the shower device is sink-shaped, and/or a third water jet pattern created with the shower device is cylindrical. This embodiment relates to the creation of different, particularly aesthetically pleasing, water jet patterns.

According to various embodiments, a shower system with a shower device and a wall, in particular a ceiling, to which the shower device is attached, is provided. It is possible that the shower device is designed according to the proposal. Reference may be made to all explanations concerning the shower device according to the proposal and the method according to the proposal.

Various embodiments provide a shower device for creating at least one water jet pattern with a structural assembly, with a nozzle assembly and with a lighting assembly, wherein the structural assembly provides an exit opening for the emergence of the water discharged by the nozzle assembly and has an outer edge region running about the edge of the exit opening, wherein the exit opening during the shower operation is in particular only partly occupied with emerging water at any given time, wherein the nozzle assembly is arranged distributed along at least a portion of the edge of the exit opening at the edge region, especially along at least a quarter of the edge of the exit opening, and wherein the path of the water discharged by the nozzle assembly during the shower operation runs each time from the edge region in the direction of the exit opening and then through the exit opening.

In various embodiments, the light generated by the lighting assembly emerges at least for a part, such as substantially, from the exit opening.

In various embodiments, the nozzle assembly is arranged distributed along the entire edge of the exit opening.

In various embodiments, the path of the water discharged by the nozzle assembly runs from several different directions from the edge region to the exit opening, such as to a center region of the exit opening, in some embodiments in a star pattern.

In various embodiments, the portion of area through which the water discharged by the nozzle assembly during the shower operation passes through the passage area of the exit opening at any given time is less than 50%, less than 40%, or less than 20%.

In various embodiments, the nozzle assembly comprises a first group of at least two nozzles of a first kind, in some embodiments, that the nozzle assembly comprises a second group of at least two nozzles of a second kind, and, in some embodiments, that the nozzle assembly comprises a third group of at least two nozzles of a third kind.

In various embodiments, the nozzle of the first kind is a splash jet nozzle, and/or, that the nozzle of the second kind is a single jet nozzle, and/or, that the nozzle of the third kind is a splash jet nozzle or a single jet nozzle.

In various embodiments, a valve assembly is provided, with which the nozzle assembly can be actuated with water, in some embodiments, that different nozzles of the nozzle assembly, such as nozzles of a different kind, are actuated in dependence on the kind of water jet pattern.

In various embodiments, the nozzle assembly is actuatable by means of the valve assembly so that the water jet pattern produces a splash jet across at least a portion of the edge of the exit opening that emerges from the edge of the exit opening.

In various embodiments, the nozzle assembly is coordinated with an encircling storage channel, into which the nozzle assembly generally channels water.

In various embodiments, the nozzle assembly is actuatable by means of the valve assembly so that the water jet pattern produces a multitude of single jets across at least a portion of the edge of the exit opening, whose path is a trajectory from the nozzle assembly across the edge region into the exit opening.

In various embodiments, at least a portion of the nozzles of the nozzle assembly, especially the nozzles of the second kind, is/are tilted upward in the mounted condition relative to the horizontal.

In various embodiments, the lighting assembly comprises at least one light source, which is arranged in the edge region of the exit opening, in some embodiments, that the light source is arranged along at least a segment of the edge of the exit opening, in some embodiments, that the lighting assembly has an LED ribbon which is arranged along at least a segment of the edge of the exit opening.

In various embodiments, the lighting assembly has a reflector arrangement and that the light of the lighting assembly is reflected by the reflector arrangement and then emerges through the exit opening, in some embodiments, that the reflector arrangement comprises a hood-shaped reflector, in some embodiments, that the reflector extends across the entire exit opening, in some embodiments, that the reflector extends across at least a portion of the edge region of the exit opening.

In various embodiments, the exit opening is round in configuration, in some embodiments, that the exit opening is circular round in configuration or characterized in that the exit opening is elliptical in configuration or that the exit opening is configured in the manner of an elongated hole.

In various embodiments, the exit opening is a polygon, in some embodiments, that the exit opening is triangular, square, pentagonal or hexagonal.

In various embodiments, the exit opening is multi-sided, in some embodiments, that the exit opening is three-sided, four-sided, five-sided or six-sided.

In various embodiments, the edge region is funnel-shaped at least for a portion, such as in the segment of the edge region facing the exit opening, and that in the mounted condition the funnel-shaped segment of the edge region tapers downward.

In various embodiments, the nozzle assembly and/or the lighting assembly are/is arranged so that in the mounted condition when looking at the exit opening, the nozzle assembly and the lighting assembly are not visible due to the arrangement in the edge region of the exit opening, in some embodiments, that the structural assembly comprises a cover, which provides the edge of the exit opening and which hides at least one portion of the nozzle assembly and/or of the lighting assembly, in some embodiments, that the cover is substantially funnel-shaped or substantially ring-shaped.

In various embodiments, the smallest clear internal dimension of the exit opening is at least 150 mm, at least 200 mm, at least 400 mm, at least 500 mm or at least 800 mm.

Various embodiments provide a shower device for creating at least one water jet pattern, said shower device comprising a nozzle assembly for discharging water, a structural assembly comprising a damming section for damming the water discharged from said nozzle assembly, and an exit opening for discharging the water discharged from said nozzle assembly and dammed in said damming section from said shower device, wherein the damming section comprises a boundary arrangement, which the water passes, at least partially, towards the exit opening during shower operation and wherein the exit opening is associated with a surge rim, which is at least partially occupied by discharged water during shower operation, wherein the boundary arrangement is designed as a flow-through damming structure with several flow paths.

Various embodiments provide a shower device for creating at least one water jet pattern, the shower device comprising a nozzle assembly for discharging water, a structural assembly with a damming section for damming the water discharged by the nozzle assembly, an exit opening for discharging the water discharged by the nozzle assembly and dammed in the damming section from the shower device, and a lighting assembly for illuminating the water discharged from the exit opening, wherein the structural assembly comprises a base body, in which the nozzle assembly, the damming section and the lighting assembly are at least partially accommodated and from which water can be discharged via the exit opening, wherein the exit opening is assigned a surge edge, which is at least partially occupied by discharged water during shower operation, and wherein the exit opening is confined by a circumferential first opening edge, wherein the shower device comprises a functional arrangement comprising at least a part of the lighting assembly and/or at least a part of the nozzle assembly, and, that the functional arrangement is designed as an assembly unit which, in the course of assembly, can be connected to the structural assembly, in particular detachably, in such a way that, in the assembled state, the functional arrangement is at least partially accommodated by the base body, wherein the functional arrangement, in the course of assembly, can be moved, at least partially, through an assembly opening of the structural assembly, which is surrounded by the first opening edge.

Various embodiments provide a shower device for creating at least two water jet patterns, the shower device comprising a nozzle assembly for discharging water with a first nozzle group for creating a first water jet pattern and with a second nozzle group for creating a second water jet pattern, a first shower head, which comprises the first nozzle group and the second nozzle group, and several water supply lines via which water can be supplied to the first shower head, wherein the water supply lines are designed as supply and spacing units for supplying water to the first shower head and for spacing and fastening the first shower head with respect to a wall, in particular a ceiling.

Various embodiments provide a shower device for creating at least two water jet patterns, the shower device comprising a nozzle assembly for discharging water with a first nozzle group for creating a first water jet pattern and/or a second nozzle group for creating a second water jet pattern, a first shower head, which comprises the first and/or second nozzle group, and several water supply lines via which water can be supplied to the first shower head, wherein the nozzle assembly comprises a third nozzle group for creating a third water jet pattern, that the shower device comprises a second shower head, which comprises the third nozzle group and in relation to which the first shower head is arranged, in particular rigidly, in the assembled state, and at least one further water supply line, via which water can be supplied to the second shower head, and that the first shower head and the second shower head are spaced apart from one another at a shower head spacing along a, in particular vertical, geometrical main axis of the shower device.

### BRIEF DESCRIPTION OF THE DRAWINGS

In the following, various aspects shall be explained more closely by means of a drawing depicting merely sample embodiments. The drawing shows:

FIG. 1 a shower assembly according to the proposal with a shower device according to the proposal in a perspective view,

FIG. 2 the shower device from FIG. 1 in a cross-sectional representation along intersecting line II - II during the creation of a first water jet pattern,

FIG. 3 the shower device according to FIG. 2 during the creation of a second water jet pattern,

FIG. 4 the shower device according to FIG. 2 in a cutout representation regarding the edge region of the exit opening and

FIG. 5 another shower device according to the proposal in a representation according to FIG. 4.

FIG. 6 a schematic diagram of a shower system according to the proposal with a shower device according to the proposal in perspective view,

FIG. 7 the shower device according to FIG. 6 in lateral sectional view,

FIG. 8 perspective views of the shower device according to FIG. 6 in a) assembled state and b) during assembly,

FIG. 9 a schematic detail view of a damming section with damming structure of the shower device according to FIG. 6 in perspective view,

FIG. 10 in a) the damming section with damming structure according to FIG. 9 in lateral sectional view and in b) as well as c) one damming module of the damming structure in different views,

FIG. 11 another schematic representation of the shower device according to FIG. 6 during assembly,

FIG. 12 in a) a schematic representation of a functional arrangement designed as a mounting unit in perspective view and in b) a sectional view of a mounting arrangement,

FIG. 13 a schematic diagram of a shower system according to the proposal with a shower device according to the proposal in perspective view,

FIG. 14 a side sectional view of the shower device according to FIG. 13,

FIG. 15 perspective views of the shower device according to FIG. 13 in a) assembled state and b) during assembly,

FIG. 16 a schematic detail view of a damming section with damming structure in perspective,

FIG. 17 in a) the damming section with damming structure according to FIG. 16 in lateral sectional view and in b) and c) respectively a damming module of the damming structure in different views,

FIG. 18 another schematic representation of the shower device according to FIG. 13 during assembly,

FIG. 19 in a) a schematic representation of a functional arrangement designed as a mounting unit in perspective view and in b) a sectional view of a mounting arrangement,

FIG. 20 a schematic representation of a shower system according to the proposal with a shower device according to the proposal in a perspective view from below,

FIG. 21 a sectional view of the shower device according to FIG. 20 during shower operation,

FIG. 22 a sectional view, orthogonal to the sectional view in FIG. 21, of a first shower head of the shower device according to FIG. 20,

FIG. 23 a schematic representation of a shower system according to the proposal with a shower device according to the proposal in a perspective view from below,

FIG. 24 a sectional view of the shower device according to FIG. 23 during shower operation, and

FIG. 25 a sectional view, orthogonal to the sectional view in FIG. 24, of a first shower head of the shower device according to FIG. 23.

### DETAILED DESCRIPTION

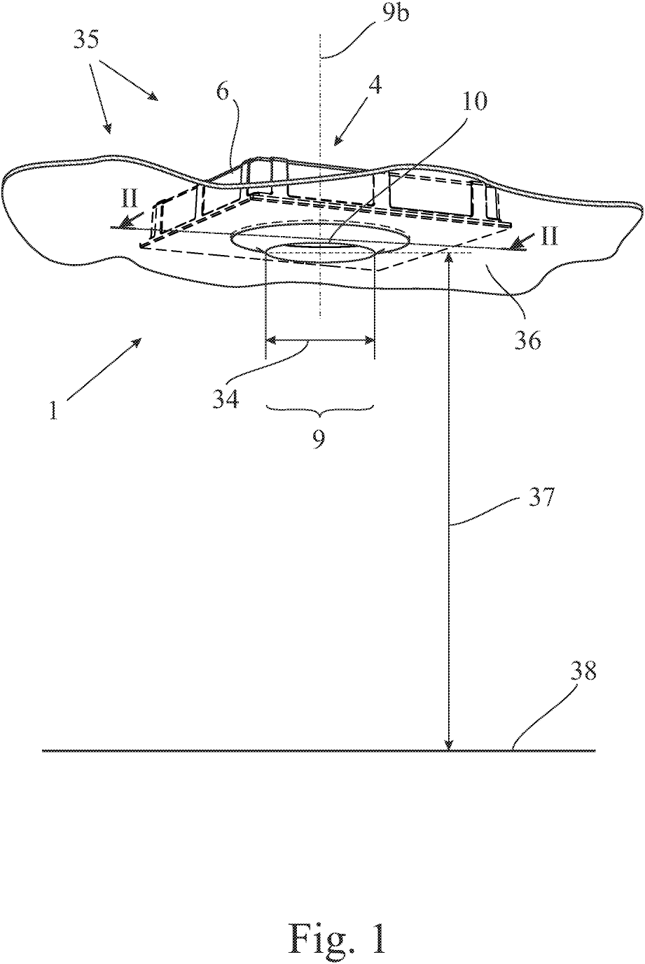

The shower device 1 shown in FIGS. 1 to 5 is used to create at least one water jet pattern 2, 3, as will be explained in detail below.

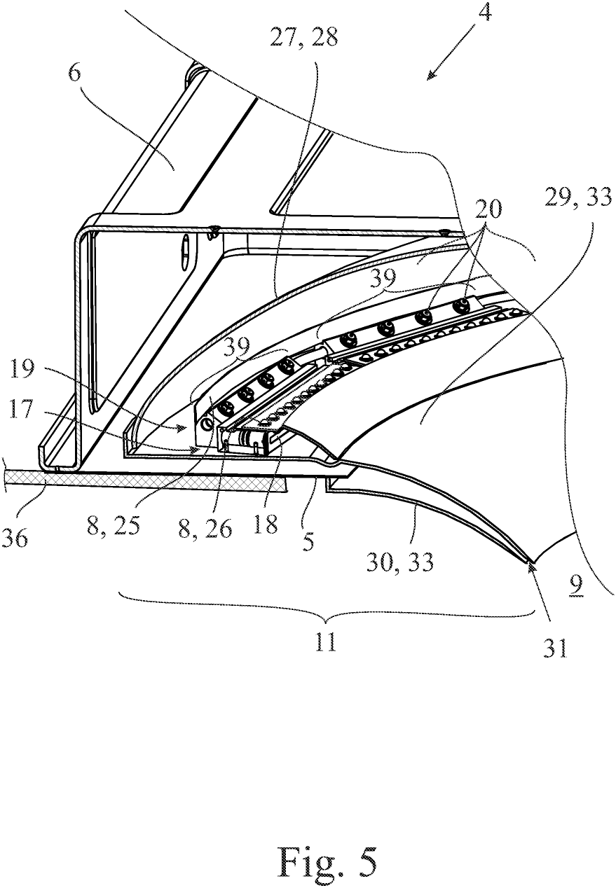

The following remarks apply primarily to the embodiment shown in FIGS. 1 to 4. All explanations in this regard hold accordingly for the embodiment according to FIG. 5, whose fundamental structural layout corresponds to the layout of the embodiment shown in FIGS. 1 to 4.

The shower device 1 is outfitted with a structural assembly 4, which determines the structural mechanical layout of the shower device 1. Here, the structural assembly 4 comprises a carrier assembly 5 and a housing 6 to accommodate the carrier assembly 5. The structural assembly 4 can be formed accordingly from a plurality of components. But it is also conceivable to design the structural assembly 4 as a single piece.

The structural assembly 4 here can be designed to be substantially closed except for the exit opening. In this way, the shower device 1 can be mounted for the most part independently of the particular surrounding circumstances.

In various embodiments, represented here, the structural assembly 4 is such that the shower device 1 as a whole is designed as a cohesive insert module for ceiling installation. But basically the shower device 1 can also be designed as a cohesive surface-mount module.

The shower device 1 moreover comprises a nozzle assembly 7, which shall be explained later on, with at least one nozzle, with at least two nozzles, or with at least three nozzles, for the dispensing of water W. The dispensing of water W by the nozzle assembly 7 occurs at least for a portion of the nozzle assembly 7 in each case toward the exit opening 9, yet to be explained, in particular toward a center region 16 of the exit opening 9. The term “nozzle” should always be taken in the broader sense in the present document.

Moreover, the shower device 1 comprises a lighting assembly 8, which shall also be explained later on, with at least one light source for putting out light.

Now, it is important that the structural assembly 4 has an already mentioned exit opening 9, here a single exit opening 9, for the emergence of the water W discharged by the nozzle assembly 7. The exit opening 9 forms a clear width for the emergence of water W.

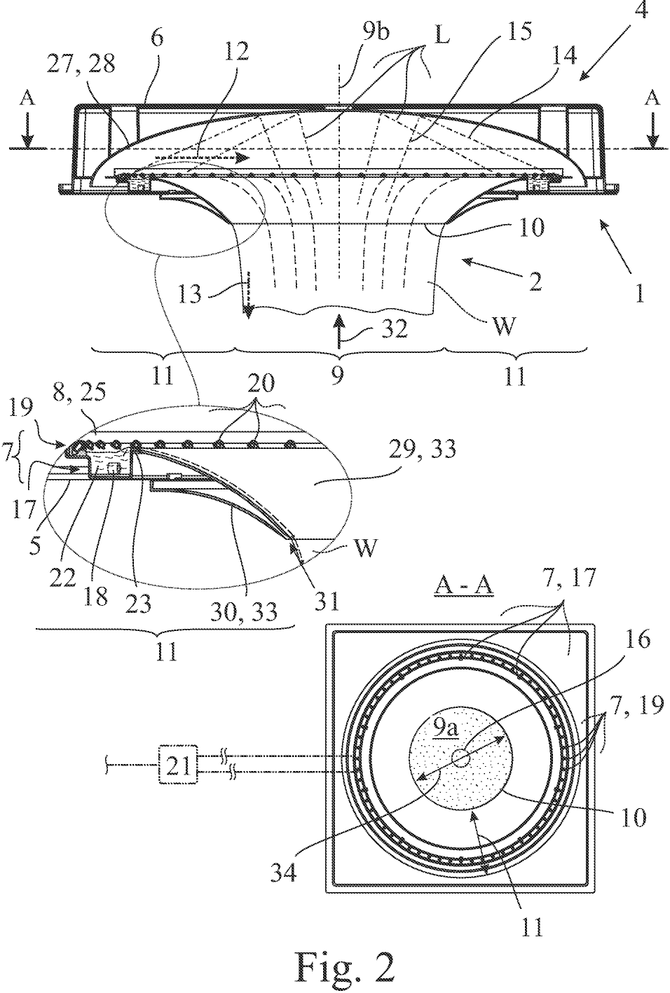

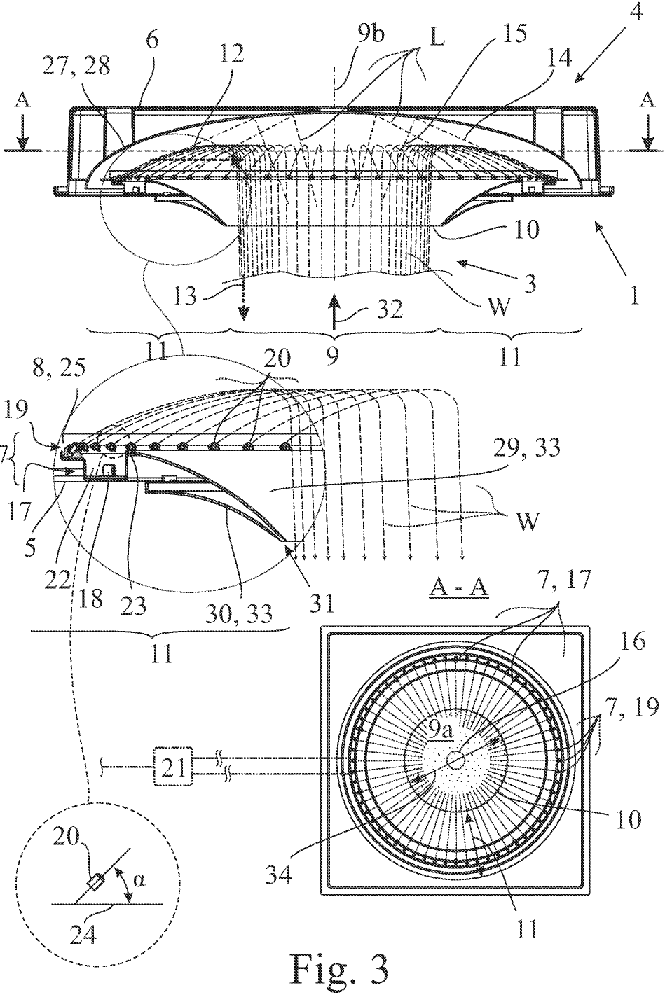

The structural assembly 4 comprises an outer edge region 11 running about the edge 10 of the exit opening 9. As can be seen from the representations according to FIGS. 2 and 3, the edge region 11 in the present instance is defined in that it encircles the exit opening 9. It may be provided here, as shown in FIGS. 2 and 3, that the edge region 11 extends, starting from the edge 10, in a plane which is spaced at an upward distance, in the mounted condition, from the plane which is formed by the edge 10.

The edge region 11 can be formed of a nontransparent material, especially of a plastic material. Thus, it is well suited to hiding the nozzle assembly 7 and/or the lighting assembly 8, as shall be explained.

FIGS. 2 and 3 show two variants for the shower operation of the shower device 1 according to the proposal, in which different water jet patterns 2, 3 can be created. It becomes clear that, when the two water jet patterns 2, 3 are created, the exit opening 9 is only partly occupied with emerging water W at any given time. This means that the exit opening 9 is much larger than would be needed per se for the emergence of the water produced by the nozzle assembly 7. But this opens up the possibility of creating water jet patterns which cannot be created with the usual, small exit openings 9.

From the cross-sectional view A-A according to FIG. 2 it can be seen that the nozzle assembly 7 is arranged distributed along at least a portion of the edge 10 of the exit opening 9 at the edge region 11 provided by the structural assembly 4. It has already been pointed out that the nozzle assembly 7 follows the course of the edge 10 of the exit opening 9.

In various embodiments, the nozzle assembly 7 is arranged distributed along at least a quarter of the edge 10 of the exit opening 9 at the edge region 11 provided by the structural assembly 4, such as along at least a half of the edge 10 of the exit opening 9. Here it can be the case that the nozzle assembly 7 is arranged distributed along the entire edge 10 of the exit opening 9.

Moreover, one sees from FIG. 2 that, during the shower operation, the path of the water W discharged by the nozzle assembly 7 runs each time from the edge region 11 in the direction of the exit opening 9 and then through the exit opening 9. Components of the path of the water W discharged by the nozzle assembly 7 are indicated by the references 12, 13 in FIG. 2.

It can further be seen from FIGS. 1 to 5 that, in the mounted state, the emergence of water W from the exit opening 9 in any case has a downwardly directed motion component. In some embodiments, it is the case that the downwardly directed motion component of the water W is exclusively due to gravity. Thus, the nozzle assembly 7 itself here generates no downwardly directed force component on the water W. Alternatively, it is basically conceivable that the nozzle assembly 7 exerts a downwardly directed force component on the water W, i.e., it brings about a downward acceleration of the water W.

The path of the light L generated by the lighting assembly 8 is indicated by the references 14 and 15 in FIGS. 2 and 3. It is evident from this that here the light L generated by the lighting assembly 8 emerges at least partly, or in some embodiments substantially, from the exit opening 9. Thus, the exit opening 9 has a dual use, namely, on the one hand for the emergence of water W and on the other hand for the emergence of light L, which simplifies the design layout of the shower device 1.

As shown in FIG. 1, the installation position of the shower device 1 can be substantially horizontal, so that the passage area 9a assigned to the exit opening 9 is substantially horizontally directed in the mounted state. The exit opening 9 can be designed symmetrical in regard to an axis of symmetry 9b, wherein the axis of symmetry 9b here can be oriented substantially vertical, i.e., running from top to bottom.

As mentioned above, the nozzle assembly 7 in the depicted embodiments is arranged distributed along the entire edge 10 of the exit opening 9. Regardless of the dimension of the nozzle assembly 7 along the edge 10 of the exit opening 9, the distribution may be uniform or nonuniform.

FIG. 2 shows that the path 12 of the water W discharged by the nozzle assembly 7 runs from several different directions from the edge region 11 to the exit opening 9, here to a center region 16 of the exit opening 9. The center region 16 here lies in the region of the centroid of the exit opening 9.

FIG. 2 shows that, thanks to the uniform distribution of the nozzle assembly 7 along the edge 10 of the exit opening 9, a star-shape profile for the path 12 results. Depending on the water jet pattern 2, 3, the portion of area through which the water W discharged by the nozzle assembly 7 during the shower operation passes through the passage area 9a of the exit opening 9 will change. Basically, the portion of area during the shower operation at any given time may be less than 50%, less than 40%, or, as here, less than 20%. It is clear from the representation according to FIG. 2 that the portion of area 9a here is even much less than 20%. In various embodiments, it is the case that only a region of the exit opening 9 near the edge is occupied with emerging water W, at least in the case of a water jet pattern 2 (FIG. 2), so that in any case the center region 16 is free of water W.

FIGS. 2 to 4 show that the edge region 11 provides a considerable design space for the nozzle assembly 7, so that many different nozzles of the nozzle assembly 7 may be used.

In the depicted embodiment, the nozzle assembly 7 comprises a first group 17 of at least two nozzles 18 of a first kind. In some embodiments, the first group 17 comprises more than two nozzles 18 of the first kind. In the depicted sample embodiment, the nozzle assembly 7 moreover comprises a second group 19 of at least two nozzles 20 of a second kind. In some embodiments, the second group 19 comprises a plurality of nozzles 20 of the second kind. Basically, it is also conceivable, although not represented here, for the nozzle assembly 7 to comprise a third group of at least two nozzles of a third kind, as well as further groups of nozzles of further kinds.

In the depicted sample embodiment, the nozzle 18 of the first kind is quite generally a splash nozzle. In the present case, this means that a single accelerated jet does not emerge from the nozzle 18 of the first kind. In the most simple case, the nozzle 18 of the first kind is a simple hose opening. Alternatively, the nozzle 18 of the first kind may also be a slot nozzle, as shown in FIG. 5.

FIG. 2 shows as an example that a valve assembly 21 is provided, with which the nozzle assembly 7 can be actuated with water W, i.e., impacted with water W, which water W is discharged by the nozzle assembly 7 as mentioned above. In FIGS. 2 and 3, one valve assembly 21 is shown as an example, whose entrance depicted at the left side of the drawing is connected to a water supply and whose exits depicted at the right side of the drawing are connected to the first group 17 of nozzles 18 of the first kind and to the second group 19 of nozzles 20 of the second kind. The nozzle assembly 7 in this regard is hydraulically actuatable by means of the valve assembly 21. The valve assembly 21, in turn, is electrically actuatable by a control assembly, not depicted here.

In various embodiments, different nozzles 18, 20 of the nozzle assembly 7, here nozzles 18, 20 of a different kind, may be actuated in dependence on the kind of water jet pattern 2, 3 desired. Basically, quantities such as water pressure or volume flow can also be adjusted by means of the valve assembly 21 or an additional valve assembly.

For example, the nozzle assembly 7 can be actuated by means of the valve assembly 21 so that the water jet pattern 2 produces a splash jet across at least a portion of the edge 10 of the exit opening 9, emerging from the edge 10 of the exit opening 9. This is shown for example in FIG. 2. Here, the nozzles 18 of the first kind of the nozzle assembly 7 are actuated, i.e., impacted with water W, so that the water W discharged by the nozzle assembly 7 arrives via the edge region 11 at the edge 10 and exits there in the form of a splash jet.

In order to make sure that a uniform splash jet is produced across the edge 10 of the exit opening 9, the nozzle assembly 7 can be coordinated with a storage channel 22, especially an encircling one. The storage channel 22 can be arranged between the nozzle assembly 7 in general, here between the nozzles of the first kind 18, and the edge 10 of the exit opening 9, into which the nozzle assembly 7 in general, here the nozzles 18 of the first kind, supply water W. The water W moves uniformly across the edge 23 of the storage channel 22, which is the basis for a uniform splash jet across the edge 10 of the exit opening 9. The storage channel 22 in the present instance is part of the nozzle assembly 7 and is accordingly arranged at the edge region 11, distributed along at least one segment of the edge 10 of the exit opening 9, here, across the entire edge 10 of the exit opening 9.

In order to create the water jet pattern 3 which is shown in FIG. 3, the nozzle assembly 7 can be actuated by means of the valve assembly 21 so that the water jet pattern 3 produces a multitude of single jets across at least a portion of the edge 10 of the exit opening 9, whose path is a trajectory from the nozzle assembly 7 across the edge region 11 into the exit opening 9. Only the nozzles 20 of the second kind are actuated with water W here, as likewise shown in FIG. 3.

In order to be able to realize the above trajectory of the water W, it is provided that at least a portion of the nozzles of the nozzle assembly 7, here the nozzles 20 of the second kind, is/are arranged tilted upward in the mounted condition relative to the horizontal 24. In the depicted sample embodiment, the aforesaid tilting of the nozzles 20 of the second kind relative to the horizontal 24 is provided about an angle α of around 55°. In some embodiments, the angle of tilt α to the horizontal 24 lies in a range between 30° and 80°, or in a range between 40° and 70°.

The lighting assembly 8 can basically comprise several light sources 25, 26. In some embodiments, it can be the case that the lighting assembly 8 comprises at least one light source 25, which is arranged in the edge region 11 of the exit opening 9. In various embodiments, the light source 25 is arranged along at least a segment of the edge 10 of the exit opening 9. In some embodiments, it is the case that the light source 25 is even arranged along the entire edge 10 of the exit opening 9. It can be provided that the lighting assembly 8 has an LED ribbon as the light source 25, which is arranged along at least a segment of the edge 10 of the exit opening 9. As shown in the representation according to FIG. 2, the LED ribbon here can be arranged along the entire edge 10 of the exit opening 9. A further light source 26 is shown in FIG. 5 and shall be explained further below.

Moreover, the lighting assembly 8 may comprise a light source, not shown, which can be situated in the installed state in the region of the exit opening 9, in FIG. 2 above the edge 10 of the exit opening 9, and in some embodiments above the center region 16 of the exit opening 9. Further light sources of the lighting assembly 8 are conceivable.

In order to realize an indirect illumination of the exit opening 9 as well as of the water W emerging from the exit opening 9, the lighting assembly 8 can be outfitted with a reflector arrangement 27, wherein the light rays of at least one light source 25, 26 of the lighting assembly 8 are reflected by the reflector arrangement 27 and then emerge through the exit opening 9. In the depicted sample embodiment, the reflector arrangement 27 comprises a hood-shaped reflector 28, which here extends across the entire exit opening 9. In some embodiments, and as represented in FIGS. 2 and 3, it is the case that the reflector 28 extends across at least a portion of the edge region 11 of the exit opening 9, especially across the entire edge region 11 of the exit opening 9. It has already been pointed out that such a reflector arrangement 27 produces an optical depth effect when looking into the exit opening 9.

Both embodiments shown in FIGS. 1 to 5 have a round exit opening 9, in particular a circular round exit opening 9. Instead of the circular round form of the exit opening 9, an elliptical configuration of the exit opening 9 or a configuration of the exit opening 9 in the manner of an elongated hole can basically be provided. The round configuration enables a steady course of the water jet pattern 2, 3 along the edge 10 of the exit opening 9, as also already explained.

Alternatively, the exit opening 9 may also be a polygon. In various embodiments, the exit opening 9 is then triangular, square, pentagonal or hexagonal. It should be considered here, as indicated above, that at least one corner of the exit opening 9 may be sharp-edged and/or at least one corner of the exit opening 9 may be rounded.

Basically, the exit opening 9 may also be multi-sided, wherein the exit opening 9 is three-sided, four-sided, five-sided or six-sided, for example. Such a multi-sided configuration encompasses all shapes of the exit opening 9 for which individual sides may be identified. In some embodiments, at least one of these sides is configured straight for at least a portion.

In one embodiment which can be advantageous both in regard to creating the water jet pattern 2, 3 and in a creative respect, the edge region 11 is funnel-shaped at least for a portion, such as in the segment of the edge region 11 facing the exit opening 9, wherein in the mounted condition the funnel-shaped segment 29 of the edge region 11 tapers downward. The funnel-shaped segment 29 forms here a transition segment from the nozzle assembly 7 to the edge 10 of the exit opening 9. In the water jet pattern 2 shown in FIG. 2, a laminar flow is produced from the edge 23 of the storage channel 22 to the edge 10 of the exit opening 9.

Also shown in FIGS. 1 to 5 is the fact that a further funnel segment 30 is mounted on the above funnel-shaped segment 29 from the bottom, which on the one hand further improves the shower device 1 in a creative aspect. On the other hand, it is conceivable to arrange further nozzles between the two funnel-shaped segments 29, 30, which may contribute to the respective water jet pattern 2, 3 in addition to the proposed nozzle assembly 7 in that the water W discharged by these additional nozzles emerges to the outside through the gap 31 produced between the two funnel-shaped segments 29, 30.

An especially attractive creative overall impression is produced in the depicted sample embodiments in that the nozzle assembly 7 and the lighting assembly 8 are arranged so that in the mounted condition when looking 32 at the visible surface of the shower device 1, especially at the exit opening 9, upward in FIGS. 2, 3, the nozzle assembly 7 and the lighting assembly 8 are concealed by the edge region 11 by the assembly in the edge region 11 of the exit opening 9 and thus are not visible. This can basically also be provided only for one of the components, the nozzle assembly 7 and the lighting assembly 8. Thus, the nozzle assembly 1 and/or the lighting assembly 8 can be advantageously concealed to a person standing underneath the shower device 1.

In order to further improve the aforementioned concealed arrangement of the nozzle assembly 7 or of the lighting assembly 8, it can be provided that the structural assembly 4 comprises a cover 33, which provides the edge 10 of the exit opening 9 and which hides at least one portion of the nozzle assembly 7 and/or of the lighting assembly 8 in the above looking 32 at the visible surface of the shower device 1. In some embodiments, the cover 33 is at least partly substantially funnel-shaped and is provided by the two funnel-shaped segments 29, 30. Alternatively, it can also be provided that the cover 33 has other shapes and is substantially ring-shaped, for example. As can be seen in the drawing, the cover 33 here forms part of the aforementioned edge region 11 of the exit opening 9.

The exit opening 9 of the shower device 1 according to the proposal is comparatively large, as already explained above. In some embodiments, the smallest clear internal dimension 34 of the exit opening 9 is at least 150 mm, at least 200 mm, at least 400 mm, at least 500 mm or at least 800 mm in a variant suitable for particularly large spaces. Depending on the place of installation, a correspondingly unique overall impression is produced with suitable choice of the exit opening 9.

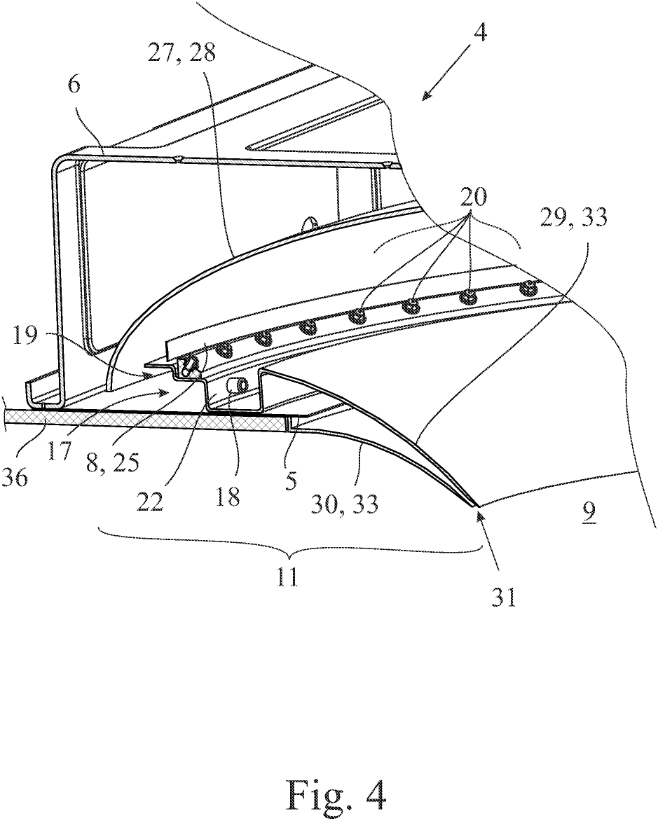

FIG. 5 shows another embodiment of a shower device 1 according to the proposal in a representation according to FIG. 4. As already explained, the layout of this other shower device 1 corresponds to the layout of the shower device 1 represented in FIGS. 1 to 4.

One feature of the shower device 1 depicted in FIG. 5 is that the nozzle assembly 7 is realized by a plurality of linear strip segments 39, which are arranged along the edge 10 of the exit opening 9. Accordingly, the feature of the distribution of the nozzle assembly 7 along the edge 10 of the exit opening 9 should be interpreted broadly, as indicated above.

Moreover, the nozzles 18 of the first kind are slot nozzles here, whose slots in turn are arranged along the edge 10 of the exit opening 9. This favors the uniform creation of the splash jet along the edge 10 of the exit opening 9 in the case of the water jet pattern shown in FIG. 2. Accordingly, is it also not absolutely necessary in the sample embodiment shown in FIG. 5 to realize a storage channel 22 associated with the nozzle assembly 7 of the kind shown in FIG. 2. The storage channel 22 indicated in FIG. 5 is much more shallow, so that a drainage of the water W remaining in the storage channel 22 after the use of the shower device 1 is no problem.

Finally, it is noteworthy in the embodiment shown in FIG. 5 that an additional light source 26 is provided in the form of an illuminant 26a distributed along the edge 10 of the exit opening 9, especially LEDs, which beams onto a portion of the water W discharged by the nozzle assembly 7. In some embodiments, it is the case that the additional light source 26 beams onto the water W situated on the aforementioned trajectory, so that the water W situated on the trajectory acts as a kind of lightguide. In this way, especially interesting optical lighting effects can be produced.

It may further be pointed out that the shower device 1 according to the proposal can basically have additional nozzle assemblies, which can be designed and arranged in the usual manner. For example, additional nozzles may also be arranged in the visible surface of the shower device 1, without the overall device departing from the proposed teaching.

Also shown is a shower assembly 35 with a ceiling 37 and a floor 38 and also with a shower device 1 according to the first mentioned teaching, wherein the shower device 1 is mounted in or on the ceiling 36 above the floor 38.

The mounting in the ceiling 36 is shown in FIG. 1. The exit opening 9 here lies roughly in the plane of the ceiling 36, which can fundamentally be a suspended ceiling. Reference may be made to all remarks on the device 1 according to the proposal.

The shower device 1 may also be mounted on a ceiling 36 and, in some embodiments, set onto the ceiling 36. It is conceivable that the essential portion of the shower device 1 in the mounted state is arranged offset downward from the ceiling 36.

As mentioned above, special importance is attached to the ratio between the smallest clear internal dimension 34 of the exit opening 9 and the height 37 of the exit opening 9 or the ceiling 36 above a floor 38. In some embodiments, the ratio between the smallest clear internal dimension 34 of the exit opening 9 and the height 37 of the exit opening 9 or the ceiling 36 above the floor 38 is greater than 0.05, greater than 0.1, greater than 0.2, or in particular greater than 0.3.

In the case of water jet patterns 2, 3, which exit from the edge 10 of the exit opening 9, there may regularly occur in the course of the downwardly directed path 13 of the water W a point of bundling of the water W, similar to a focal point in optical systems. In some embodiments, it is the case that the point of bundling in the proposed shower assembly 35 is situated above the floor 38 on top of which the shower assembly 35 is mounted. This has proven to be advantageous in experiments on the practical use of the particular water jet pattern 2, 3.

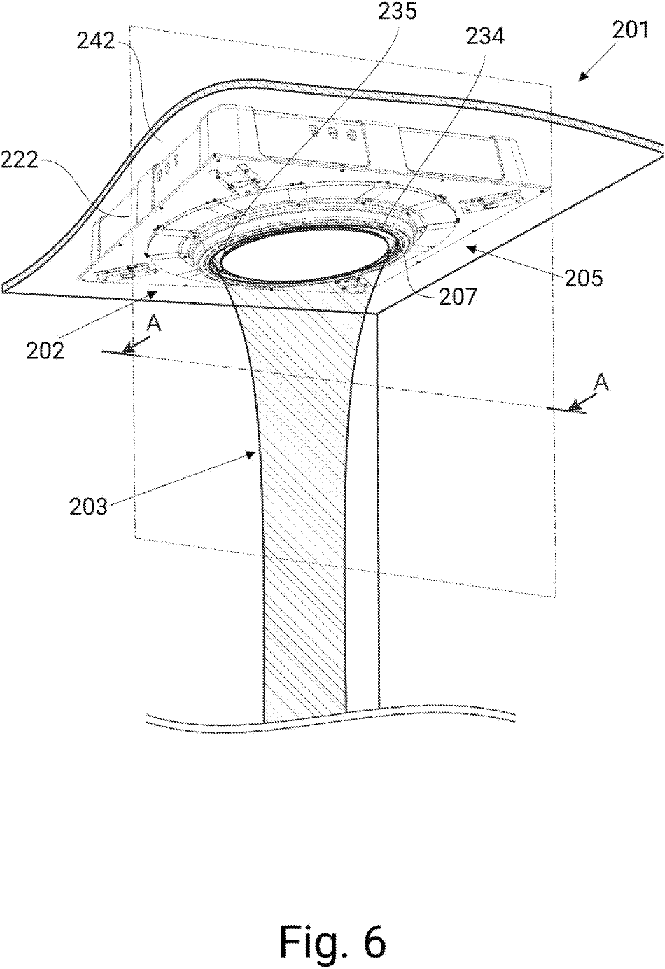

According to a further teaching described with reference to FIGS. 6 to 12, a shower device 1 for creating at least one water jet pattern 2, 3 is provided, the shower device comprising a nozzle assembly 7 for discharging water, a structural assembly 4 having a damming section for damming the water discharged from the nozzle assembly 7, and an exit opening 9 for the discharge of the water discharged by the nozzle assembly 7 and dammed in the damming section of the shower device 1, wherein the damming section comprises a boundary arrangement, which the water passes at least partially towards the exit opening 9 during the shower operation, and wherein the exit opening 9 is associated with a surge rim, which is at least partially occupied by discharging water during the shower operation. It can be that the boundary arrangement is designed as a flow-through barrage structure with several flow paths. Reference may be made to all explanations concerning the shower device 1 according to the first teaching.

In detail, with reference to FIGS. 6 to 12, the following:

FIG. 6 illustrates an overview of a shower system 201 according to the proposal, including a shower device 202 according to the proposal. First, the shower device 202 will be discussed in detail below. The shower system 201 will be discussed later in the description.

The embodiment shown relates to a shower device 202 for creating at least one water jet pattern 203. In some embodiments, the water jet pattern 203 is formed as a coherent, closed water jet. However, alternative water jet patterns 203 are equally conceivable, such as, in particular, a coherent, partially closed water jet or a water jet, which is only coherent in sections.

The shower device 202 comprises a nozzle assembly 204 for dispensing water. Further, the shower device 202 comprises a structural assembly 205 comprising a damming section 206 for damming water discharged from the nozzle assembly 204. In the damming section 206, water discharged by the nozzle assembly 204 during shower operation can first be dammed before being discharged, for example, as a surge of water. For this purpose, the shower device 202 comprises an exit opening 207, via which the water discharged by the nozzle assembly 204 and accumulated in the damming section 206 can exit the shower device 202 accordingly. When water emerges from the exit opening 207, the water jet pattern 203 can be formed accordingly.

With respect to the damming section 206, it is provided that the damming section 206 includes a boundary arrangement 208, which the water passes, at least partially, towards the exit opening 207 during the shower operation. The water can flow from the damming section 206 towards the exit opening 207, passing through the boundary arrangement 208.

The exit opening 207 is associated with a surge rim 209, which is at least partially occupied by discharged water during shower operation, in particular at all times. The association of the surge rim 209 with the exit opening 207 may be to the extent that the water flows from the surge rim 209 toward the exit opening 207 and exits therefrom. The surge rim 209 may allow the water jet pattern 203 to be formed as a surge of water, in that the exiting water flows over the surge rim 209. In particular, the surge rim 209 may be arranged, such that water from the at least partially occupied surge rim 209 exits the exit opening 207. If only a portion of the surge rim 209 is occupied by water, the resuit may be, for example, a water surge that is only partially coherent or a coherent, partially closed water surge.

In some embodiments of the shower device 202, the boundary arrangement 208 of the shower device 202 is designed as a flow-through damming structure 210 with several flow paths 211. The flow paths 211 can ensure sufficient damming in the damming section 206 and, at the same time, the damming structure 210 itself can be designed to be flowable therethrough. In particular, it is conceivable that the flow paths 211 are formed by several damming elements 212, as will be explained below.

Whereas in the prior art the boundary arrangement 208 is passed by water accumulating in the damming section 206 and then flowing over the boundary arrangement 208, when a certain damming height 213 is reached, in the shower device 202 according to the proposal, the dammed water is provided to flow through the boundary arrangement 208 formed as a damming structure 210.

In some embodiments, the damming structure 210 includes several damming elements 212 for damming water. In some embodiments, the damming elements 212 are evenly spaced apart from each other in the main flow direction 214 of the water flowing from the damming section 206 to the exit opening 207 and/or transversely thereto, at least evenly spaced apart from each other in sections. The spacing in the main flow direction 214 and transversely to the main flow direction 214 of the damming elements 212 may be of the same or different sizes. In some embodiments the damming structure 210 comprises at least 500, at least 1000, or at least 2000, damming elements 212.

In some embodiments, in addition or alternatively, it is provided that the damming elements 212 are arranged in several rows in the main flow direction 214 of the water flowing from the damming section 206 to the exit opening 207 and/or that the damming elements 212 are arranged in several rows transversely to the main flow direction 214 of the water flowing from the damming section 206 to the exit opening 207. It may be provided that the rows of the damming elements 212, in particular rows directly adjacent to each other, are arranged in an offset manner with respect to each other.

The main flow direction 214 of the water results from the flow of the water from the damming section 206 to the exit opening 207, which is predetermined by the design. In the embodiment according to FIG. 6, the main flow direction 214 of the water corresponds to a radial direction. The direction transverse to the main flow direction 214 is inclined, in particular orthogonal, to the main flow direction 214 and corresponds, in some embodiments, to the circumferential direction around the exit opening 207 along which, in particular, the damming structure 210 extends circumferentially.

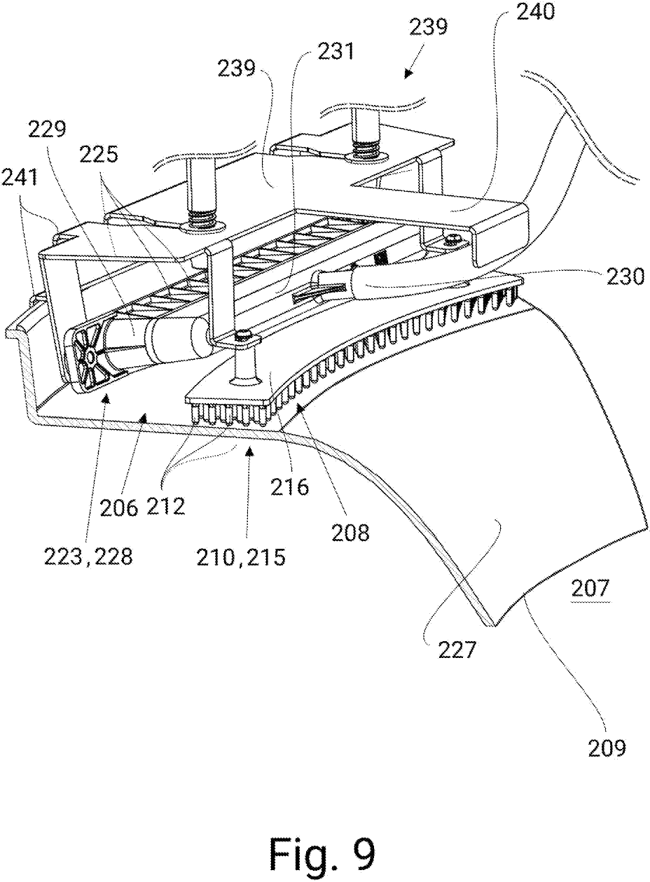

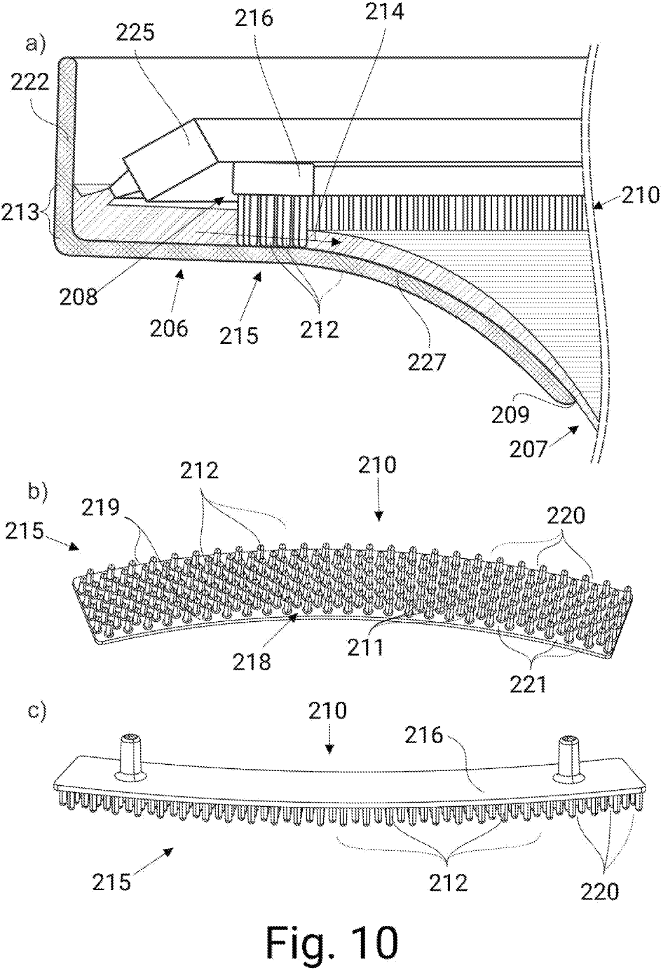

In FIG. 9 and FIGS. 10a), 10b) and 10c), the several damming elements 212 of the damming structure 210 are exemplarily shown. In the main flow direction 214 of the water, which runs from the damming section 206 towards the exit opening 207, the damming elements 212 are equally spaced apart and arranged in several rows, such as in more than three rows or in more than four rows. Transversely to the main flow direction 214, in particular in the circumferential direction, the damming elements 212 are also spaced at equal distances from one another and arranged in several rows. Since the damming structure 210 is formed according to the embodiment shown in FIG. 9 and, in some embodiments, by several damming modules 215, it is conceivable that the damming elements 212 are arranged transversely to the main flow direction 214 only in sections, namely within a damming module 215, at equal distances from one another. Further explanations of the damming modules 215 will be given below.

In the present context, a module, in this case a damming module 215, is always to be understood as a pre-assembled unit.

In some embodiments, it is provided that the damming elements 212 are formed as columnar damming elements 212. It is possible that the damming elements 212 are conical or cylindrical in shape. Furthermore, it is equally conceivable that the damming elements 212 comprise a polygonal cross-section instead of a round cross-section.

Further, it can be provided that the damming structure 210 is formed as one or more damming modules 215. The damming module 215 or the damming modules 215 may, in some embodiments, each comprise at least one damming element 212 or several damming elements 212 and at least one base element 216. The damming element 212 or the damming elements 212 are arranged on the respective base element 216. In this case, the damming elements 212 are arranged on the base element 216 in a uniformly spaced manner, in particular in the main flow direction 214 and/or transversely with respect to the main flow direction 214. It may be provided that the damming module 215 or the damming modules 215 each has or have at least 20, at least 50, at least 100, or at least 200, damming elements 212. In particular, the several damming modules 215 may be of the same design. The damming module 215 or the damming modules 215, in particular the respective base element 216 and the damming elements 212, in some embodiments may be formed integrally. In particular, the damming elements 212 may be arranged on the base element 216 without contacting each other. At least part of the damming modules 215, or in some embodiments all of the damming modules 215, may or may not be of the same design, in particular with respect to the base element 216 and the damming elements 212.

It has proven useful that the basic element 216 is curved, in particular around a geometric main axis 217 of the shower device 202, and/or comprises a plate-like design. The geometric main axis 217 is here the central axis around which the edge of the exit opening 207 extends. In particular, this extends in the vertical direction. The vertical direction is here the direction of gravity. Accordingly, the horizontal direction is the direction orthogonal thereto.

With regard to the arrangement of the damming elements 212 on the base element 216, it has proven advantageous if the damming elements 212 are arranged on the base element 216 on several circular paths. The circular paths can each comprise a different curvature and a common center, or each comprise the same curvature and a different center.

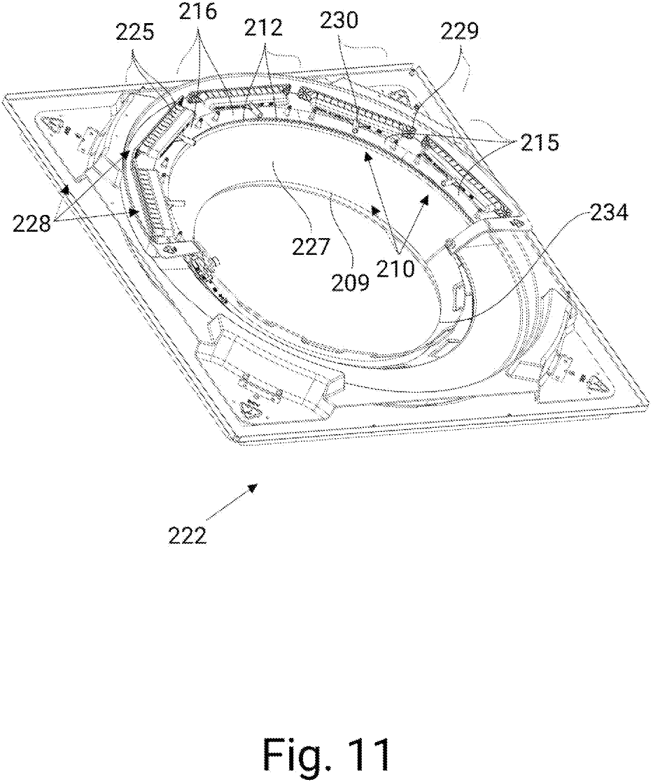

From FIGS. 9 and 11, it can be seen by way of example that the damming structure 210 is formed as several damming modules 215, such as at least four damming modules 215, at least eight damming modules 215, or at least ten damming modules 215. Each of the damming modules 215 comprises several damming elements 212, which are arranged on a plate-like base element 216 of the respective damming module 215, as shown for example in FIG. 10b). In some embodiments, the damming modules 215 are arranged side by side, in particular annularly.

It is equally conceivable that the damming module 215 or the damming modules 215 is or are each formed as a perforated plate or perforated plates, in particular with round or elongated holes. In this case, the damming elements 212 can in particular be formed as elements delimiting the holes, and the base element 216 can in particular hold together the elements delimiting the holes.

In some embodiments, flow paths 211 are formed through the damming elements 212. The flow paths 211 may allow flow through the damming structure 210. Alternatively or additionally, it is possible that the flow paths 211 are formed such that the water flowing through the damming structure 210 is deflected several times, such as at least twice or at least four times, in particular by the damming elements 212. The deflection can take place within the damming structure 210. The local direction of flow of the water, i.e., the direction of flow at a particular point in the damming structure 210, may be changed in this case, but the main direction of flow 214 of the water from the damming section 206 towards the exit opening 207 may remain the same. In this respect, a multiple redirection of the water across the damming structure 210, i.e., in particular within the damming structure 210, may take place. The flow paths 211 can each be formed by at least two, at least four, or at least eight, damming elements 212. The flow paths 211, in particular of a damming module 215, may be confined on one side by the base element 216, in particular of the damming module 215.

In some embodiments, at least some of the flow paths 211, in particular at least some or all of the flow paths 211 of a damming module 215, form a coherent channel structure 218. The flow paths 211 of the damming structure 210, in particular the flow paths 211 of a damming module 215, can thus be interconnected, in particular fluidically. To this extent, within the channel structure 218, the flow paths 211 may not be delimited from one another.

The flow paths 211 are exemplified by FIG. 10b). In some embodiments, the plurality of damming elements 212 form the plurality of flow paths 211, wherein the flow paths 211 of a damming module 215 form a coherent channel structure 218. In some embodiments, the damming elements 212 of the rows arranged one behind the other in the main flow direction 214, are arranged offset from one another. This results in multiple deflections of the water across the damming structure 210 during shower operation.

Further, it is provided in some embodiments, that the damming structure 210 comprises several openings 219. In some embodiments, the openings 219 are formed by the damming elements 212 themselves, meaning laterally bordered by them. In some embodiments, a portion of the openings 219 are formed as inlet openings 220 for the inflow of water into the flow paths 211 of the damming structure 210 and a portion of the openings 219 are formed as exit openings 221 for the outflow of water from the flow paths 211 of the damming structure 210. In some embodiments, it may be provided that the number of damming elements 212 exceeds the number of openings 219. In some embodiments, a damming module 215 comprises at least 10, at least 15, or at least 20, inlet openings 220 and/or exit openings 221.

Exemplarily, FIG. 10b) shows that a part of the openings 219 is formed as inlet openings 220 and the other part of the openings 219 is formed as exit openings 221. The inlet openings 220 are, in some embodiments, arranged facing the damming section 206 and the exit openings 221 are, in some embodiments, arranged facing the exit opening 207, as exemplified by FIG. 10a). In some embodiments, the openings 219 are confined on one side by the respective base element 216. In some embodiments, openings 219 arranged adjacent to each other may be spaced apart from each other by at least one damming element 212, respectively. It is further, in some embodiments, the case that an inlet opening 220 allows the inflow of water to several, in particular two, flow paths 211. The exit openings 221 may each, in some embodiments, allow the exit of water from several, in particular two, flow paths 211. The inlet openings 220 are, in some embodiments, facing the damming section 206, and the exit openings 221 are, in some embodiments, facing away from the damming section 206 and facing the exit opening 207.

Furthermore, it is provided in some embodiments, that the damming structure 210 is designed in such a way that the water in the damming section 206 can completely run off towards the exit opening 207 after the shower operation. In particular, the damming elements 212 can be adjacent to a base body 222 of the shower device 202 on one side. In some embodiments, the damming elements 212 are adjacent to a lowest point of the damming section 206, allowing the water to drain out of the damming section 206 after the shower operation.

As exemplified in FIG. 10a), the water in the damming section 206 after the shower operation can completely drain towards the exit opening 207. Due to the flow-through capability of the damming structure 210 formed by the several damming elements 212, the water drains completely from the damming section 206, thereby avoiding water accumulation in the damming section 206 after the shower operation.

Alternatively or additionally, it may be provided that the damming structure 210 is configured such that the cross-section of the flow paths 211 through which water flows is dependent on the damming height 213 of the water dammed by the damming structure 210 in the damming section 206. The cross-section of the flow paths 211, through which water can flow, may increase approximately with the damming height 213 of the water dammed in the damming section 206.

From FIG. 10a), for example, it can be seen that the cross-sectional area of the flow paths 211 through which the flow passes is dependent on the damming height 213. If the damming height 213 increases in the damming section 206, the cross-sectional area of the flow paths 211 increases. If the damming height 213 in the damming section 206 decreases, the cross-section of the flow paths 211 decreases.

In some embodiments, the damming structure 210 is configured such that the damming height 213 of the water dammed in the damming section 206 is dependent on the volumetric flow rate of the water discharged from the nozzle assembly 204.

From FIG. 10a), it can be seen by way of example that larger volumetric flows of water discharged through the nozzle assembly 204 result in greater damming heights 213, than is the case for smaller volumetric flows.

It may be provided that the damming structure 210 is configured such that the volumetric flow rate of the water flowing through the damming structure 210 is dependent on the damming height 213 of the water dammed by the damming structure 210 in the damming section 206.

It is further provided, in some embodiments, that the nozzle assembly 204 comprises a first nozzle group 223, via which a first water jet pattern 203, in particular formed as a circumferential or partially circumferential water jet, can be created. In some embodiments, it is provided that the nozzle assembly 204 comprises a second nozzle group 224, via which a second water jet pattern 203, in particular formed as several water jets, which differs in particular from the first water jet pattern 203, can be created. In some embodiments, it is provided that the first nozzle group 223 comprises one or more nozzles of the first type 225, which is or are configured as a jet nozzle or jet nozzles and/or as a surge nozzle or surge nozzles. In some embodiments, the second nozzle group 224 comprises one or more nozzles of the second type 226, which is or are configured as a jet nozzle or jet nozzles or as a surge nozzle or surge nozzles. In particular, it is possible for the nozzle groups to be individually controllable so that the first water jet pattern 203 can be created independently of the second water jet pattern 203. It is, in some embodiments, possible that via the nozzle or nozzles of the first type 225 water can be discharged indirectly via the exit opening 207 by guiding the water from at least one guide surface 227 of the structural assembly 205, in particular of the base body 222, prior to discharge from the exit opening 207, wherein in some embodiments the surge rim 209 is part of the guide surface 227.

In some embodiments, the first nozzle assembly 223 comprises one or more first type nozzle modules 228, each formed by one or more first type nozzles 225 and a first nozzle holder 229 for holding the one or more first type nozzles 225. The one or more nozzles of the first type 225 may be disposed on the nozzle holder. In some embodiments, the one or more first type nozzle holders 229 each includes a water supply 230 and a water distribution system 231 for supplying and distributing water to the one or more first type nozzles 225. The water supply 230 may allow connection of a hose or pipe to supply water to the nozzle or nozzles. The first nozzle holder 229 may be or the first nozzle holders 229 may each be formed in one piece.

A module, in this case a nozzle module, is always to be understood as a pre-assembled unit in the present context, as already indicated.

Alternatively or additionally, it is possible for the second nozzle assembly 224 to include one or more second type nozzle modules 232 each formed by one or more second type nozzles 226 and a second nozzle holder 233 for holding the one or more second type nozzles 226. In some embodiments, the one or more second nozzle holders 233 each includes a water supply 230 and a water distribution system 231 for supplying and distributing water to the one or more second type nozzles 226. The water supply 230 may allow connection of a hose or pipe to supply water to the nozzle or nozzles. The second nozzle holder 233 may be or the second nozzle holders 233 may each be formed in one piece.

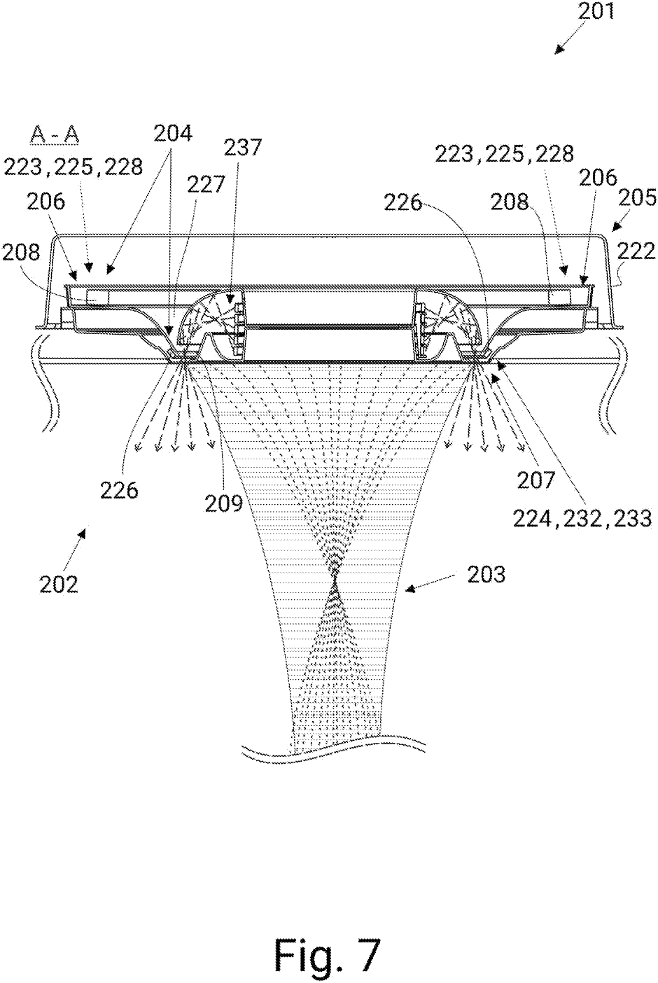

FIG. 9 shows an exemplary nozzle module of first type 228. The nozzle device comprises, in some embodiments, a plurality, at least four, at least eight, or at least ten, nozzle modules of the first type 228, as can be seen, for example, in FIG. 11. The nozzle modules of the first type 228 each comprise a nozzle holder, on which several nozzles of the first type 225 are arranged side by side. The nozzle holders are each formed in one piece and comprise an internal water distribution system 231 and a water supply 230. The water supplies 230 are each configured as push-in connections for push-in attachment of a water hose. In some embodiments, the water supplies 230 are each oriented opposite the corresponding nozzles of the first type 225. The nozzles of the first type 225 can be arranged facing away from the exit opening 207 in such a way that they can discharge water into the damming section 206 during shower operation. FIG. 7 shows exemplary nozzle modules of the second type 232.

Further, it is provided, in some embodiments, that the damming section 206 is formed as a circumferential channel. In some embodiments, the damming section 206 is confined on one side by the damming structure 210. In some embodiments, on the side facing the exit opening 207, the damming section 206 may be confined by the damming structure 210. In some embodiments, the damming section 206 formed as a circumferential channel may be annular, and in some embodiments elliptical or circular. In some embodiments, the dam section 206 may be partially or fully circumferential. In some embodiments, the damming structure 210 is arranged in such a way that the damming elements 212 adjoin the lowest point of the damming section 206, which is formed as a circumferential channel, in particular on the end face. In the assembled state of the shower device 202, the base element 216 may be arranged in a vertical direction above the damming elements 212. Corresponding to the damming section 206, the damming structure 210 may be partially or fully circumferential and/or round, in particular elliptical or circular.

From FIG. 7 and FIG. 9, it can be seen by way of example that the damming section 206 is formed as a circumferential channel in which water can be dammed. The damming section 206 is annular and coherent and surrounds the exit opening 207. The damming section 206 is arranged coaxially to the exit opening 207. The front side of the damming elements 212 adjoins the deepest regions of the damming section 206, which is formed as a circumferential channel.

In some embodiments, it is provided that water flows through the exit opening 207 only partially during the shower operation, in particular at all times, namely only at the edge. It can be that the exit opening 207 is not completely occupied by water at any time.

It is conceivable that the exit opening 207 is annular, in particular circular or elliptical. In particular, the exit opening 207 can be formed circumferentially, such as partially circumferential or fully circumferential. It is possible that the surge rim 209 associated with the exit opening 207 is also circular or elliptical in shape. In particular, the surge rim 209 may be formed circumferentially, such as partially circumferentially or fully circumferentially. In some embodiments, the surge rim 209 may be arranged coaxially with the exit opening 207. The surge rim 209 may be formed as part of the structural assembly 205.

It is further provided, in some embodiments, that the, in particular annular, exit opening 207 is confined by a first opening edge 234 and, in some embodiments, by a second opening edge 235. It is possible that the first opening edge 234 is free of water, in particular water discharged by the first nozzle group 223, at any time during the shower operation. Alternatively or additionally, it is possible that the second opening edge 235 is free of water, in particular water discharged by the first nozzle group 223, at all times during the shower operation. It may be provided that the first opening edge 234 is at least partially occupied by water, in particular discharged by the second nozzle group 224, at all times during the shower operation, in particular when water is discharged from the second nozzle group 224. Alternatively or additionally, it may be provided that the second opening edge 235 is at least partially occupied at all times by water, in particular discharged by the second nozzle group 224, during the shower operation, in particular when water emerges from the second nozzle group 224. “Partially occupied at all times during shower operation” means in this context that not the complete opening edge is occupied by water, but rather that at all times during shower operation this edge is only in stretches or sections occupied , thus providing water-free areas.

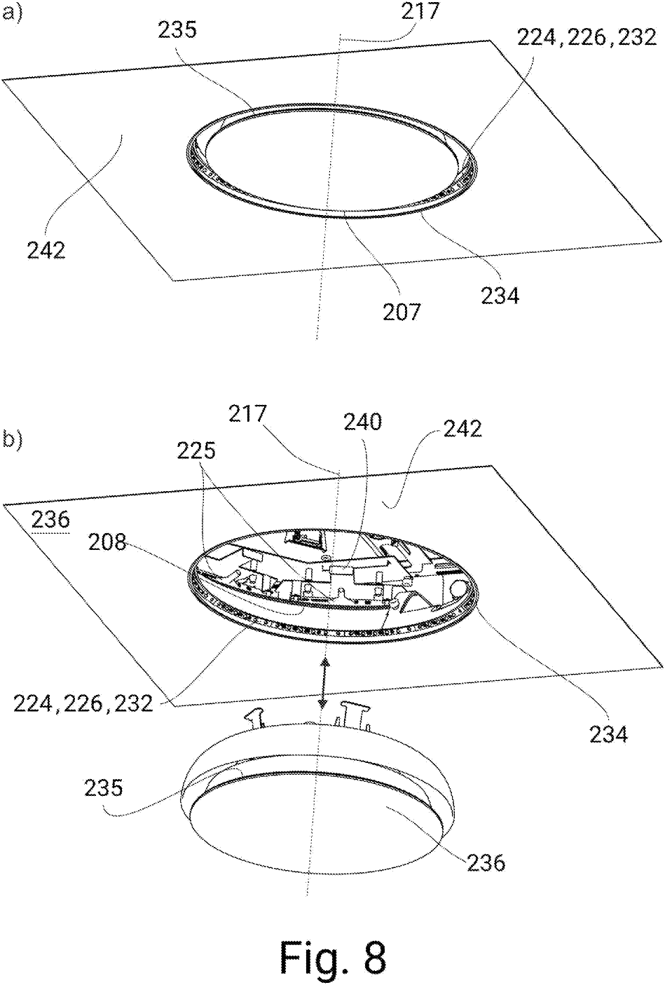

As exemplarily shown in FIG. 8a), the exit opening 207 of the shower device 202 is confined by a first opening edge 234 and a second opening edge 235. Here, the exit opening 207 is correspondingly circular and annular in shape. The first opening edge 234 surrounds, in some embodiments, the second opening edge 235. The first opening edge 234 is arranged, in some embodiments, coaxially with the second opening edge 235. In the embodiment shown in FIG. 7, the first opening edge 234 and the second opening edge 235 can be at all times free of water discharged through the first nozzle group 223. The exit opening 207 is associated with the surge rim 209, which is why the water discharged by the first nozzle group 223 passes through the exit opening 207 in a surge-like manner without contacting the first opening edge 234 and the second opening edge 235. Also exemplified in FIG. 7, the water discharged from the second nozzle group 224 can pass through the discharge opening 207 without contacting the first opening edge 234 or the second opening edge 235. In the embodiment, the first opening edge 234 and the second opening edge 235 are thus free of water at all times during shower operation.

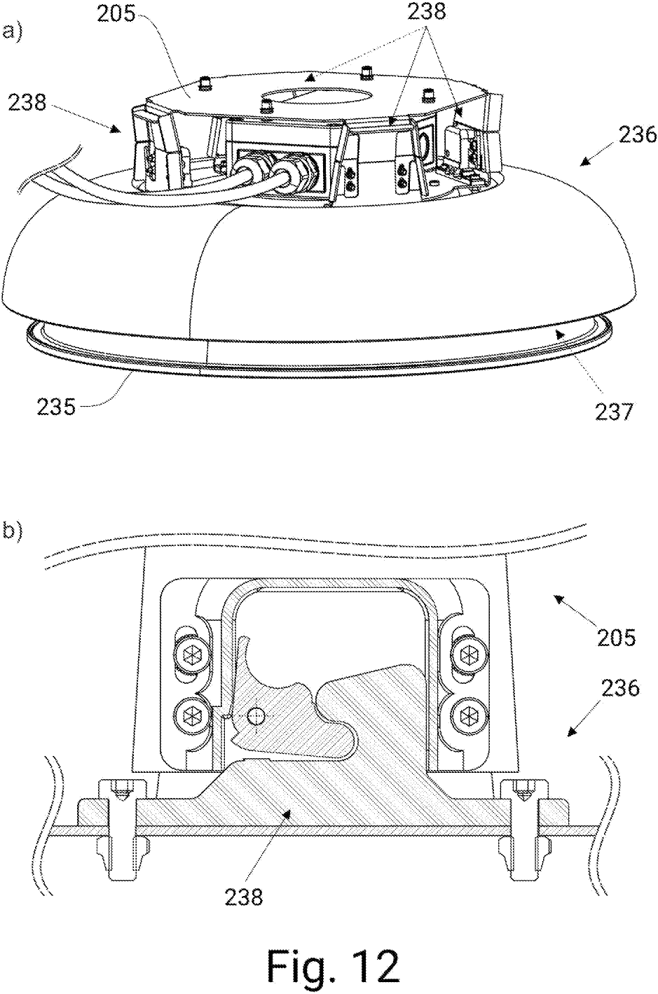

In some embodiments, the structural assembly 205 comprises a base body 222. The base body 222 can form a housing, which is at least partially or predominantly closed, in particular at least laterally and vertically upwards, in and on which, for example, the components of the shower device 202 are at least partially arranged. It can be possible that a functional arrangement 236, in particular formed as an assembly unit, is arranged, in particular detachably, on the base body 222. Such a functional arrangement 236 is shown in FIGS. 8a) and 8b) in perspective from below and in FIG. 12a) in perspective from above. In particular, the functional arrangement 236 may comprise functional components of the shower device 202. “Functional components” are components that are necessary for the shower operation. In some embodiments, the functional arrangement 236 comprises at least a portion of a lighting assembly 237 and/or at least a portion of the nozzle assembly 204. It may be provided that the lighting assembly 237 comprises at least one light source arranged in such a way that the at least one water jet pattern 203 can be illuminated with light, in particular indirectly. In some embodiments, the functional arrangement 236 comprises a light deflector, which deflects the light towards the exit opening 207. In particular, the light deflection can be designed in the manner of a screen.

From FIG. 6, it can be seen by way of example that the structural assembly 205 can include a base body 222. The base body 222 is formed in the manner of a box-shaped housing. A functional arrangement 236 configured as an assembly unit can be arranged on the base body 222 during assembly, as shown for example in FIGS. 8a) and 8b). The functional arrangement 236 can be disassembled for maintenance. As shown, for example, in FIG. 7, the functional arrangement 236 comprises a lighting assembly 237 comprising several light sources. The light sources are, in some embodiments, LEDs and are arranged, such that light emitted from the light sources indirectly illuminates the water jet pattern 203. For this purpose, the functional arrangement 236 comprises a light deflector formed in the manner of a screen.

According to a further embodiment, the first opening edge 234 is formed as part of the base body 222 and/or the second opening edge 235 is formed as part of the functional arrangement 236. Exemplarily, this results from FIGS. 8a) and 8b).

It can be provided that the shower device 202 comprises a fastening arrangement 238, wherein the functional arrangement 236 can be fastened, i.e. mechanically connected, to the structural assembly 205 via the fastening arrangement 238 in a manual assembly movement. In FIG. 8b), a manual assembly movement is indicated. During the manual assembly movement, the functional arrangement 236 may be moved relative to the structural assembly 205. The manual assembly movement may comprise a rotational movement and/or a linear movement. Here, in some embodiments, the manual assembly movement comprises a purely linear movement of the functional arrangement 236 aligned with respect to the structural assembly 205 in a vertical direction.

Various embodiments provide that the fastening arrangement 238 is designed as a latchable fastening arrangement 238, in which at least one fastening element and at least one fastening point can be latched to one another, in particular in a self-locking manner (FIG. 12b)). This enables a, in particular self-locking, latching connection. The at least one fastening element is arranged on the functional arrangement 236 and the at least one fastening point is arranged on the structural assembly 205. Alternatively, the at least one fastening point is arranged on the functional arrangement 236 and the at least one fastening element is arranged on the structural assembly 205.

It can be provided that the structural assembly 205 comprises a holder 239, via which the damming structure 210 and/or one of the nozzle groups can be arranged on a base body 222 of the structural assembly 205, and/or, that the structural assembly 205 comprises several holders 239, via each of which one of the damming modules 215 and/or one of the nozzle modules of a first type 228 or a second type can be arranged on the base body 222 of the structural assembly 205. In some embodiments, the holder 239 or the holders 239 each comprise a lever 240. Alternatively or additionally, the holder 239 or the holders 239 are each prestressed relative to the main body 222. Furthermore, it may alternatively or additionally be provided that the holder 239 or the holders 239 each comprise at least one latching means 241 for latching to the base body 222. In some embodiments, the respective latching means 241 can be unlatched via the respective lever 240. The holder 239 or the holders 239 may each be formed as a sheet metal part.

In FIG. 9, one of several holders 239 is shown by way of example. Via the holder 239 of the shower device 202, in some embodiments, the damming structure 210 and the first nozzle group 223, in particular a nozzle module of the first type 228, are arranged on the base body 222 of the structural assembly 205. The holder 239 comprises a manually operable lever 240, by means of which a latching means 241 of the holder 239 is unlatchable. In the assembled state, the latching means 241 latches onto the base body 222, so that a tool-free assembly of the holder 239 and the components of the shower device 202 attached to the holder 239, in particular the nozzle module of the first type 228 and the damming module 215, may be possible. In some embodiments, the holder 239 is prestressed with respect to the base body 222, so that it is held in position when assembled.

According to a further teaching, a damming module 215 is proposed for forming a damming structure 210 of a shower device 202, in particular a shower device 202 according to the proposal, which can be flowed through. The damming module 215 comprises a base element 216 and several damming elements 212, wherein the damming elements 212 are arranged on the base element 216 in several rows in at least two directions. A possible embodiment of the damming module 215 according to the proposal is shown in FIGS. 10b) and 10c).

In some embodiments, the base element 216 is plate-like shaped. In some embodiments, the damming elements 212 are columnar in shape. It may be provided that the damming elements 212 comprise at least 50, at least 100 or at least 200, damming elements 212. In particular, the two directions may be transverse to each other, in particular orthogonal. It is possible that one of the two directions corresponds to a main flow direction 214 and the other of the two directions corresponds to a direction transverse to the main flow direction 214. In some embodiments, the damming elements 212 may be evenly spaced apart from each other in at least one direction, such as in two directions, on the base element 216.

Reference may be made to all explanations concerning the shower device 202 according to the proposal.

According to a further teaching, a shower system 201 comprising a shower device 202 and a wall 242, such as a ceiling, to which the shower device 202 is attached, is proposed.

It can be that the shower device 202 is designed according to the proposal. A possible embodiment of the shower system 201 according to the proposal is shown in FIG. 6.

In some embodiments, the shower device 202, in particular the structural assembly 205, is at least partially integrated into the wall 242. It may be provided that the exit opening 207 is in a plane with the wall 242 or that the exit opening 207 spans a first plane and the wall 242 spans a second plane, wherein the distance between the first plane and the second plane is at most 10 cm, at most 1 cm, at most 0.5 cm, or at most 0.2 cm.

Reference may be made to all of the comments regarding the shower device 202 according to the proposal and the damming module 215 according to the proposal.

According to a further teaching, a method for creating at least one water jet pattern 203 with a shower device 202, in particular a shower device 202 according to the proposal, is furthermore proposed. In the method, it is provided that water is discharged via a nozzle assembly 204 of the shower device 202, the water discharged from the nozzle assembly 204 is dammed in a damming section 206 of a structural assembly 205 of the shower device 202, and the water discharged from the nozzle assembly 204 and dammed in the damming section 206 exits from an exit opening 207 of the shower device 202, wherein the water during the shower operation passes a boundary arrangement 208 of the damming section 206 at least partially towards the exit opening 207, and exiting water at least partially occupies a surge rim 209 associated with the exit opening 207 during the shower operation, in particular at any time.

In the method according to the proposal, it can be that the boundary arrangement 208 is formed as a damming structure 210 with multiple flow paths 211 and that the water flows through the damming structure 210.

Reference may be made to all embodiments relating to the shower device 202 according to the proposal, the damming module 215 according to the proposal, and the shower system 201 according to the proposal.

In some embodiments, after the shower operation, the water dammed in the damming section 206 during the shower operation drains completely from the damming section 206. In particular, the water may drain through the flow paths 211. The flow paths 211 may be formed by the damming elements 212.

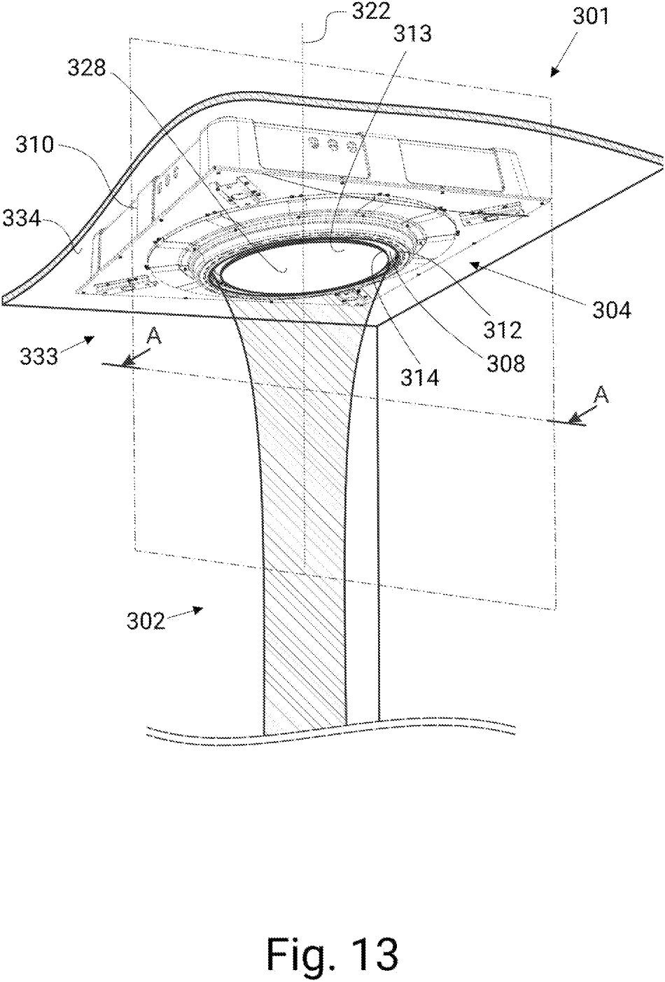

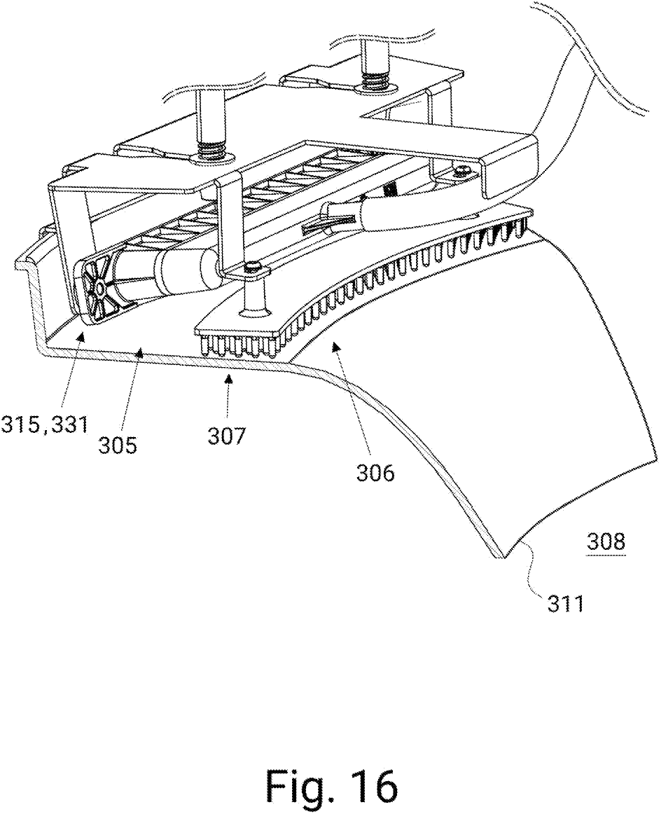

According to a further teaching described with reference to FIGS. 13 to 19, a shower device for creating at least one water jet pattern is provided, the shower device comprising a nozzle assembly for discharging water, a structural assembly comprising a damming section for damming the water discharged by the nozzle assembly, an exit opening for discharging the water discharged by the nozzle assembly and dammed in the damming section from the shower device, and a lighting assembly for illuminating the water emerging from the exit opening, the structural assembly comprising a base body in which the nozzle assembly, the damming section and the lighting assembly are at least partially accommodated and from which water can emerge via the exit opening, the exit opening being assigned a surge rim, which is at least partially occupied by emerging water during shower operation, and the exit opening being confined by a circumferential first opening edge. It can be that the shower device comprises a functional arrangement, which comprises at least part of the lighting assembly and/or at least part of the nozzle assembly, and that the functional arrangement is designed as an assembly unit which, in the course of assembly, can be connected to the structural assembly, in particular detachably, in such a way that, in the assembled state, the functional arrangement is at least partially accommodated by the base body, it being possible for the functional arrangement, in the course of assembly, to be moved at least partially through an assembly opening of the structural assembly, which is surrounded by the first opening edge. Reference may be made to all explanations regarding the shower device according to the proposal of the first teaching and regarding the shower device according to the proposal of the second teaching.

In detail, with reference to FIGS. 13 through 19, the following:

The embodiment illustrated in FIGS. 13 to 19, which can be in this respect, relates to a shower device 301 for creating at least one water jet pattern 302. The water jet pattern 302 can comprise a partially circulating or fully circulating water surge. In FIG. 13, a fully circulating water surge is illustrated as an example.

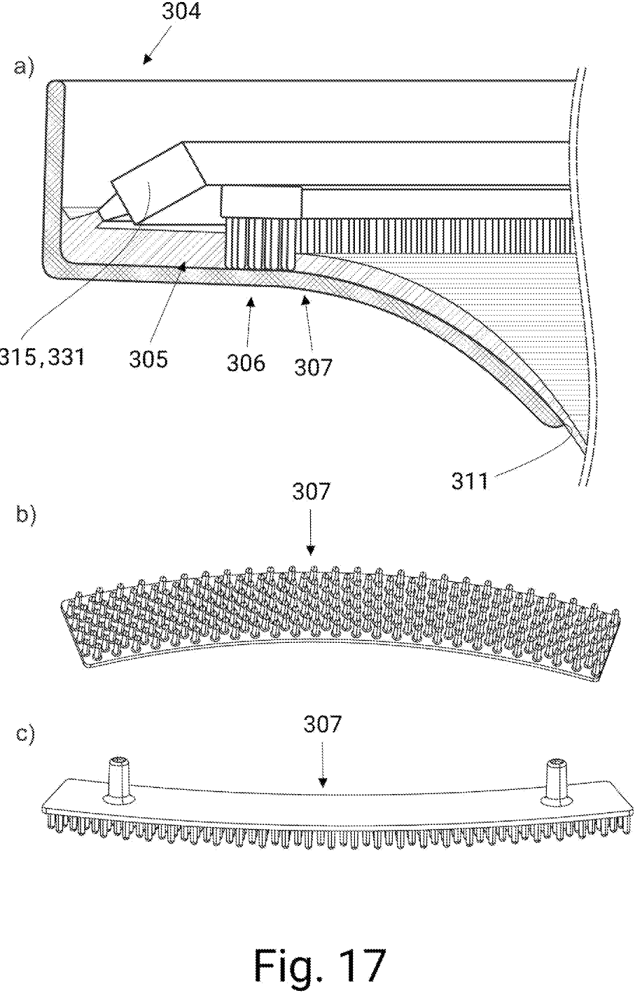

The shower device 301 comprises a nozzle assembly 303 for discharging water and a structural assembly 304 comprising a damming section 305 for damming the water discharged from the nozzle assembly 303. Accordingly, the water is discharged from the nozzle assembly 303 in the shower mode and is initially dammed in the damming section 305, for example, to be able to create a particularly uniform water surge of the water jet pattern 302. The damming can be effected by a boundary arrangement 306, for example with a damming structure 307, which can be passed by the dammed water (FIGS. 17a), b) and c)).

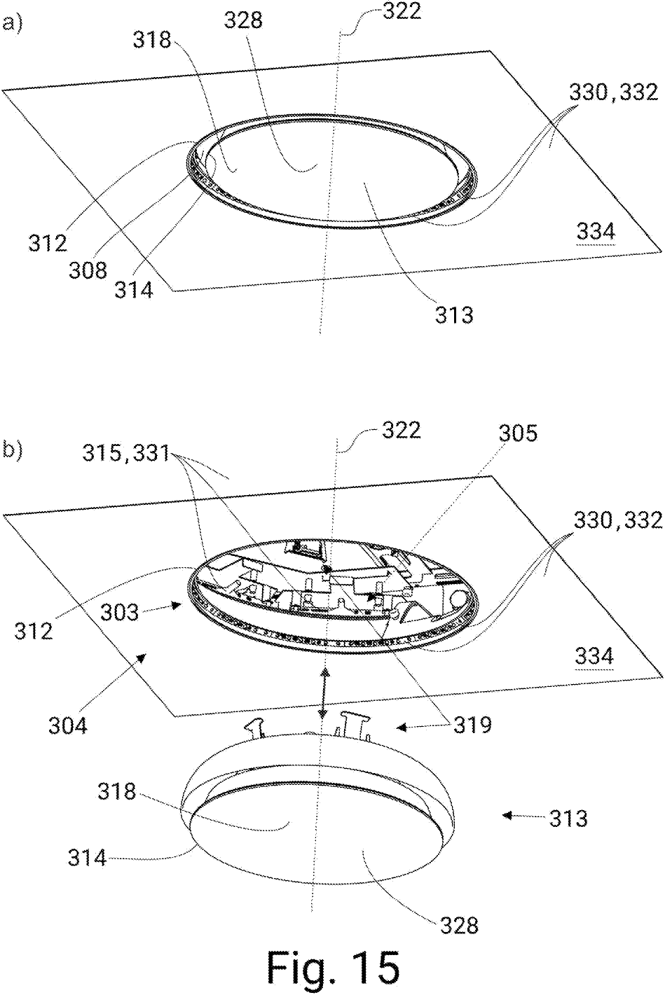

After damming, the water can exit the shower device 301. For this purpose, the shower device 301 comprises an exit opening 308 through which the water discharged by the nozzle assembly 303 and dammed in the damming section 305 can be discharged from the shower device 301. The exit opening 308 may in particular be curved, annular, circular or elliptical. In FIG. 15, the curved, namely annular and circular, exit opening 308 is illustrated as an example.

The shower device 301 further includes an lighting assembly 309 for illuminating the water exiting the exit opening 308, such as to produce an illuminated water jet pattern 302.

The structural assembly 304 comprises a base body 310 in which the nozzle assembly 303, the damming section 305 and the lighting assembly 309 are at least partially accommodated in the assembled state and from which water can be discharged via the exit opening 308. In the assembled state, the base body 310 thus at least partially surrounds the nozzle assembly 303, the damming section 305 and the lighting assembly 309. As here, the base body 310 can form an at least partially or predominantly closed housing, in particular at least laterally and vertically upwards.

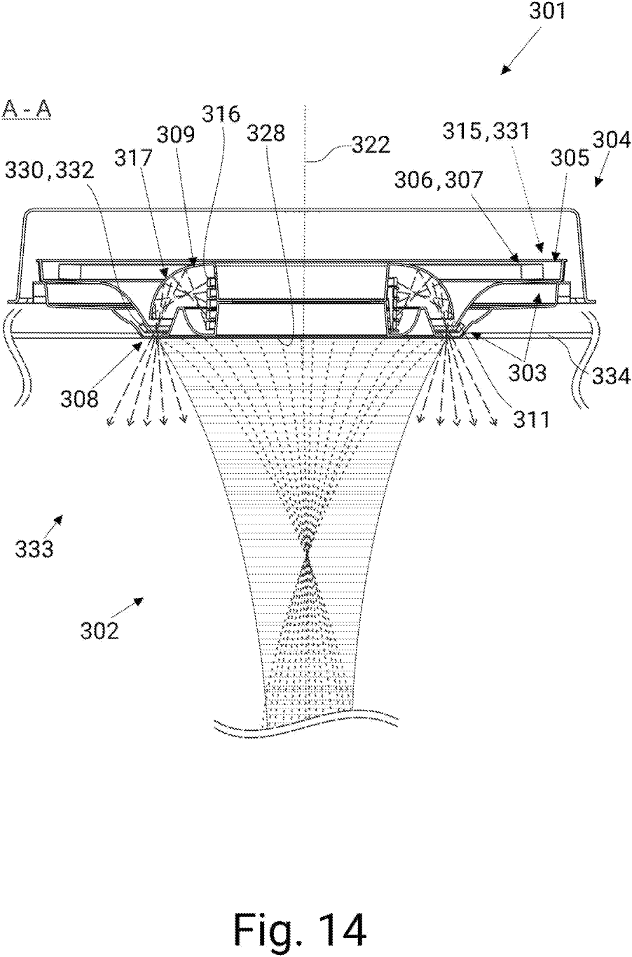

The exit opening 308 is associated with a surge rim 311, which is at least partially occupied by escaping water during shower operation. The surge rim 311 may in particular be part of the structural assembly 304 and, in some embodiments, be arranged within the base body 310. Water may flow over the surge rim 311 as a surge of water towards the exit opening 308 and exit from the exit opening 308. This is shown by way of example in FIG. 14.

The exit opening 308 is further confined by a circumferential first opening edge 312. The first opening edge 312 may in particular be curved, in particular circular or elliptical. The first opening edge 312 may in particular surround the exit opening 308. In FIG. 13, the first opening edge 312 is curved and circular by way of example.

Now, it can be that the shower device 301 comprises a functional arrangement 313 comprising at least part of the lighting assembly 309 and/or at least part of the nozzle assembly 303. For example, FIG. 14 shows a functional arrangement 313 comprising the lighting assembly 309. The nozzle assembly 303 is, in some embodiments, arranged within the base body 310 and is in particular not included in the functional arrangement 313. However, it is also possible that the nozzle assembly 303 is encompassed by the functional arrangement 313.

The functional arrangement 313 is designed as an assembly unit which, in the course of assembly, can be connected to the structural assembly 304, in particular detachably, in such a way that, in the assembled state, the functional arrangement 313 is at least partially accommodated by the base body 310. The functional arrangement 313 can in particular be mechanically connectable, for example attachable, to the structural assembly 304, so that the functional arrangement 313 can be arranged on the structural assembly 304, in particular on the base body 310. The functional arrangement 313 may be separable from the structural assembly 304, in particular non-destructively, for example for the purpose of maintenance of the structural assembly 304 and the functional arrangement 313. The functional arrangement 313 configured as an assembly unit, may in particular be pre-assembled. The functional unit formed as an assembly unit can be used as a single part, such as in the course of assembly.

During assembly, the functional arrangement 313 is at least partially movable through an assembly opening of the structural assembly 304 surrounded by the first opening edge 312. The mounting opening may be formed as part of the base body 310. The movement may be in an assembly movement, such as in a vertical direction. In particular, the mounting opening may be curved, circular and/or elliptical. The first opening edge 312 may define the mounting opening on one side. The exit opening 308 may be part of the mounting opening.

It is further shown and provided, for example in FIGS. 13 and 15a), that the exit opening 308 is confined by a second opening edge 314 in such a way that the exit opening 308 is annular between the first opening edge 312 and the second opening edge 314. It is conceivable that the annular exit opening 308 is in particular circular, as exemplarily illustrated in FIG. 15a), or elliptical. It is conceivable that the first opening edge 312 is also curved and/or the second opening edge 314 is also curved. In some embodiments, the annular exit opening 308 is slit-shaped, wherein in particular a ratio of the first opening edge 312 to the second opening edge 314 of at most 1.4 to 1, of at most 1.2 to 1, of of at most 1.1 to 1, has proven to be effective.

In some embodiments, the first opening edge 312 is formed as part of the structural assembly 304, in particular the base body 310, and the second opening edge 314 is formed as part of the functional arrangement 313. Thereby, the exit opening 308 can be formed by the assembly by connecting the functional arrangement 313 to the structural assembly 304. It is conceivable that, in the assembled state, the second opening edge 314 is arranged concentrically with respect to the first opening edge 312. It is also conceivable that the functional arrangement 313 is accommodated in the base body 310 in such a way that the first opening edge 312 and the second opening edge 314 are arranged in one, in particular horizontal, plane, as shown for example in FIG. 15a).

During the shower operation, the exit opening 308, in some embodiments, in particular at any time, is only partially flowed through by water, which reaches the exit opening 308 from the surge rim 311. The exit opening 308 is thus, in particular at all times, only partially occupied by water, as can be seen, for example, in FIG. 13. In some embodiments, the first opening edge 312 and/or the second opening edge 314 are free of water during shower operation, in particular at all times. Shown in FIGS. 13 and 14, the water can flow off over the surge rim 311 as a surge of water and flow through the exit opening 308 without contact, so that the first opening edge 312 as well as the second opening edge 314 are free of water, in particular water from a first nozzle group 315, during the shower operation. The first nozzle group 315 will be described in more detail below. Alternatively, however, it is also conceivable that the first opening edge 312 itself is designed as a surge rim 311. This is then correspondingly not free of water. In this case, the water flows through the exit opening 308 at the first opening edge 312.

In various embodiments, the lighting assembly 309 includes at least one light source 316 and a light deflector 317 associated with the light source 316, wherein the light from the light source 316 is deflectable via the light deflector 317 such that the water exiting the exit opening 308 is indirectly illuminated (FIG. 14). The light from the light source 316 may exit through the exit opening 308. In particular, the light source 316 may be an LED. In particular, the light source 316 may be arranged to emit light at an angle to the vertical direction. It has been found that the lighting assembly 309 can include a plurality of light sources 316, which are arranged in the vertical direction and/or around a vertical axis in several rows, as exemplified in FIG. 14. In this way, for example, a particularly high light intensity and uniform illumination can be achieved. In some embodiments and shown in FIG. 14, the light deflector 317 comprises a deflecting screen, in particular surrounding the at least one light source 316. The deflecting screen has an arcuate shape. The deflecting screen can be formed in one piece or in multiple pieces.

In some embodiments, the at least one light source 316 and the light deflector 317 are formed as part of the functional arrangement 313. It is equally possible that the at least one light source 316 is arranged as part of the functional arrangement 313 and the light deflection 317 is arranged within the structural assembly 304, in particular within the base body 310. In particular, the light source 316 and the light deflector 317 may be pre-assembled. It is further conceivable that the functional arrangement 313 comprises a light cover 318, which covers the at least one light source 316 in the assembled state in such a way that it is not visible to a user during shower operation and/or that it is not visible from the outside. The light cover 318 may be in the form of a cap. In particular, it is possible for the light cover 318 to be pre-assembled so that it can be mounted during assembly without any further assembly steps.

It can be provided that the shower device 301 comprises a fastening arrangement 319, wherein the functional arrangement 313 can be fastened, i.e. mechanically connected, to the structural assembly 304 via the fastening arrangement 319 in a manual assembly movement. In FIG. 15b), a manual assembly movement is indicated. During the manual assembly movement, the functional arrangement 313 may be moved relatively to the structural assembly 304. The manual assembly movement may comprise a rotational movement and/or a linear movement. In some embodiments, the manual assembly movement comprises a purely linear movement of the functional arrangement 313 in a vertical direction, which is aligned with respect to the structural assembly 304.

A further embodiment provides that the fastening arrangement 319 is designed as a latchable fastening arrangement 319, in which at least one fastening element 320 and at least one fastening point 321 assigned to the fastening element 320 can be latched to one another, in particular in a self-locking manner. This enables a, in particular self-locking, latching connection. The at least one fastening element 320 is arranged on the functional arrangement 313 and the at least one fastening point 321 is arranged on the structural assembly 304. Alternatively, the at least one fastening point 321 is arranged on the functional arrangement 313 and the at least one fastening element 320 is arranged on the structural assembly 304.

It is conceivable that the fastening arrangement 319 comprises several fastening elements 320 and a plurality of fastening points 321 each associated with one of the fastening elements 320, as is the case, for example, with the embodiment in FIG. 15b). It can be provided that the fastening elements 320 and the fastening points 321 on the structural assembly 304 and the functional arrangement 313 are arranged at a uniform angular distance from one another about a, in particular vertical, geometric main axis 322 of the functional arrangement 313 fastened to the structural assembly 304. This makes it easier to align the functional arrangement 313 about the vertical axis, for example. In FIG. 15b), it is shown that the four fastening elements 320 are arranged at a uniform angular distance of 90° from each other. The four fastening points 321 are correspondingly arranged at a uniform angular distance of 90° from one another.

The main geometric axis 322 is here the central axis around which the edge of the exit opening 308 extends. It extends in particular in the vertical direction. The vertical direction here is the direction of gravity. Accordingly, the horizontal direction is the direction orthogonal thereto.

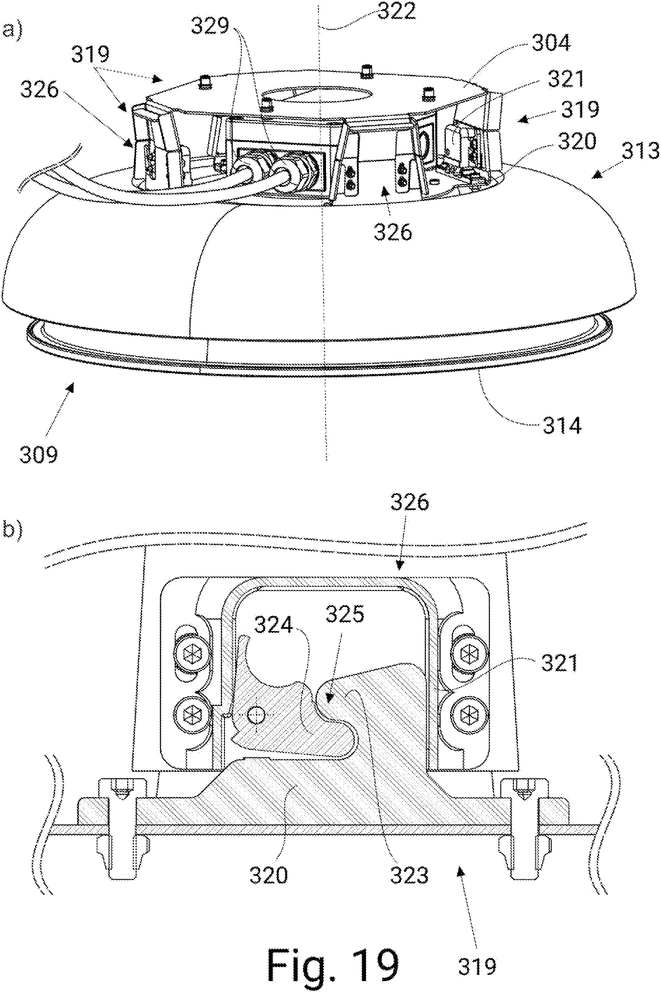

It is further provided, in some embodiments, that the at least one fastening element 320 comprises a latching element of a first type 323 and the at least one fastening point 321 comprises a latching element of a second type 324, which engage behind one another in the assembled state, resulting in a self-locking latching connection 325. This is shown in FIG. 19b). The self-locking latching connection 325 allows the latching element of the first type 323 and the latching element of the second type 324 to lock each other. When a certain force is overcome, for example during disassembly, the self-locking latching connection 325 can be released. In FIG. 19b), a vertically downwardly directed force, in particular a tensile force, would have to be applied to the functional arrangement 313 for this purpose. In some embodiments, the latching connection is released by the application of force alone. Thus, only a single disassembly movement in only a single direction is required to release the latching connection. The latching element of the first type 323 can be designed, in particular, as a latching hook. The latching element of the second type 324 can be designed in particular as a latching hook or as a latching recess into which the latching element of the first type 323 latches.

In some embodiments, the latching element of the first type 323 or the latching element of the second type 324 is mounted movably, in particular rotatably, and can be transferred from an unlatching position to a latching position in the course of assembly, in particular during the assembly movement, so that the latching element of the first type 323 and the latching element of the second type 324 engage behind each other. In FIG. 19b), a latching element of the second type 324, designed as a latching hook, is rotatably mounted. In some embodiments, the latching element of the first type 323 is rigid.

In some embodiments, the at least one fastening point 321 comprises a fastening receptacle 326, in which the latching element of the second type 324 is arranged and into which the latching element of the first type 323 can be moved in the course of the assembly, in particular during the assembly movement, in particular guided by the fastening receptacle 326. In FIG. 19b), the latching element of the first type 323 is shown and can be guided on one side by the fastening receptacle 326. The fastening receptacle 326 is, in some embodiments, arranged in such a way that the latching element of the first type 323 can be moved into the fastening receptacle 326 in vertical direction.

Further provided herein, the fastening arrangement 319 is configured such that the functional arrangement 313 is detachable, i.e., mechanically separable, from the structural assembly 304 in a manual disassembly movement. During the manual disassembly movement, the functional arrangement 313 may be moved relatively to the structural assembly 304. The manual disassembly movement may comprise a rotational movement and/or a linear movement. Here, in some embodiments, the manual disassembly movement comprises a purely linear movement of the functional arrangement 313 relative to the structural assembly 304 in a vertical direction. In particular, it is possible that the disassembly movement is a counter movement, i.e. an opposite movement, to the assembly movement. In some embodiments, it is provided that during the manual disassembly movement, the functional arrangement 313, in particular as an assembly unit, is movable along the geometric main axis 322 of the functional arrangement 313 by a manual pulling force, whereby the at least one fastening element 320 and the at least one fastening point 321 are disengaged from each other. In particular, the self-locking latching connection 325 can be separated by the manual disassembly movement.

It can be provided that the structural assembly 304, in particular the base body 310, comprises an inspection opening 327 for servicing the nozzle assembly 303 accommodated in the base body 310 and/or the damming section 305 accommodated in the base body 310 and/or the lighting assembly 309 accommodated in the base body 310. In some embodiments, the functional arrangement 313 is at least partially arranged within the inspection opening 327, when assembled. The arrangement may result from connecting the functional arrangement 313 to the structural assembly 304. In some embodiments, the functional arrangement 313 includes a cover surface 328 that at least partially covers the inspection opening 327 in the assembled state and exposes the inspection opening 327 in the disassembled state of the functional arrangement 313. To this extent, covering the inspection opening 327 can be performed in the course of assembly without an additional assembly step, for example of a cover. In some embodiments, the assembly opening may be part of the inspection opening 327. In some embodiments, the assembly opening may be coverable by the cover surface 328.

In the embodiment shown in FIGS. 15a) and 15b) , the base body 310 can include the inspection opening 327. The base body 310, in some embodiments, accommodates the nozzle assembly 303 and the damming section 305, which are maintainable via the inspection opening 327. The lighting assembly 309 is, in some embodiments, included by the functional arrangement 313. In the assembled state of the functional arrangement 313 in the inspection opening 327 (FIG. 15b)), the nozzle assembly 303 accommodated in the base body 310 and the damming section 305 accommodated in the base body 310 are not accessible and thus not maintainable. The inspection opening 327 is covered by the cover surface 328 of the functional arrangement 313. It is conceivable that the cover surface 328 is flush with an outer surface of the base body 310. On the other hand, if the functional arrangement 313 is disassembled, for example in a disassembly movement, the inspection opening 327 is uncovered and the nozzle assembly 303 and the damming section 305 are maintainable via the inspection opening 327. Generally, other components of the shower device 301 accommodated in the base body 310 may also be serviceable via the inspection opening 327.

It is further provided, in some embodiments, that the shower device 301 comprises a functional connection 329, wherein a functional connection between the structural assembly 304 and the functional arrangement 313 can be established via the functional connection 329 in the course of assembly, in particular without tools. The functional connection 329 can be formed as an electrical connection, in particular in case where the functional arrangement 313 comprises at least part of the lighting assembly 309, and/or as a water supply, in particular in case where the functional arrangement 313 comprises at least part of the nozzle assembly 303. In the exemplary functional arrangement 313 shown in FIG. 19a), the functional arrangement 313 can include the lighting assembly 309 and a functional connection 329 configured as an electrical connection. Via the functional connection 329, the functionality of the functional arrangement 313 can be achieved, in some embodiments, the illumination of the exiting water via the lighting assembly 309.

It is possible that the functional connection is automatically established in the course of the assembly by an additional assembly step or, in particular, during the assembly movement, when the functional arrangement 313 is attached to the structural assembly 304 by the fastening arrangement 319. It may be provided, for example, that before the functional arrangement 313 is connected to the structural assembly 304 in an additional assembly step, a cable of the functional connection 329 arranged on the structural assembly 304 is connected to a cable connection of the functional connection 329 arranged on the functional arrangement 313 (FIG. 19a)). Alternatively, however, it may be provided that a part of the functional connection 329 is arranged at the structural assembly 304 and a corresponding part of the functional connection 329 is arranged at the functional arrangement 313, as part of the assembly unit. In the course of the assembly, during the assembly movement, the parts of the functional connection 329 are automatically connectable and a functional connection can be established. The functional connection 329 can be designed, for example, according to the plug-socket principle.

According to a further embodiment, the structural assembly 304 or the functional arrangement 313 comprises a control unit for controlling the lighting assembly 309. Via the control unit, the light of the lighting assembly 309, in particular of the light source 316, can be switched. In some embodiments, it is provided that the control unit comprises a radio module, in particular a WLAN or a Bluetooth module, for controlling the lighting assembly 309 via radio signals. This makes it particularly easy to install the shower device 301 if, for example, a power connection is provided but no switch is provided for it.

It is further provided, in some embodiments, that the nozzle assembly 303 comprises a first nozzle group 315, via which a first water jet pattern 302, in particular with a circulating or partially circulating water jet, can be created, and that the nozzle assembly 303 comprises a second nozzle group 330, via which a second water jet pattern 302, in particular several individual water jets, can be created. The first water jet pattern 302 can be different from the second water jet pattern 302. The first nozzle group 315 and the second nozzle group 330 can, in particular, be controlled independently, so that water can be discharged through the nozzle groups simultaneously or with a time delay.

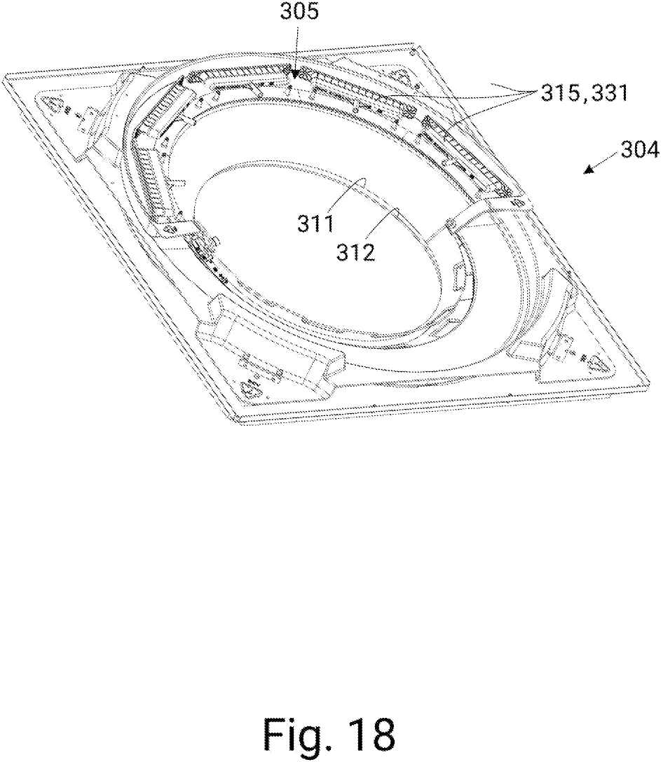

In some embodiments, the first nozzle group 315 comprises one or more first type nozzles 331, through which water is dispensable into the damming section 305. Alternatively or additionally, the second nozzle group 330 comprises one or more second type nozzles 332, through which water is dispensable through the exit opening 308. The nozzle of the first type 331 or the nozzles of the first type 331 may be, for example, surge nozzles and/or jet nozzles. The nozzle of the second kind 332 or the nozzles of the second kind 332 may be formed as surge nozzles and/or jet nozzles. In some embodiments, the nozzle of the first type 331 or the nozzles of the first type 331 and the nozzle of the second type 332 or the nozzles of the second type 332 are arranged on the structural assembly 304, in particular on the base body 310, as exemplarily shown in FIGS. 14 and 18.

Also proposed is a shower system 333 having a shower device 301 and a wall 334, such as a ceiling, to which the shower device 301 is attached.

It is provided in the shower system 333 according to the proposal, that the shower device 301 is designed according to the proposal. In FIG. 13, the shower system 333 is illustrated as an example, wherein the shower device 301, in some embodiments, is arranged at least partially in a ceiling.

Reference may be made to all explanations concerning the shower device 301 according to the proposal.

Further illustrated and provided in FIG. 13 is that the shower device 301, in particular the structural assembly 304, such as the base body 310, is integrated in the wall 334 in such a way that the exit opening 308 is arranged in a plane with the wall 334. Alternatively, however, it is equally conceivable that the exit opening 308 spans an exit plane which is spaced from the wall 334 by at most 10 cm, at most 1 cm, or at most 0.5 cm. Alternatively or additionally, it is conceivable that the shower device 301, in particular the structural assembly 304, such as the base body 310, is integrated into the wall 334 in such a way that a cover surface 328 of the functional arrangement 313 is arranged in a plane with the wall 334, or, that the cover surface 328 spans a cover plane which is spaced from the wall 334 by at most 10 cm, at most 1 cm, or at most 0.5 cm. By this, a shower device 301 with an exit opening 308 little below or little above the wall 334, in particular the ceiling, can be created.

Also proposed is a method for assembling a shower device 301 according to the proposal.

In the method according to the proposal, it is provided that the functional arrangement 313 of the shower device 301 is, in particular detachably, connected to the structural assembly 304 in the course of assembly in such a way that the functional arrangement 313 is at least partially accommodated by the base body 310 in the assembled state, the functional arrangement 313 being moved at least partially through the assembly opening of the structural assembly 304 surrounded by the first opening edge 312 in the course of assembly. In the course of the assembly, in particular an assembly movement, such as a manual assembly movement, may take place.

It may be provided that the functional arrangement 313 of the shower device 301 is separated from the structural assembly 304 in the course of the disassembly, wherein the functional arrangement 313 is at least partially moved through the assembly opening of the structural assembly 304 surrounded by the first opening edge 312 in the course of the disassembly. In particular, a disassembly movement, such as a manual disassembly movement, may be performed in the course of the disassembly. In some embodiments, the disassembly, in particular the disassembly movement, takes place in the direction opposite to the assembly, in particular the assembly movement.

Reference may be made to all embodiments relating to the proposed shower device 301 and the proposed shower system 333.

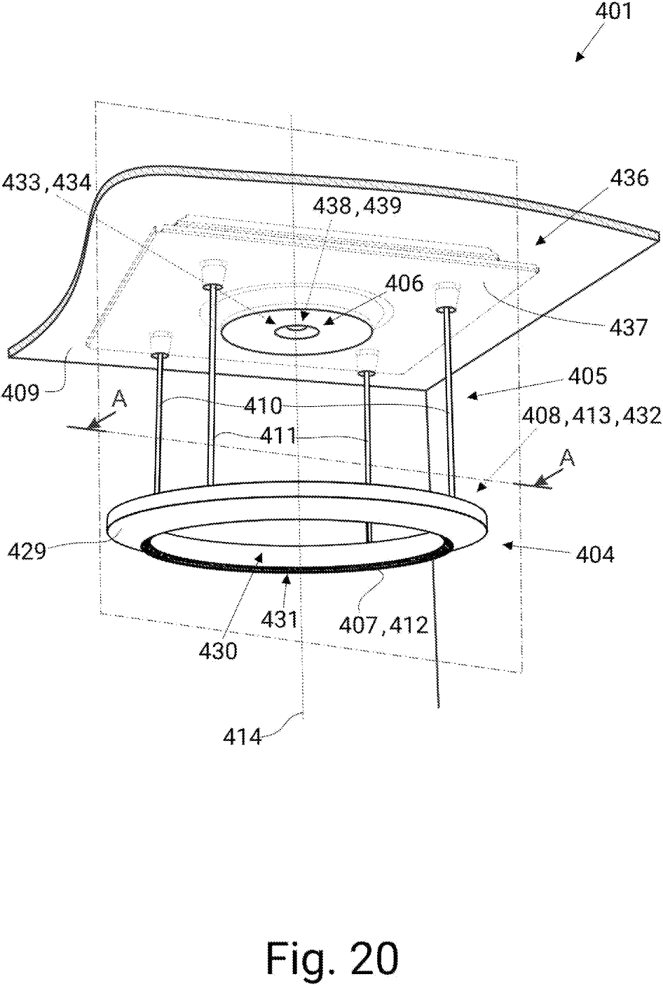

According to a further teaching described on the basis of FIGS. 20 to 22, a shower device for creating at least two water jet patterns is provided, the shower device comprising a nozzle assembly for delivering water with a first nozzle group for creating a first water jet pattern and a second nozzle group for creating a second water jet pattern, a first shower head, which comprises the first nozzle group and the second nozzle group, and several water supply lines, via which water can be supplied to the first shower head. It can be that the water supply lines are designed as supply and spacing units for supplying water to the first shower head and for spacing and fastening the first shower head with respect to a wall, in particular a ceiling. Reference may be made to all explanations concerning the shower device according to the proposal of the first teaching, concerning the shower device according to the proposal of the second teaching and concerning the shower device according to the proposal of the third teaching.

In detail, with reference to FIGS. 20 to 22, the following:

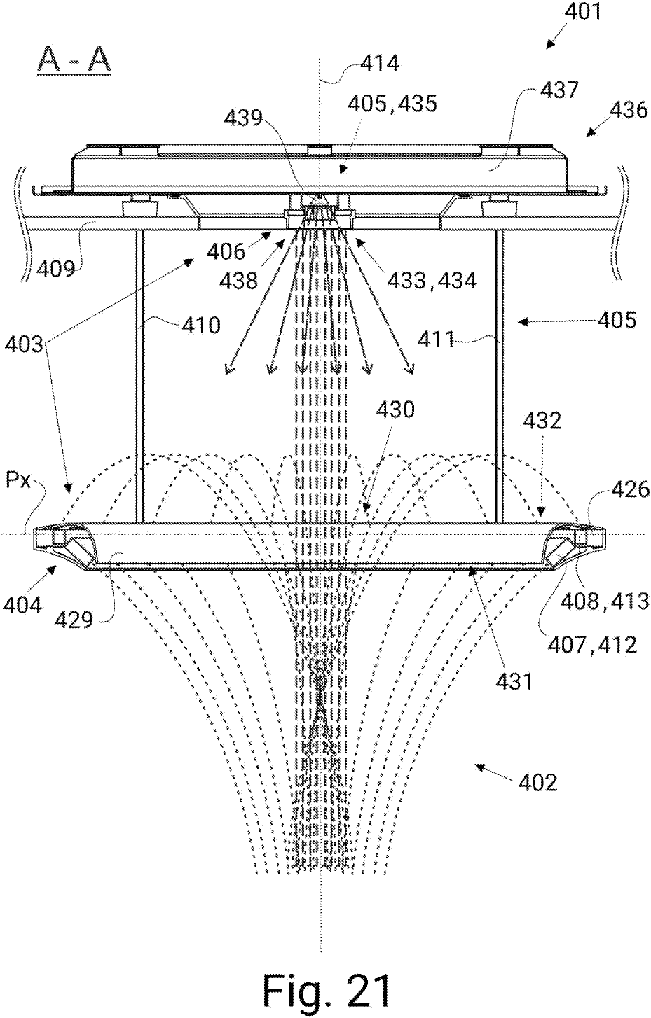

The embodiment illustrated in FIGS. 20 to 22 relates to a shower device 401 for creating at least two water jet patterns 402. The water jet patterns 402 may comprise, for example, water jets and/or a water surge, as exemplified in FIG. 21. The water jet patterns 402 may be created simultaneously or sequentially in the shower operation.

The shower device 401 comprises a nozzle assembly 403, a first shower head 404 accommodating at least part of the nozzle assembly 403, and several water supply lines 405. “First” shower head 404 does not mean that a further, “second” shower head 406 must also necessarily be provided, but it can also be the only shower head. As will be explained further, however, a second shower head 406 is also provided in the present embodiment.

It is now the case that the nozzle assembly 403 comprises a first nozzle group 407 and a second nozzle group 408 and enables water to be discharged via them. By means of the first nozzle group 407, a first water jet pattern 402 can be created and by means of the second nozzle group 408, a second water jet pattern 402 can be created. FIG. 21 shows by way of example that the first nozzle group 407 creates a, in some embodiments cone-shaped, first water jet pattern 402 and the second nozzle group 408 creates a, in some embodiments sink-shaped, second water jet pattern 402.

The first nozzle group 407 and the second nozzle group 408 are received by the first shower head 404. It is conceivable that the nozzle assembly 403 comprises further nozzle groups which are not accommodated by the first shower head 404. The first shower head 404 may, in some embodiments, be annular and circular in shape. Likewise, other shapes are conceivable, such as annular and elliptical.

Water can be supplied to the first shower head 404 via the water supply lines 405. The water supply lines 405 are, in some embodiments, each tubular. The water supply lines 405 are, in some embodiments, each formed straight at least in sections. Further, the water supply lines 405, in some embodiments, each comprise a constant outer diameter at least in sections, in particular in a visible region.

Now, it can be that the water supply lines 405 are formed as supply and spacing units for supplying water to the first shower head 404 and for spacing and fixing the first shower head 404 with respect to a wall 409. As used herein, a wall 409 generally refers to any boundary of the shower area. In particular, the term “wall” as used herein includes the ceiling of a shower area. A ceiling may be, for example, the ceiling of a bathroom or, for example, a suspended ceiling. When the term “wall” 409 is used in the following, the ceiling is meant in the present embodiment. The present disclosure can also be applied to a side wall.

In this way, the nozzle assembly 403 can be positioned in the shower area in the course of assembly in such a way that water can emerge spaced apart from the wall 409 or ceiling at different points and/or in different directions, for example also describing an arc due to the force of gravity, which makes it possible to create aesthetically particularly appealing water jet patterns 402. In addition, the supply and spacing units allow the creation of a floating design element, which makes the overall aesthetic effect of the shower device 401 particularly appealing.

In some embodiments, the first shower head 404 is rigidly arranged, relative to the second shower head 406 and/or to the wall 409 when mounted. “Rigid” in this context means immovable, that is, during an intended shower operation the first shower head 404 is not movable relative to the wall 409 and/or the second shower head 406, unlike for example a hand shower. However, the term “rigid” refers only to the state of the shower device 401 when mounted as intended, which thus does not preclude adjustability in the course of mounting, in particular for changing the shower spacing.

In some embodiments, it is provided that the water supply lines 405 are designed as spatially separated, i.e. individual, water supply lines 405, which are attached to the first shower head 404 at a distance from each other, as exemplarily shown in FIGS. 20 and 21. The water supply lines 405 may, in some embodiments, each be tubular in shape. It can be that the water supply lines 405 each comprise a straight section, which is arranged between the first shower head 404 and the wall 409.

In some embodiments, the water supply lines 405 of the first water supply line group 410 and the water supply lines 405 of the second water supply line group 411 are arranged substantially parallel to each other. In some embodiments, the water supply lines 405 of the first water supply line group 410 and the water supply lines 405 of the second water supply line group 411 comprise the same length and/or diameter. It is possible that the water supply lines 405 are oriented vertically, i.e., in the direction of gravity, as exemplified in FIGS. 20 and 21. Alternatively or additionally, the water supply lines 405 of the first water supply line group 410 and the water supply lines 405 of the second water supply line group 411 are arranged on a common first circular path, as exemplarily shown in FIG. 20, or a common elliptical path.

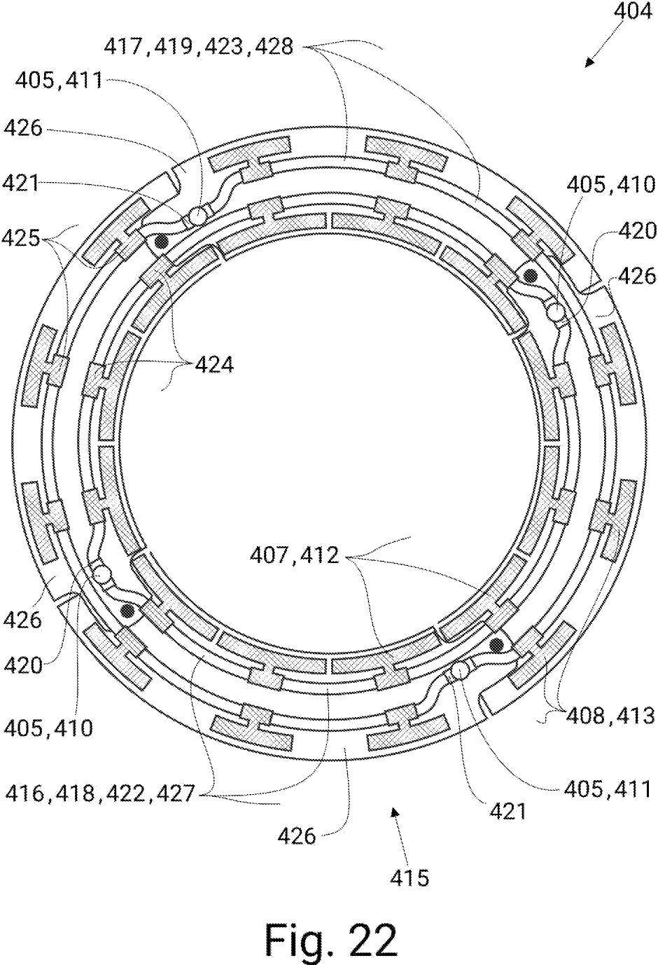

In the present embodiment, as a synopsis of FIG. 21 and FIG. 22 shows, the water supply lines 405 are divided into water supply line groups, in this case into two water supply line groups, each water supply line group supplying water to a different nozzle group. Water can be supplied to the first nozzle group 407 via a first water supply line group 410 comprising at least two water supply lines 405, and water can be supplied to the second nozzle group 408 via a second water supply line group 411 comprising at least two water supply lines 405. In this case, the first water supply line group 410 and the second water supply line group 411 are designed to be fluidically separate from one another, in this case in such a way that the water supply lines 405 of the first water supply line group 410 and the water supply lines 405 of the second water supply line group 411 are arranged essentially parallel to one another and/or on a common first circular path or elliptical path.

When water is supplied to the first and second nozzle groups 408 via two water supply lines 405 in each case, a larger volumetric flow rate of water can be supplied to the corresponding nozzle group than would be the case, for example, with a single water supply line 405. In particular for cases in which the first nozzle group 407 and/or the second nozzle group 408 comprise, for example, a large number of first nozzles 412 or second nozzles 413, it is possible to ensure a uniform supply of water via the several water supply lines 405 of each water supply line group without having to accept unnecessarily high pressure losses, for example.

Water can be fed separately to the respective nozzle group by means of water feed groups which are designed to be fluidically separate from one another. For example, water can be fed through the water lines of the first water supply line group 410 and supplied to the first nozzle group 407, in particular the first nozzles 412, while no water flows through the water lines of the second water supply line group 411 and thus no water is supplied to the second nozzle group 408, in particular the second nozzles 413. The first nozzle group 407 and the second nozzle group 408 can thus be controlled individually. It is thus possible for the first water jet pattern 402 or the second water jet pattern 402 to be created individually or for the first water jet pattern 402 and the second water jet pattern 402 to be created together.

It is further provided, in some embodiments, that the first nozzle group 407 comprises several first nozzles 412 for delivering water for the first water jet pattern 402 and the second nozzle group 408 comprises several second nozzles 413 for delivering water for the second water jet pattern 402. It is possible that the first nozzle group 407, in particular the first nozzles 412, and the second nozzle group 408, in particular the second nozzles 413, can be controlled separately from one another via the water supply lines 405 of the first water supply line group 410 and the second water supply line group 411. This allows the water jet patterns 402 to be created independently of one another. The first nozzles 412 and/or the second nozzles 413 can be designed as surge nozzles and/or as jet nozzles, to name just a few examples. In the embodiment according to FIG. 21, the first nozzles 412 and the second nozzles 413 are designed as jet nozzles.

Furthermore, it can be the case that water can be discharged in a first direction via the first nozzles 412 and water can be discharged in a second direction via the second nozzles 413, and that the first direction is different from the second direction.

“Different” in the present context means that the two directions deviate from each other, in particular that the first direction deviates from the second direction by at least 30°, by at least 60°, or by at least 90°.

Further, it is conceivable that the first direction is oriented downward with respect to a horizontal plane Px and the second direction is oriented upward with respect to the horizontal plane Px, as exemplified by FIG. 21. It is possible that the water of the second water jet pattern 402 undergoes a change in direction due to gravity. In FIG. 21 further exemplarily shown, the first water jet pattern 402 is cone-shaped and the second water jet pattern 402 is sink-shaped.

As exemplified and shown in FIG. 22, at least some of the first nozzles 412, or in particular all of the first nozzles 412, are arranged point-symmetrically with respect to a geometric main axis 414, vertical here, of the first shower head 404. Alternatively or additionally, at least some of the second nozzles 413, or in particular all of the second nozzles 413, can be arranged point-symmetrically with respect to a geometric main axis 414, which is vertical here, of the first shower head 404, with some of the second nozzles 413 being arranged at different distances from one another in the circumferential direction with respect to the geometric main axis 414, which is vertical here, of the first shower head 404, as is also exemplified by FIG. 22.

The geometric main axis 414 is here the center axis around which the first nozzle group 407 and/or the second nozzle group 408 extends. This extends in particular in the vertical direction. The vertical direction is here the direction of gravity. Correspondingly, the horizontal direction is the direction orthogonal thereto.

In some embodiments, it is further the case that the first shower head 404 comprises a distribution system 415, in particular an internal distribution system 415, for distributing water from the water supply lines 405 towards the first nozzle group 407 and second nozzle group 408, which comprises a first distribution line 416 for distributing water to the first nozzles 412 and a second distribution line 417 for distributing water to the second nozzles 413. It can be that the first distribution line 416 and the second distribution line 417 are fluidically separated from each other. This allows the fluidic separation of the water supply line groups to be maintained. In FIG. 22, the distribution system 415 is shown as an example.

Shown by way of example in FIG. 22, it is possible for the first distribution line 416 to comprise a first ring line 418, on which the first nozzles 412 are arranged, in particular at least partially equally spaced, and for the second distribution line 417 to comprise a second ring line 419, on which the second nozzles 413 are arranged, in particular at least partially equally spaced. The water may be circulated in the first annular conduit 418 and/or the second annular conduit 419, respectively, for supplying the first nozzles 412 and/or second nozzles 413 with water. It is conceivable that the first manifold 416 and/or the second manifold 417 may, in particular, also comprise one or more conduit elements extending transversely from the first annular conduit 418 and/or the second annular conduit 419. In particular, water may be feedable into the first and/or second ring line 419 via one or more first supply ports 420 and/or one or more second supply ports 421. In some embodiments, the first annular conduit 418 and the second annular conduit 419 are each circular in shape. Alternatively, the first ring line 418 and/or the second ring line 419 may be formed in other shapes, such as elliptical.

It is also possible that the first distribution line 416, in particular the first ring line 418, is formed from several first line elements 422, in particular detachably, fluidically connected to one another, and/or, that the second distribution line 417 is formed from several second line elements 423, in particular detachably, fluidically connected to one another. In the embodiment of FIG. 22, the first ring line 418 comprises several first line elements 422 detachably connected to each other and the second ring line 419 comprises several second line elements 423 detachably connected to each other.

It is further provided here, that the first nozzle group 407 comprises several first nozzle connections 424, via which the first nozzles 412 are fluidically connected in groups to the first manifold 416, and/or, that the second nozzle group 408 comprises several second nozzle connections 425, via which the second nozzles 413 are connected in groups to the second manifold 417. It is possible, as exemplified in FIG. 22, for the first nozzle connections 424 to be arranged uniformly spaced apart from one another on the first ring line 418, and/or, for the second nozzle connections 425 to be arranged uniformly spaced apart from one another on the second ring line 419.

“Group-wise” in this context means that a nozzle connection connects at least two of the respective nozzles to the respective manifold.

Furthermore, it is provided, in some embodiments, that the first nozzle connections 424 each connect two first line elements 422, in particular detachably, to one another, and/or, that the second nozzle connections 425 each connect two second line elements 423, in particular detachably, to one another, as exemplified in FIG. 22. The first nozzle connections 424 and/or the second nozzle connections 425 can in particular connect the respective conduit elements in a latching and/or screwing manner.

Furthermore, it is provided here, that the first ring line 418 is formed from the first line elements 422 and the first nozzle connections 424, and/or, that the second ring line 419 is formed from the second line elements 423 and the second nozzle connections 425. To this extent, the nozzle connections can be part of the ring line.

It is further provided, in some embodiments, that the first shower head 404 comprises a modular base body 426, which is formed from several interconnected, in particular mechanically interconnected, base body modules 426. Shown in FIG. 22, the base body 426 is annular in shape, in particular circular or elliptical. The base body modules 426 may, in some embodiments, be detachably connected to each other, in particular via a snap-in and/or screw connection. The base body modules 426 can, in some embodiments, be of the same design or can be divided into several groups of base body modules 426, each of which is of the same design.

It is further possible that the first distribution line 416, in particular the first line elements 422, and/or the first nozzles 412 are arranged on the base body 426 via the first nozzle connections 424, and/or, that the second distribution line 417, in particular the second line elements 423, and/or the second nozzles 413 are arranged on the base body 426 via the second nozzle connections 425. This is also shown by way of example in FIG. 22.

It is shown, in some embodiments, that the first nozzles 412, in particular the first nozzle group 407, are arranged on a common second circular path or a common second elliptical path, and/or, that the second nozzles 413, in particular the second nozzle group 408, are arranged on a common third circular path or a common third elliptical path. In some embodiments, the second circular path or second elliptical path and the third circular path or third elliptical path are arranged concentrically, and/or, the diameters of the second circular path and the third circular path or the major and minor axes of the second elliptical path and the third elliptical path are different in size.

It is further provided, in some embodiments, that the distribution system 415 comprises at least two first supply ports 420, through which water of a water supply line 405 of the first water supply line group 410 can be supplied to the first distribution line 416, in particular to the first ring line 418, and that the distribution system 415 comprises at least two second supply ports 421, through which water of a water supply line 405 of the second water supply line group 411 can be supplied to the second distribution line 417, in particular to the second ring line 419. In FIG. 22, the base body 426 is of annular design and the two first supply ports 420 and the two second supply ports 421 are each arranged opposite to each other in the first annular line 418, which is in particular also of annular design, or the second annular line 419, which is in particular also of annular design. The first supply port 420 and/or the second supply port 421 can, in some embodiments, be point-symmetrical with respect to the geometric main axis 414 of the first shower head 404, which is vertical here.

In some embodiments, it is possible for the first supply ports 420 and/or the second supply ports 421 to be formed as part of the base body 426, in particular each as part of a base body module 426. Here, the first supply ports 420 and/or the second supply ports 421 may be formed approximately integrally as part of one or more base body modules 426. In particular, the first supply ports 420 and/or the second supply ports 421 may comprise three fluidic ports each for connecting a water line of the first water supply line group 410 and two first line elements 422, or, for connecting a water line of the second water supply line group 411 and two second line elements 423, as illustrated, for example, in FIG. 22.

In various embodiments, the first supply ports 420 divide the first distribution line 416, in particular the first ring line 418, into several first line sections 427, wherein the lengths of the different first line sections 427 differ from each other by at most 25%, at most 10%, or at most 5%. The first line sections 427 may comprise several first line elements 422. Alternatively or additionally, the second supply ports 421 may divide the second distribution line 417, in particular the second ring line 419, into several second line sections 428, wherein the lengths of the different second line sections 428 differ from each other by at most 25%, at most 10%, or at most 5%. The second line sections 428 may comprise several second conduit elements 423. In FIG. 22, it is exemplary and illustrated that the various first line sections 427 differ by no more than 5% as they are formed to be substantially the same length. In FIG. 22, the two first line sections 427 each comprise seven first conduit elements 422. Furthermore, it is illustrated that the various second line sections 428 deviate by no more than 5%, as these are formed with substantially the same length. In FIG. 22, the two second line sections 428 each comprise seven second line elements 423.

It is further provided, in some embodiments, that the first shower head 404 comprises a housing 429, in which the base body 426 and/or the distribution system 415 and/or the first nozzle group 407 and/or the second nozzle group 408 are, at least partially, in particular completely, accommodated. In some embodiments, it is provided that the housing 429 is annular, in particular circular or elliptical. In FIG. 20, the annular and circular housing 429 is shown as an example. The annular housing 429 is formed circumferentially around the geometric main axis 414 and extends circumferentially around a flat, i.e. non-annular, jet passage opening 430, the cross-sectional shape of which is defined by the annular shape of the housing 429 and in this respect is in particular circular or elliptical.

In various embodiments, the second nozzle group 408 or its second nozzles 413 are arranged and aligned in such a way that during shower operation the water of the second water jet pattern 402 passes at least partially, in some embodiments completely, through the jet passage opening 430 of the first shower head 404. This can be seen in an exemplary manner in FIG. 21. “Complete” in this context does not include splashing water or misdirected water from defective or dirty nozzles or the like, but refers only to the intended water jet pattern 402 during regular shower operation.

In some embodiments, it is the case that the housing 429 comprises a first exit opening 431 via which water of the first nozzle group 407, in particular of the first nozzles 412, can be discharged from the interior of the housing 429 to the outside. It is further possible that the first exit opening 431 is formed as a slit-shaped, in particular curved, in some embodiments coherent, first exit opening 431. In FIG. 20 and FIG. 21, for example, the slit-shaped, curved and coherent first exit opening 431 is shown, from which the water of the first nozzles 412 can be discharged from the interior of the housing 429 to the outside. FIG. 21 illustrates, by way of example, the water exiting the first exit opening 431.

In various embodiments, the housing 429 comprises a second exit opening 432 through which water of the second nozzle group 408, in particular of the second nozzles 413, can be discharged from the interior of the housing 429 to the outside. It is possible that the second exit opening 432 is formed as a second exit opening 432 i.e. formed from a row of holes. In FIG. 21, the second exit opening 432 formed from a row of holes is shown in cross-section, by way of example, from which the water of the second nozzles 413 can be discharged to the outside from the interior of the housing 429. In FIG. 21, the exit of the water from the second exit opening 432 is illustrated by way of example.

The exit opening is to be understood as “slit-shaped” if the ratio of its length to its width is at least 20 to 1, at least 45 to 1, or at least 60 to 1.

It has proven useful that the first nozzle group 407, in particular the first nozzles 412, and/or the second nozzle group 408, in particular the second nozzles 413, are accommodated in the housing 429 in such a way that the housing 429 is free of water from the first nozzle group 407 and/or the second nozzle group 408 during shower operation. The water thus emerges from the first nozzles 412 and the second nozzles 413 without contact with respect to the housing 429, as shown for example in FIG. 21.

It can be provided that the shower device 401 comprises a second shower head 406 with a third nozzle group 433 for creating a third water jet pattern 402, which comprises at least one third nozzle 434, and a third water supply line group 435 with at least one water supply line 405. In the assembled state, the first shower head 404 is arranged in particular rigidly with respect to the second shower head 406. FIG. 20 shows the second shower head 406. FIG. 21 shows the third water head 402.

It is possible that the first shower head 404 and the second shower head 406 are spaced apart by a shower head spacing, wherein the water supply lines 405 of the first water supply line group 410 and the second water supply line group 411 space the first shower head 404 and the second shower head 406 apart. The shower head spacing can be at least 20 cm, at least 30 cm, or at least 45 cm. The first shower head 404 and the second shower head 406 are, in some embodiments, arranged coaxially with respect to each other. It can be provided that the second shower head 406 is arranged with respect to the first shower head 404 in such a way that, during shower operation, the water of the third water jet pattern 402 passes at least partially, in some embodiments completely, through the jet passage opening 430 of the first shower head 404. This is shown by way of example in FIG. 21.

It may be provided that the first shower head 404 is a shower head remote from the wall, and, that the second shower head 406 is a shower head close to the wall, as exemplified in FIG. 20. Further, it is possible that the first water jet pattern 402 and/or the second water jet pattern 402 is or are each an outer water jet pattern 402, and/or, that the third water jet pattern 402 is an inner water jet pattern 402.

In some embodiments, the first, second and third water supply line groups 435 are separately controllable. The different water jet patterns 402 can thus optionally be created individually or together or in groups.

It is further provided, in some embodiments, that the shower device 401 comprises a mounting arrangement 436 with a, in particular plate-shaped, mounting body 437 for mounting on a wall 409, in this case the ceiling, on which the first shower head 404 is arranged via the water supply lines 405 of the first water supply line group 410 and the second water supply line group 411 and on which the second shower head 406 is arranged, in some embodiments, that the mounting body 437, at least partially, surrounds the second shower head 406. As exemplarily shown in FIG. 21, it is conceivable that the mounting body 437 is mounted on a ceiling of a bathroom and a suspended ceiling extends below the mounting body 437.

It is further provided, in some embodiments, that the shower device 401 comprises a lighting assembly 438 for illuminating at least one of the water jet patterns 402 by light with at least one light source 439. In some embodiments, all water jet patterns 402 of the different nozzle groups can be directly illuminated via the lighting assembly 438 during shower operation. In the present embodiment, the lighting assembly 438 is at least partially integrated in the second shower head 406 in such a way that the light source 439 of the lighting assembly 438 can be flowed around by the water of the third nozzle group 433.

Proposed is a method for creating a water jet pattern 402 using a shower device 401 according to the proposal.

Reference may be made to all explanations concerning the shower device 401 according to the proposal.

It is further provided, in some embodiments, that a first water jet pattern 402 created with the shower device 401 is cone-shaped, and/or, that a second water jet pattern 402 created with the shower device 401 is sink-shaped, and/or, that a third water jet pattern 402 created with the shower device 401 is cylinder-shaped. In some embodiments, the water jet patterns 402 can be formed from a water surge and/or from several individual water jets.

In FIG. 21, by way of example, the first water jet pattern 402 is cone-shaped and formed from several individual water jets, and/or, the second water jet pattern 402 is sink-shaped and formed from several individual water jets, and/or, the third water jet pattern 402 is cylinder-shaped and formed from a circumferential water surge.

Furthermore, a shower system with a shower device 401 and a wall 409, in particular a ceiling, is proposed, wherein the shower device 401 is designed according to the proposal. FIG. 20 shows an exemplary embodiment of the shower system.

Reference may be made to all explanations concerning the shower device 401 according to the proposal and the method according to the proposal.

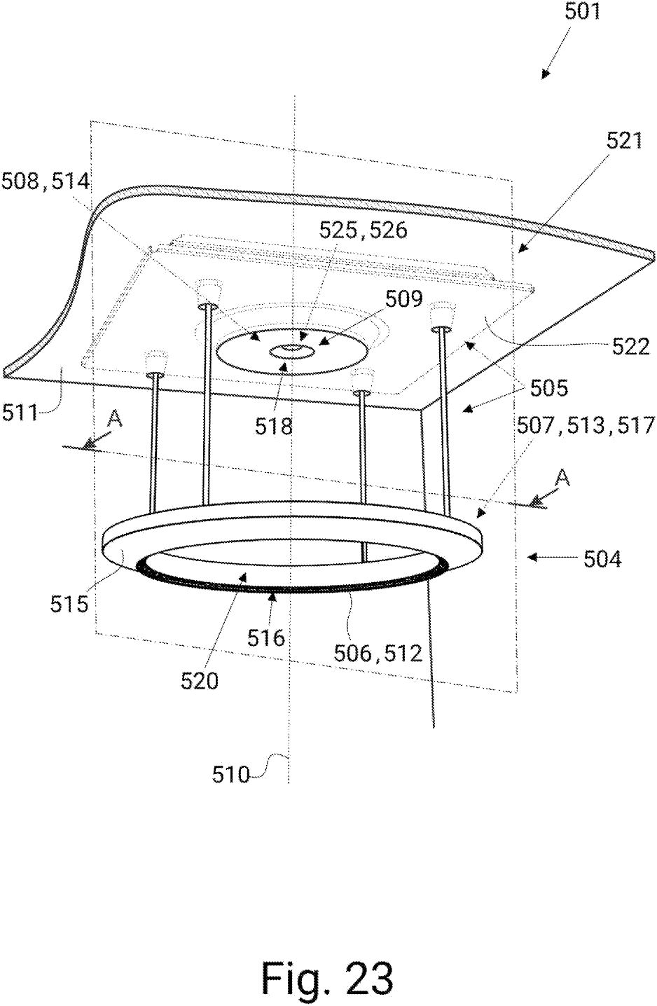

According to a further teaching described on the basis of FIGS. 23 to 25, a shower device for creating at least two water jet patterns is provided, the shower device comprising a nozzle assembly for delivering water with a first nozzle group for creating a first water jet pattern and/or second nozzle group for creating a second water jet pattern, a first shower head, which comprises the first and/or second nozzle group, and several water supply lines via which water can be supplied to the first showerhead. It can be that the nozzle assembly comprises a third nozzle group for creating a third water jet pattern, that the shower device comprises a second showerhead, which comprises the third nozzle group and in relation to which the first shower head is arranged in the assembled state, in particular rigidly, and at least one further water supply line, via which water can be supplied to the second shower head, and that the first shower head and the second shower head are spaced apart from each other at a shower head spacing along a, in particular vertical, geometrical main axis of the shower device. Reference may be made to all explanations concerning the shower device according to the proposal of the first teaching, concerning the shower device according to the proposal of the second teaching, concerning the shower device according to the proposal of the third teaching and concerning the shower device according to the proposal of the fourth teaching.

In detail, with reference to FIGS. 23 to 25, the following:

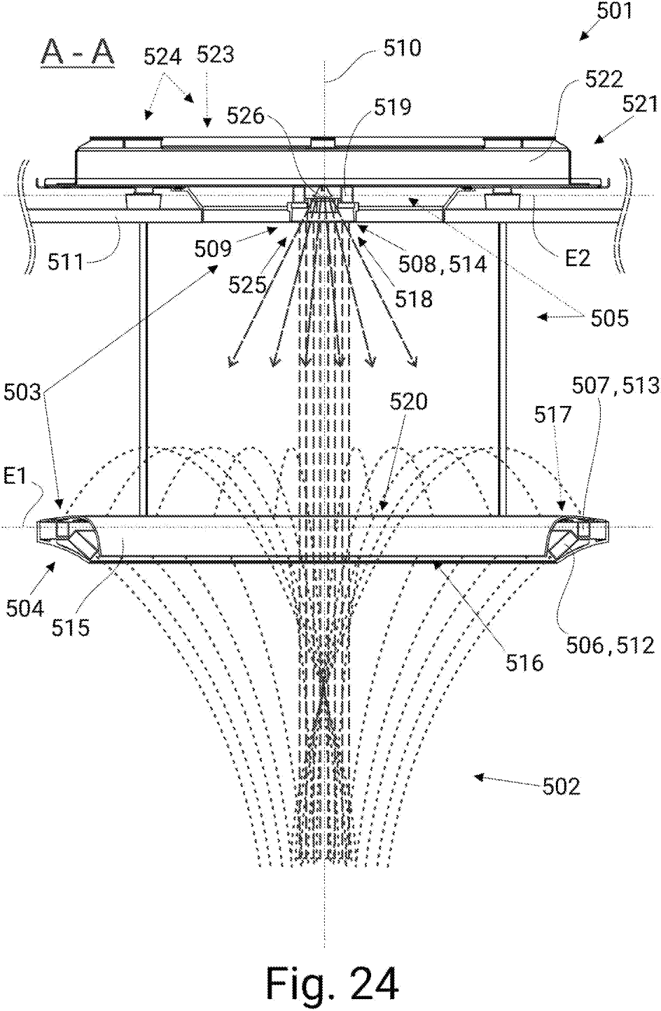

The embodiment illustrated in FIGS. 23 to 25 relates to a shower device 501 for creating at least two water jet patterns 502. The water jet patterns 502 may comprise, for example, water jets and/or a water surge, as exemplified in FIG. 24. The water jet patterns 502 may be created simultaneously or sequentially in the shower operation.

The shower device 501 includes a nozzle assembly 503, a first shower head 504 receiving a portion of the nozzle assembly 503, and several water supply lines 505.

It is now the case that the nozzle assembly 503 comprises a first nozzle group 506 and/or a second nozzle group 507 and enables water to be discharged via them. By means of the first nozzle group 506, a first water jet pattern 502 and/or by means of the second nozzle group 507, a second water jet pattern 502 can be created. FIG. 24 shows by way of example that the first nozzle group 506 creates a, in some embodiments conical, first water jet pattern 502 and the second nozzle group 507 creates a, in some embodiments sink-shaped, second water jet pattern 502.

“First” nozzle group 506 does not mean here that a further, “second” nozzle group 507 must also necessarily be provided on the first shower head 504, and vice versa. Rather, the “first” nozzle group 506 or the “second” nozzle group 507 can also be the only nozzle group of the first shower head 504. However, as will be further explained, in the present embodiment, two nozzle groups are provided as part of the first shower head 504.

The first nozzle group 506 and the second nozzle group 507 are received by the first shower head 504. The first shower head 504 may, in some embodiments, be annular and circular in shape. Likewise, other shapes are conceivable, such as annular and elliptical.

Water can be supplied to the first shower head 504 via some of the water supply lines 505. These water supply lines 505 are, in some embodiments, each tubular. These water supply lines 505 are, in some embodiments, each formed straight at least in sections. Furthermore, these water supply lines 505, in some embodiments, each comprise a constant outer diameter, at least in sections, in particular in a visible region.

It can be that the nozzle assembly 503 comprises a third nozzle group 508 for creating a third water jet pattern 502, that the shower device 501 comprises a second shower head 509, which comprises the third nozzle group 508, and at least one further water supply line 505, via which water can be fed to the second shower head 509, and in that the first shower head 504 and the second shower head 509 are spaced apart from each other at a shower head spacing along a, in particular vertical, geometric main axis 510 of the shower device 501.

It is thus the case that the nozzle assembly 503 comprises at least one further nozzle group, the third nozzle group 508, which is not accommodated by the first shower head 504. In this case, the second shower head 509 can be attached to a wall 511, in particular to a ceiling, as can be seen from FIG. 23 and FIG. 24, and/or is arranged closer to the wall 511 or ceiling than the first shower head 504 in the assembled state of the shower device 501.

By a wall 511 is meant here quite generally any boundary of the shower area. In particular, the term “wall” 511 also includes the ceiling of a shower area. A ceiling can be, for example, the ceiling of a bathroom or a suspended ceiling. When the term “wall” 511 is used hereinafter, the ceiling is meant in the present embodiment. The present disclosure is also applicable to a side wall.

At this point, it should be noted that “third” nozzle group 508 does not mean that two further nozzle groups must necessarily be provided in the shower device 501. As explained before, it is also conceivable that only one further nozzle group, the “first” nozzle group 506 or the “second” nozzle group 507, can be provided. It can be that the “third” nozzle group 508 is a component of the second shower head 509 and that at least one other nozzle group is a component of the first shower head 504. However, as will be further explained, in the present embodiment, as mentioned above, a second nozzle group 507 is also provided as part of the first shower head 504, so that a total of three nozzle groups are provided.

In various embodiments, a second shower head 509 is thus provided in addition to the first shower head 504, which, as part of the nozzle assembly 503, comprises a further nozzle group, the third nozzle group 508, for creating a further waterjet pattern 502, the third water jet pattern 502. This second shower head 509 is arranged at a distance spaced apart from the first shower head 504. Based on the shower head spacing, the first shower head 504 is arranged, in some embodiments, in a vertical direction lower than the second shower head 509, so that water of the water jet patterns 502 created by the first shower head 504 exits the shower device 501 at a higher point, than water of the water jet pattern 502 created by the second shower head 509, creating a unique sculptural overall pattern, as shown in FIG. 24.

The spacing from the first shower head 504 to the second shower head 509 and/or from the wall 511 also allows water to emerge spaced from the wall 511 or ceiling at different locations and/or in different directions, for example also describing an arc due to gravity, thereby allowing aesthetically particularly pleasing water jet patterns 502 to be created.

In various embodiments, the first shower head 504 is rigidly arranged relative to the second shower head 509 and/or the wall 511 when mounted. “Rigid” in this context means immovable, meaning that during an intended shower operation the first shower head 504 is not movable relative to the wall 511 and/or the second shower head 509, unlike, for example, a hand shower. However, the term “rigid” refers only to the condition of the shower device 501 when mounted as intended, which thus does not preclude adjustability in the course of mounting, in particular to change the shower head spacing.

In various embodiments, the first shower head 504 extends along a first plane E1 transverse to the main geometric axis 510. In order to create the aforementioned shower head spacing, in some embodiments, the second shower head 509 extends along a second plane E2, extending transversely to the geometric main axis 510. The first plane E1 and the second plane E2 are thereby different from each other, in some embodiments, the first plane E1 and the second plane E2 being spaced apart and/or parallel to each other along the main geometric axis 510 of the shower device 501. The direction transverse to the main geometric axis 510 is oblique or orthogonal to the main geometric axis 510.

It is further provided, in some embodiments, that the first nozzle group 506 comprises several first nozzles 512 for delivering water for the first water jet pattern 502 and/or the second nozzle group 507 comprises several second nozzles 513 for delivering water for the second water jet pattern 502. According to FIG. 23 and FIG. 24, the third nozzle group 508 comprises a single third nozzle 514 or likewise several third nozzles 514 for delivering water for the third water jet pattern 502.

It should also be noted that a nozzle group, for example the third nozzle group 508, does not necessarily have to comprise several nozzles, but can also comprise only a single nozzle. In the case of the first nozzle group 506 and the second nozzle group 507, however, several nozzles are provided in each case.

The first nozzles 512 and/or the second nozzles 513 and/or the at least one third nozzle 514 can be designed as surge nozzles and/or as jet nozzles, to name just a few examples. In the embodiment according to FIG. 24, the nozzles are designed as jet nozzles.

Furthermore, in some embodiments, water can be discharged in a first direction via the first nozzles 512 and water can be discharged in a second direction via the second nozzles 513 and that the first direction is different from the second direction.

“Different” in the present context means that the two directions deviate from each other, in particular that the first direction deviates from the second direction by at least 30°, by at least 60°, or by at least 90°.

Further, it can be conceivable that the first direction is oriented downward with respect to a horizontal plane E1, E2 and the second direction is oriented upward with respect to the horizontal plane E1, E2, as exemplified by FIG. 24. It is possible that the water of the second water jet pattern 502 undergoes a change in direction due to gravity. In FIG. 24 further exemplarily shown, the first water jet pattern 502 is cone-shaped and the second water jet pattern 502 is sink-shaped.

It is shown and, in some embodiments that the first nozzles 512, in particular the first nozzle group 506, are arranged on a common first circular path or a common first elliptical path, and/or, the second nozzles 513, in particular the second nozzle group 507, are arranged on a common second circular path or a common second elliptical path. In some embodiments, the first circular path or first elliptical path and the second circular path or second elliptical path are arranged concentrically, and/or, the diameters of the first circular path and the second circular path or the major and minor axes of the first elliptical path and the second elliptical path are different in size. The respective common circular path or elliptical path thereby runs parallel to the first plane E1. It is further the case that the at least one third nozzle 514 is located in the second plane E2 and/or emits the water for the third water jet pattern 502 orthogonally to the second plane E2.

It is further provided, in some embodiments, that the first shower head 504 comprises a housing 515, in which the first nozzle group 506 and/or the second nozzle group 507 is, at least partially, in particular completely, accommodated. In some embodiments, it is provided that the housing 515 comprises a first exit opening 516, in particular slit-shaped and/or curved and/or coherent, via which water of the first nozzle group 506, in particular of the first nozzles 512, can be discharged from the interior of the housing 515 to the outside. Additionally or alternatively, it can be provided that the housing 515 comprises a second exit opening 517, formed in particular from a row of holes, via which water of the second nozzle group 507, in particular of the second nozzles 513, can be discharged from the interior of the housing 515 to the outside. As FIGS. 23 to 25 show, this housing 515 is configured, in some embodiments, annularly, in particular circularly or elliptically.

The first exit opening 516 is to be understood as “slit-shaped” if the ratio of its length to its width is at least 20 to 1, at least 45 to 1, or at least 60 to 1.

In some embodiments, the first exit opening 516 and/or the second exit opening 517 each run parallel to the first plane E1. Further, as shown in the present embodiment, the at least one third nozzle 514 may lie in the second plane E2. Additionally or alternatively, a third exit opening 518 associated with the at least one third nozzle 514 may also be located in a housing portion 519 of the second shower head 509 in the second plane E2. Additionally or alternatively, as exemplified in FIG. 24, the at least one third nozzle 514 may also discharge the water for the third water jet pattern 502 orthogonally to the second plane E2.

Furthermore, it is provided, in some embodiments, that the annular housing 515 of the first shower head 504 is formed circumferentially about the geometric main axis 510 and extends circumferentially about a flat, i.e. non-annular, jet passage opening 520, the cross-sectional shape of which is defined by the annular shape of the housing 515 and to this extent is in particular circular or elliptical.

In some embodiments, the second nozzle group 507 or its second nozzles 513 are arranged and aligned in such a way that, during shower operation, the water of the second water jet pattern 502 passes at least partially, in some embodiments completely, through the jet passage opening 520 of the first shower head 504. Additionally or alternatively, it can also be provided that the second shower head 509 is arranged opposite the first shower head 504 in such a way that, in shower mode, the water of the third water jet pattern 502 passes at least partially, in some embodiments completely, through the jet passage opening 520 of the first shower head504. This can be seen in an exemplary manner from FIG. 24. “Complete” in this context does not include splashing water or misdirected water from defective or dirty nozzles or the like but refers only to the intended water jet pattern 502 during regular operation.

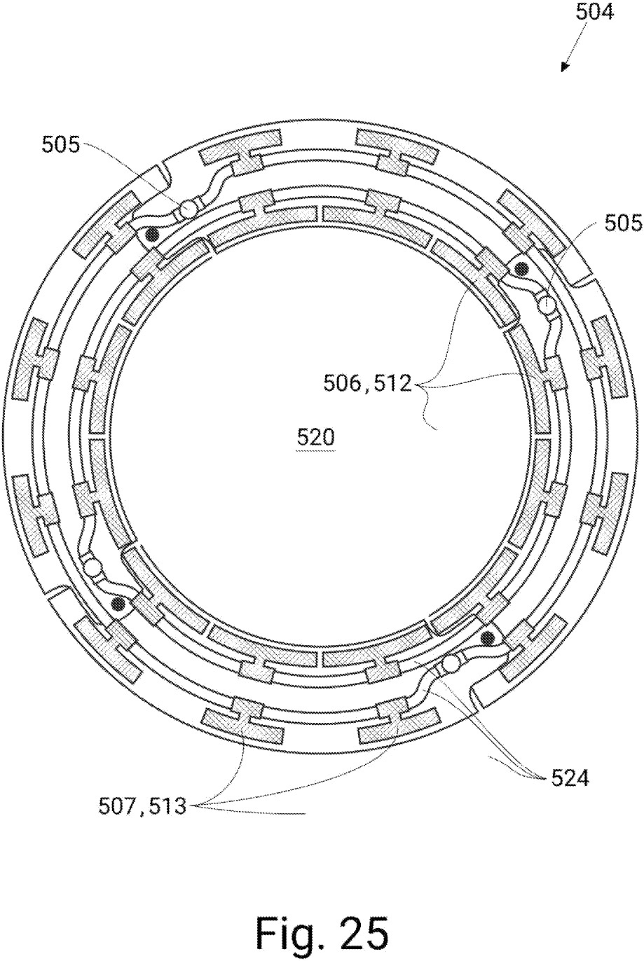

In some embodiments, the first nozzle group 506 and/or the second nozzle group 507, as exemplarily shown in FIG. 25, and/or the third nozzle group 508 is designed rotationally symmetrical. Additionally or alternatively, as exemplarily shown in FIG. 24, the first water jet pattern 502 and/or the second water jet pattern 502 and/or the third water jet pattern 502 can also be rotationally symmetrically, wherein the axes of the rotational symmetries are, in some embodiments, identical.

In various embodiments, it is further the case that the shower device 501 comprises a mounting arrangement 521 with a, in particular plate-shaped, mounting body 522 for mounting on the wall 511, in particular the ceiling, on which the second shower head 509 is arranged and which at least partially surrounds the second shower head 509, in some embodiments, that the mounting body 522 and the first shower head 504 are spaced apart from each other along the geometric main axis 510 of the shower device 501 and/or that the mounting body 522 runs parallel to the first plane E1. As exemplarily shown in FIG. 23, it is conceivable that the mounting body 522 is mounted to a ceiling of a bathroom and that a suspended ceiling extends below the mounting body 522.

The first shower head 504 and/or the second shower head 509, when mounted, can be rigidly attached to the mounting body 522 and/or attached to the wall 511 solely via the mounting body 522.

It is further provided, in some embodiments, that the water supply lines 505, via which water can be supplied to the first shower head 504, are designed as supply and spacing units for supplying water to the first shower head 504 and for spacing and fastening the first shower head 504 with respect to the wall 511, in particular the ceiling. In this way, the nozzle assembly 503 can be positioned in the shower area in the course of assembly in such a way that water can be discharged spaced from the wall 511 or ceiling at different locations and/or in different directions. In addition, the supply and spacing units allow the creation of a floating design element, which makes the overall aesthetic effect of the shower device 501 particularly appealing.

In some embodiments, the water supply lines 505, via which water can be supplied to the first shower head 504, space the first shower head 504 and the second shower head 509 from one another. The shower head spacing can be at least 20 cm, at least 30 cm, or at least 45 cm. The first shower head 504 and the second shower head 509 are, in some embodiments, arranged coaxially with respect to one another.

Additionally or alternatively, as exemplified by FIG. 23 and FIG. 24, the first shower head 504 may be disposed on the mounting body 522 via the water supply lines 505 through which water may be supplied to the first shower head 504.

In various embodiments, the water supply lines 505 through which water can be supplied to the first shower head 504 are arranged substantially parallel to each other. In various embodiments, the water supply lines 505 comprise the same length and/or diameter. It is possible that the water supply lines 505 are aligned vertically, i.e. in the direction of gravity, as exemplified in FIGS. 23 and 24. Alternatively or additionally, the water supply lines 505 are arranged on a common first circular path, as exemplarily shown in FIG. 25, or a common elliptical path.

In the embodiment, as a synopsis of FIG. 24 and FIG. 25 shows, the water supply lines 505, via which water can be supplied to the first shower head 504, are divided into water supply line groups 505, in this case into two water supply line groups 505, each water supply line group 505 supplying water to a different nozzle group. Via a first water supply line group 505 with at least two water supply lines 505, water can be supplied to the first nozzle group 506, and via a second water supply line group 505 with at least two water supply lines 505, water can be supplied to the second nozzle group 507. In this case, the first water supply line group 505 and the second water supply line group 505 are designed to be fluidically separate from one another, in this case in such a way that the water supply lines 505 of the first water supply line group 505 and the water supply lines 505 of the second water supply line group 505 are arranged essentially parallel to one another and/or on a common third circular path or elliptical path.

When supplying the first and second nozzle group 507 with water via two water supply lines 505 in each case, a larger volumetric flow rate of water can be supplied to the corresponding nozzle group than would be the case, for example, with a single water supply line 505. In particular for cases in which the first nozzle group 506 and/or the second nozzle group 507 have, for example, a large number of first nozzles 512 or second nozzles 513, it is possible to ensure a uniform supply of water via several water supply lines 505 of each water supply line group 505 without having to accept unnecessarily high pressure losses, for example. By supplying water via water supply line groups 505, which are designed to be fluidically separate from one another, water can be supplied separately to the respective nozzle group.

It is further provided, in some embodiments, that the mounting body 522 comprises at least one water supply 523 for a supply line, in particular laid in the wall 511, and a water distribution structure 524, and that the water distribution structure 524 in the mounting body 522 distributes the supply line of water to the first shower head 504 and the second shower head 509. The water distribution structure 524 can be switchable, such that the supply of water is either exclusively to the first shower head 504 or exclusively to the second shower head 509 or simultaneously, in particular in adjustable volumetric flow rates, to the first shower head 504 and the second shower head 509.

As can be seen from FIG. 24, in the present embodiment it is also provided that the first nozzle group 506 creates a radially outer water jet pattern 502 as the first water jet pattern 502 in shower mode and/or the second nozzle group 507 creates a radially outer water jet pattern 502 as the second water jet pattern 502 in shower mode, and that the third nozzle group 508 in shower mode creates a radially inner water jet pattern 502 as the third water jet pattern 502.

A “radially outer” water jet pattern 502 means that the water for the water jet pattern 502 exits the shower head, in this case the first shower head 504, relatively far radially outwardly with respect to the main geometric axis 510. Accordingly, a “radially inner” water jet pattern 502 means that the water for the water jet pattern 502 emerges from the shower head, in this case the second shower head 509, radially further inwards than in the case of the radially outer water jet pattern 502, with respect to the geometric main axis 510.

In various embodiments, it is the case that the first water jet pattern 502 and/or the second waterjet pattern 502 falls radially, in particular in an arc, in the direction of the third water jet pattern 502 and/or the third water jet pattern 502 falls along the geometric main axis 510, in particular vertically and/or straight, in the direction of the first water jet pattern 502 and/or the second water jet pattern 502. As FIG. 24 exemplarily shows, the first waterjet pattern 502 and/or the second waterjet pattern 502 intersects the third waterjet pattern 502.

It is further provided, in some embodiments, that the shower device 501 comprises a lighting assembly 525 for illuminating at least one of the water jet patterns 502 by light with at least one light source 526. In various embodiments, all of the water jet patterns 502 of the different nozzle groups can be directly illuminated via the lighting assembly 525 during shower operation. In the present embodiment, the lighting assembly 525 is at least partially integrated in the second shower head 509 in such a way that the light source 526 of the lighting assembly 525 can be flowed around by the water of the third nozzle group 508.

Proposed is a method for creating a water jet pattern 502 using a shower device 501 according to the proposal.

Reference may be made to all explanations concerning the shower device 501 according to the proposal.

It is further provided, in some embodiments, that a first water jet pattern 502 created with the shower device 501 is cone-shaped, and/or that a second water jet pattern 502 created with the shower device 501 is sink-shaped, and/or, that a third water jet pattern 502 created with the shower device 501 is cylindrical. In some embodiments, the water jet patterns 502 can be formed from a water surge and/or from several individual water jets.

In FIG. 24, by way of example, the first water jet pattern 502 is cone-shaped and formed from several individual water jets, and/or, the second water jet pattern 502 is sink-shaped and formed from several individual water jets, and/or, the third water jet pattern 502 is cylinder-shaped and formed from a circumferential water surge.

Also proposed is a shower system comprising a shower device 501 and a wall 511, in particular a ceiling, to which the shower device 501 is attached. FIG. 23 illustrates an exemplary embodiment of the shower system.

Further provided, in some embodiments, the shower device 501 is configured according to the proposal.

Reference may be made to all explanations concerning the shower device 501 according to the proposal and the method according to the proposal.

1. A shower device for creating at least one water jet pattern comprising:
a structural assembly, with a nozzle assembly and a lighting assembly,
wherein the structural assembly provides an exit opening for the emergence of the water discharged by the nozzle assembly and has an outer edge region running about the edge of the exit opening;
wherein the exit opening during the shower operation is in particular only partly occupied with emerging water at any given time;
wherein the nozzle assembly is arranged distributed along at least a portion of the edge of the exit opening at the edge region, especially along at least a quarter of the edge of the exit opening; and
wherein the path of the water discharged by the nozzle assembly during the shower operation runs each time from the edge region in the direction of the exit opening and then through the exit opening.

2. The shower device as claimed in claim 1, wherein the light generated by the lighting assembly emerges at least in part from the exit opening.

3. The shower device as claimed in claim 1, wherein the nozzle assembly is arranged and distributed along the entire edge of the exit opening.

4. The shower device as claimed in claim 1, wherein the path of the water discharged by the nozzle assembly runs from several different directions from the edge region to the exit opening.

5. The shower device as claimed in claim 1, wherein the portion of area through which the water discharged by the nozzle assembly during the shower operation passes through the passage area of the exit opening at any given time is less than 50%.

6-9. (canceled)

10. The shower device as claimed in claim 1, wherein the nozzle assembly is coordinated with an encircling storage channel, into which the nozzle assembly generally channels water.

11. The shower device as claimed in claim 1, wherein the nozzle assembly is actuatable by the valve assembly so that the water jet pattern produces a multitude of single jets across at least a portion of the edge of the exit opening, whose path is a trajectory from the nozzle assembly across the edge region into the exit opening.

12. The shower device as claimed in claim 1, wherein at least a portion of the nozzles of the nozzle assembly, is/are tilted upward in the mounted condition relative to the horizontal.

13. The shower device as claimed in claim 1, wherein the lighting assembly comprises at least one light source, which is arranged in the edge region of the exit opening, wherein the light source is arranged along at least a segment of the edge of the exit opening.

14. The shower device as claimed in claim 1, wherein the lighting assembly has a reflector arrangement and that the light of the lighting assembly is reflected by the reflector arrangement and then emerges through the exit opening, wherein the reflector arrangement comprises a hood-shaped reflector.

15. The shower device as claimed in claim 1, wherein the exit opening is round in configuration.

16. The shower device as claimed in claim 1, wherein the exit opening is a polygon.

17. The shower device as claimed in claim 1, wherein the exit opening is multi-sided.

18. The shower device as claimed in claim 1, wherein the edge region is funnel-shaped at least for a portion and wherein in the mounted condition the funnel-shaped segment of the edge region tapers downward.

19. The shower device as claimed in claim 1, wherein the nozzle assembly and/or the lighting assembly are/is arranged so that in the mounted condition when looking at the exit opening, the nozzle assembly and the lighting assembly are not visible due to the arrangement in the edge region of the exit opening.

20. The shower device as claimed in claim 1, wherein the smallest clear internal dimension of the exit opening is at least 150 mm.

21. A shower device for creating at least one water jet pattern, said shower device comprising a nozzle assembly for discharging water, a structural assembly comprising a damming section for damming the water discharged from said nozzle assembly, and an exit opening for discharging the water discharged from said nozzle assembly and dammed in said damming section from said shower device, wherein the damming section comprises a boundary arrangement, which the water passes, at least partially, towards the exit opening during shower operation and wherein the exit opening is associated with a surge rim, which is at least partially occupied by discharged water during shower operation,
wherein the boundary arrangement is designed as a flow-through damming structure with several flow paths.

22. A shower device for creating at least one water jet pattern, the shower device comprising a nozzle assembly for discharging water, a structural assembly with a damming section for damming the water discharged by the nozzle assembly, an exit opening for discharging the water discharged by the nozzle assembly and dammed in the damming section from the shower device, and a lighting assembly for illuminating the water discharged from the exit opening, wherein the structural assembly comprises a base body, in which the nozzle assembly, the damming section and the lighting assembly are at least partially accommodated and from which water can be discharged via the exit opening, wherein the exit opening is assigned a surge edge, which is at least partially occupied by discharged water during shower operation, and wherein the exit opening is confined by a circumferential first opening edge,
wherein the shower device comprises a functional arrangement comprising at least a part of the lighting assembly and/or at least a part of the nozzle assembly, and,
wherein the functional arrangement is designed as an assembly unit which, in the course of assembly, can be connected to the structural assembly, in particular detachably, in such a way that, in the assembled state, the functional arrangement is at least partially accommodated by the base body, wherein the functional arrangement, in the course of assembly, can be moved, at least partially, through an assembly opening of the structural assembly, which is surrounded by the first opening edge.

23. A shower device for creating at least two water jet patterns, the shower device comprising a nozzle assembly for discharging water with a first nozzle group for creating a first water jet pattern and with a second nozzle group for creating a second water jet pattern, a first shower head, which comprises the first nozzle group and the second nozzle group, and several water supply lines via which water can be supplied to the first shower head,
wherein the water supply lines are designed as supply and spacing units for supplying water to the first shower head and for spacing and fastening the first shower head with respect to a wall, in particular a ceiling.

24. A shower device for creating at least two water jet patterns, the shower device comprising a nozzle assembly for discharging water with a first nozzle group for creating a first water jet pattern and/or a second nozzle group for creating a second water jet pattern, a first shower head, which comprises the first and/or second nozzle group, and several water supply lines via which water can be supplied to the first shower head,
wherein the nozzle assembly comprises a third nozzle group for creating a third water jet pattern, that the shower device comprises a second shower head, which comprises the third nozzle group and in relation to which the first shower head is arranged, in particular rigidly, in the assembled state, and at least one further water supply line, via which water can be supplied to the second shower head, and that the first shower head and the second shower head are spaced apart from one another at a shower head spacing along a, in particular vertical, geometrical main axis of the shower device.
